(19) United States
(12) Patent Application Publication
(10) Pub. No.: US 2025/0097761 A1
(43) Pub. Date: Mar. 20, 2025

(54) METHOD FOR PROCESSING DATA, COMMUNICATION DEVICE AND CHIP

(71) Applicant: GUANGDONG OPPO MOBILE TELECOMMUNICATIONS CORP., LTD., Dongguan (CN)

(72) Inventors: Zhe FU, Dongguan (CN); Shukun WANG, Dongguan (CN); Cong SHI, Dongguan (CN)

(21) Appl. No.: 18/962,367

(22) Filed: Nov. 27, 2024

Related U.S. Application Data
(63) Continuation of application No. PCT/CN2022/096977, filed on Jun. 2, 2022.

(51) Int. Cl. H04W 28/02

(52) U.S. Cl. CPC H04W 28/0268

(57) ABSTRACT

The present application provides a method for processing data. The method includes: performing data processing based on different pieces of first data corresponding to at least one quality of service (QoS) flow. The first data may include a set of PDUs; or the first data may be a coded slice, a frame, or a GOP.

### CROSS-REFERENCE TO RELATED APPLICATION

This application is a continuation application of international application No. PCT/CN2022/096977, filed on Jun. 2, 2022, the disclosure of which is herein incorporated by reference in its entirety.

### TECHNICAL FIELD

The present disclosure relates to the field of communication technologies, in particular, relates to a method for processing data, and a communication device and a chip thereof.

### BACKGROUND

In a related art, data processing is performed for quality of service (QOS) flows or session granularities. A protocol data unit (PDU) set of the same QoS flow or the same session granularity is subjected to undifferentiated processing, such that actual requirements in special scenarios cannot be met.

### SUMMARY

Embodiments of the present disclosure provide a method for processing data, and a communication device and a chip thereof.

According to some embodiments of the present disclosure, a method for processing data is provided. The method includes: performing data processing based on different pieces of first data corresponding to at least one QoS flow. The first data is a set of PDUs.

According to some embodiments of the present disclosure, a communication device is provided. The communication device includes: a processor; a transceiver connected to the processor; and a memory, configured to store one or more executable instructions of the processor, wherein the processor is configured to load and execute the one or more executable instructions to perform the method for processing data as described above.

According to some embodiments of the present disclosure, a chip is provided. The chip includes at least one of: one or more programmable logic circuits or one or more program instructions.

The chip, when running the one or more programmable logic circuits or executing the one or more program instructions, is caused to perform the method for processing data as described above.

### BRIEF DESCRIPTION OF THE DRAWINGS

For clearer descriptions of the technical solutions according to the embodiments of the present disclosure, the following briefly describes accompanying drawings required for describing the embodiments. Apparently, the accompanying drawings in the following description illustrate merely some embodiments of the present disclosure, and those of ordinary skill in the art can still derive other accompanying drawings from these accompanying drawings without creative efforts.

FIG. 1 is a schematic diagram of a 5G network architecture according to some embodiments of the present disclosure;

FIG. 2 is a schematic diagram illustrating data interaction based on a QoS flow according to some embodiments of the present disclosure;

FIG. 3 is a schematic diagram of a radio protocol architecture in the related art according to some embodiments of the present disclosure;

FIG. 4 is a flowchart of a method for processing data according to some embodiments of the present disclosure;

FIG. 5 is a flowchart of a method for processing data according to some other embodiments of the present disclosure;

FIG. 6 is a flowchart of a method for processing data according to some other embodiments of the present disclosure;

FIG. 7 is a schematic diagram of a packet header of a data packet corresponding to a set of PDUs according to some embodiments of the present disclosure;

FIG. 8 is a flowchart of a method for processing data according to some other embodiments of the present disclosure;

FIG. 9 is a flowchart of a method for processing data according to some other embodiments of the present disclosure;

FIG. 10 is a flowchart of a method for processing data according to some other embodiments of the present disclosure;

FIG. 11 is a flowchart of a method for processing data according to some other embodiments of the present disclosure;

FIG. 12 is a schematic diagram illustrating reordering according to some other embodiments of the present disclosure;

FIG. 13 is a schematic diagram illustrating reordering according to some other embodiments of the present disclosure;

FIG. 14 is a schematic diagram illustrating reordering according to some other embodiments of the present disclosure;

FIG. 15 is a schematic diagram illustrating reordering according to some other embodiments of the present disclosure;

FIG. 16 is a schematic diagram illustrating reordering according to some other embodiments of the present disclosure;

FIG. 17 is a schematic diagram illustrating reordering based on a bitmap indicator according to some embodiments of the present disclosure;

FIG. 18 is a schematic diagram illustrating reordering based on a bitmap indicator according to some other embodiments of the present disclosure;

FIG. 19 is a structural block diagram of an apparatus for processing data according to some embodiments of the present disclosure; and

FIG. 20 is a schematic structural diagram of a communication device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

First, terms involved in the embodiments of the present disclosure are briefly described hereinafter.

A set of PDUs is composed of one or more PDUs, wherein the one or more PDUs carry a payload of one information unit generated in an application layer. For example, the information unit is a frame or a video slice of extended reality and media services (XRMs). The one or more PDUs are of same importance requirements in the application layer. In the application layer, all PDUs in the PDU are required to use the corresponding information unit. In some cases, the application layer can still recover parts of the information unit in the case that some of the PDUs are missing. It should be noted that an I-frame, a P-frame, and the like, which are mentioned hereinafter, represent only a form of set of PDUs.

An I-frame is an intra-coded picture, and is a complete picture that can be independently encoded and decoded like a JPG image file.

A P-frame is a predicted picture, but is not a complete frame. The P-frame only contains image changes compared to a previous frame. In the case that a reference frame is lost, the P-frame cannot be decoded or displayed.

A B-frame is a bi-directional predicted picture, and contains changes between a previous reference frame and a next reference frame. More reference frames may result in a higher compression ratio. However, the B-frame is dedodable only in the case that the previous reference frame and the next reference frame are available.

A group of pictures (GOP) includes a collection of successive video frames. A first frame in the GOP is the I-frame and a subsequent frame is a P-frame or a B-frame.

For example, an association or dependency relationship may be present between PDUs. For example, a set of PDUs represents a video frame, and compression decoding of the video frame may only be implemented in the case that all PDUs associated in the set of PDUs are received, or may only be implemented in the case that an indication of a portion of the PDUs is received. In addition, an association or dependency relationship may be present between different sets of PDUs. For example, a dependency relationship is present between a set of PDUs representing an I-frame and a set of PDUs representing a P-frame, wherein compression decoding of the P-frame depends on the I-frame.

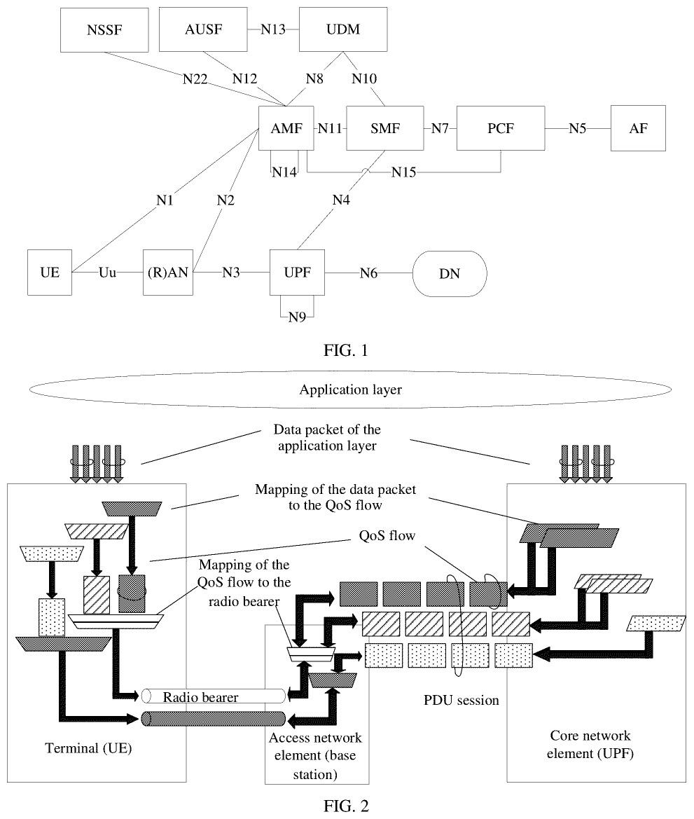

With respect to architecture of a 5G network system architecture, referring to FIG. 1, the 5G network system includes: a user equipment (UE, which is a mobile terminal defined in the 3GPP), a (radio) access network ((R)AN), a user plane function (UPF), a data network (DN), and control plane functions.

The control plane functions include: an access and mobility management function (AMF), a session management function (SMF), a policy control function (PCF), unified data management (UDM) function, an application function (AF), a network slice selection function (NSSF), and an authentication server function (AUSF).

The UE performs an access stratum connection to the AN, exchanges access stratum messages, and performs wireless data transmission over a Uu air interface; and performs a non-access stratum (NAS) connection to the AMF, and exchanges NAS messages over an N1 interface. The AMF is a mobility management function in a core network, the SMF is a session management function in the core network, and the AMF is responsible for forwarding messages related to session management between the UE and the SMF in addition to performing mobility management on the UE. The PCF is a policy management function in the core network, and is responsible for formulating policies related to mobility management, session management, billing, and the like, on the UE. The UPF is a user plane function in the core network, and performs data transmission with an external data network over an N6 interface and data transmission with the AN over an N3 interface.

The concept of quality of service flow (QOS flow) is introduced into the 5G network. Upon accessing the 5G network over the Uu air interface, the UE establishes QOS flows for data transmission under the control of the SMF. The SMF provides QoS flow configuration information of each QoS flow to a base station, wherein the QoS flow configuration information includes a bit rate requirement, a delay requirement, a bit error rate requirement, and the like. For each QoS flow, the base station ensures a QoS requirement of the QoS flow by scheduling wireless resources based on the QoS flow configuration information received from the SMF.

In a QoS flow in the 5G network, an uplink data flow (a data flow transmitted by the UE to a peer device over the 5G network) may be transmitted, or a downlink data flow (a data flow transmitted by the peer device to the UE over the 5G network) may be transmitted, wherein the peer device refers to a peer application server or a peer UE. Delay requirements of the uplink data flow and the downlink data flow in a QoS flow are the same. In the case that the delay requirements of the uplink data flow and the downlink data flow of a service are different, the data flows are transmitted in different QoS flows. The delay herein refers to a data transmission delay between the UE and the UPF.

Data processing in the 5G network includes processing for different PDUs or sets of PDUs, without processing of the requirements of different PDUs or sets of PDUs. Therefore, the requirements of different PDUs or sets of PDUs cannot be met.

Referring to FIG. 2, one or more QoS flows are required to be established for transmitting user plane data in a mobile communication network, and different data flows correspond to different QoS parameters. As an important metric for communication quality, characteristics of the QoS flow are generally indicated by the QoS parameters. The QoS parameters include, but are not limited to: a 5QI, an allocation and retention priority (ARP), a guaranteed flow bit rate (GFBR), maximum flow bit rate (MFBR), a maximum packet loss rate (uplink (UL), downlink (DL)), a end-to-end packet delay budget (PDB), an access network-packet delay budget (AN-PDB), a packet error rate, a priority level, an averaging window, a resource type, a maximum data burst volume, a UE aggregate maximum bit rate (UE-AMBR), a session aggregate maximum bit rate (Session-AMBR), and the like.

A filter (or referred to as a service data flow, SDF, template) contains parameters for characterizing data packets, and the filter is configured to filter out a specific data packet to a specific QoS flow (i.e., mapping of the data packet to the QoS flow in FIG. 2). The most commonly used filter is an IP five-tuple, i.e., a source IP address, a destination IP addresses, a source port number, a destination port number, and a protocol type.

A user plane network element (a UPF in FIG. 2) and the terminal (a UE in FIG. 2) at a network side form a filter (such as the leftmost trapezoid and the rightmost parallelogram) based on a combination of data packet characteristic parameters, wherein the filter is configured to filter an uplink data packet or a downlink data packet that is transmitted in the user plane and conforms to the data packet characteristics, and binds the uplink data packet or the downlink data packet to a specific data flow.

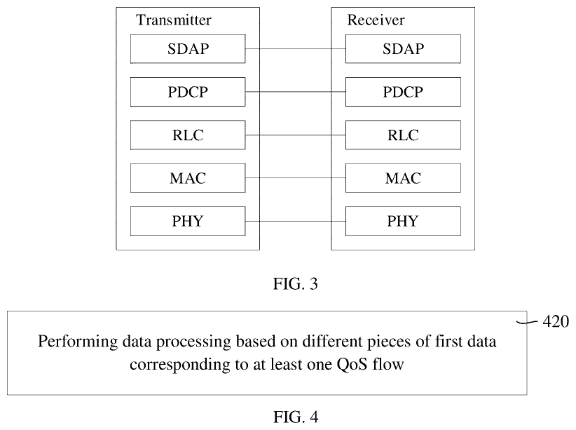

FIG. 3 illustrates a schematic diagram of a radio protocol architecture in the related art.

A Service Data Adaptation Protocol (SDAP) layer is responsible for mapping QoS bearers to data radio bearers (DRBs) based on QoS requirements.

A Packet Data Convergence Protocol (PDCP) layer is responsible for performing IP header compression, encryption, and integrity protection. At handover, the PDCP layer is further configured to perform retransmission, in-order delivery, and deduplication. With respect to dual connectivity with bearers separated, the PDCP layer may provide routing and replication, i.e., configuring one PDCP entity for each radio bearer of the terminal.

A radio link control (RLC) layer is responsible for data segmentation and retransmission. The RLC layer provides services to the PDCP layer in the form of RLC channels. One RLC entity is configured for one terminal per RLC channel (corresponding to each radio bearer).

A medium access control (MAC) layer is responsible for multiplexing of logical channels, hybrid automatic repeat request (HA ARQ) retransmission, scheduling, and scheduling related functions. The scheduling functions for uplink and downlink reside in gNBs. The MAC layer provides services to the RLC layer in the form of logical channels (LCHs). New radio (NR) changes a header structure of the MAC layer.

A physical layer (PHY) is responsible for encoding and decoding, modulation, demodulation, multi-antenna mapping, and other typical physical layer functions. The physical layer provides services to the MAC layer in the form of transport channels.

Hereinafter, methods for processing data are described.

FIG. 4 is a flowchart of a method for processing data according to some embodiments of the present disclosure. The method includes the following processes.

In 420, data processing is performed based on different pieces of first data corresponding to at least one QoS flow.

In some embodiments, performing the data processing based on the different pieces of first data corresponding to the at least one QoS flow includes the following cases.

(1) Data processing is performed based on different pieces of first data corresponding to the same QoS flow.

In some embodiments, performing the data processing based on the different pieces of first data corresponding to the same QoS flow includes: performing different data processing operations based on the different pieces of first data corresponding to the same QoS flow.

In some embodiments, performing the data processing based on the different pieces of first data corresponding to the same QoS flow includes: in the case that a network indicates to use or activate the data processing based on the different pieces of first data corresponding to the same QoS flow, and/or a transmitter/receiver/user equipment (UE) supports to perform the data processing based on the different pieces of first data corresponding to the same QoS flow, performing the data processing based on the different pieces of first data corresponding to the same QoS flow. In some embodiments, the network indication is an access network indicator, a core network indicator, or an application function (AF) indicator. In some embodiments, usage or activation indication information is configured by a base station over radio resource control (RRC) signaling. In some embodiments, the usage or activation indication information is configured by the base station over system information or dedicated signaling. In some embodiments, the usage or activation indication information is for a UE, a medium access control (MAC) entity, a cell, a QoS flow, a PDU session, a data radio bearer (DRB), or a packet data convergence protocol (PDCP).

In some embodiments, performing the data processing based on the different pieces of first data corresponding to the same QoS flow includes: in the case that the UE receives the indication from a 5G Node B (gNB) to use or activate the data processing based on the different pieces of first data corresponding to the same QoS flow, at least one of the UE or the base station performing the data processing using the different pieces of first data corresponding to the same QoS flow.

In some embodiments, the first data includes a set of PDUs.

In some embodiments, the first data is a coded slice, a frame, or a GOP.

In some embodiments, different data processing operations is performed based on a first set of PDUs and a second set of PDUs corresponding to a first QoS flow.

In some embodiments, the first set of PDUs includes one or more sets of PDUs; and the second set of PDUs includes one or more sets of PDUs.

In some embodiments, different data processing operations is performed based on a first coded slice and a second coded slice corresponding to the first QoS flow. In some embodiments, different data processing operations is performed based on a first frame and a second frame corresponding to the first QoS flow. In some embodiments, different data processing operations is performed based on a first GOP and a second GOP corresponding to the first QoS flow.

Hereinafter, the set of PDUs is used as an example, but the present disclosure is also applicable to other cases, such as a coded slice, a frame, or a GOP, which is not limited herein. It should be noted that, in the present disclosure, performing different data processing operations based on the first set of PDUs and the second set of PDUs corresponding to the first QoS flow can be replaced with performing different data processing operations based on a first PDU in the first set of PDUs corresponding to the first QoS flow and a second PDU in the second set of PDUs corresponding to the first QoS flow. Alternatively, in the present disclosure, performing different data processing operations based on the first set of PDUs and the second set of PDUs corresponding to the first QoS flow can be replaced with performing different data processing operations based on a first PDU in the first set of PDUs corresponding to the first QoS flow and a second PDU in the first set of PDUs corresponding to the first QoS flow. Alternatively, in the present disclosure, performing different data processing operations based on the first set of PDUs and the second set of PDUs corresponding to the first QoS flow can be replaced with performing different data processing operations based on a first PDU in the first set of PDUs and a second PDU in the first set of PDUs.

In some embodiments, different data processing operations is performed based on types of the first set of PDUs and the second set of PDUs. In some embodiments, different data processing operations is performed based on attributes, attribute levels, or indicators of the first set of PDUs and the second set of PDUs, wherein the attribute, attribute level, or indicator includes at least one of: association, dependency, importance, priority, decoding reliability, or reliability. In some embodiments, different data processing operations is performed based on a first relationship between the first set of PDUs and the second set of PDUs, wherein the first relationship includes at least one of an association relationship, a dependency relationship, an importance relationship, a priority relationship, a decoding reliability relationship, or a reliability relationship.

In some embodiments, the QoS flow includes the first QoS flow of a first PDU session.

In some embodiments, the QoS flow includes the first PDU session.

In some embodiments, the method for processing data includes at least one of:
configuring different first identifiers for different paths;
configuring a first identifier for each of at least one path;
configuring an identifier for the first QoS flow, a PDU session, or a SDAP;
configuring or being configured with mapping relationships between the first QoS flow and different paths;
configuring or being configured with mapping relationships between the different pieces of first data and different paths;
identifying the different pieces of first data;
adding or removing packet headers of data packets of the different pieces of first data;
adding or removing control PDUs of the different pieces of first data;
adding or removing control PDUs corresponding to the different pieces of first data;
routing the different pieces of first data to different paths;
reordering the different pieces of first data;
reordering different data packets of the different pieces of first data;
deleting or feeding back deletion of at least one of the different pieces of first data;
feeding back a transmission state of the first data;
feeding back a transmission state of at least one data packet of the first data;
retransmitting or feeding back retransmission of at least one of the different pieces of first data;
adding or removing serial numbers (SNs) of the different pieces of first data;
adding or removing association indicators of the different pieces of first data;
adding or removing type indicators of the different pieces of first data;
adding or removing importance indicators of the different pieces of first data;
receiving the different pieces of first data corresponding to the first QoS flow from a higher layer of the SDAP;
receiving the different pieces of first data corresponding to the first QoS flow from a lower layer of the SDAP; or
delivering the different pieces of first data in order.

In some embodiments, the execution subject that performs the data processing based on the different pieces of first data corresponding to the same QoS flow is at least one of a UE or a network. In some embodiments, the network is an access network (e.g., gNB), or a core network (e.g., at least one of a session management function (SMF), a user plane function (UPF), an access and mobility management function (AMF), or an AF).

(2) Data processing is performed based on different pieces of first data corresponding to different QoS flows.

In some embodiments, performing the data processing based on the different pieces of first data corresponding to the different QoS flows includes: performing different data processing operations based on the different pieces of first data corresponding to the different QoS flows.

In some embodiments, performing the data processing based on the different pieces of first data corresponding to the different QoS flows includes: in the case that a network indicates to use or activate the data processing based on the different pieces of first data corresponding to the different QoS flows, and/or a transmitter/receiver/base station supports to perform the data processing based on the different pieces of first data corresponding to the different QoS flows, performing the data processing based on the different pieces of first data corresponding to the different QoS flows. In some embodiments, the network indication is an access network indication, a core network indication, or an AF indication. In some embodiments, the usage or activation indication information is configured by a core network over non-access stratum (NAS) signaling. In some embodiments, the usage or activation indication information is configured by the core network over AMF, SMF, or UPF signaling interaction. In some embodiments, the usage or activation indication information is for a UE, a base station, a cell, a QoS flow, a PDU session, a DRB, or a PDCP.

In some embodiments, performing the data processing based on the different pieces of first data corresponding to the different QoS flows, includes: in the case that the base station receives the indication from the core network to use or activate the data processing based on the different pieces of first data corresponding to the different QoS flows, the base station performing the data processing using the different pieces of first data corresponding to the different QoS flows.

In some embodiments, the first data includes a set of PDUs.

In some embodiments, the first data is a coded slice, a frame, or a GOP.

In some embodiments, the data processing is performed based on a first set of PDUs and a second set of PDUs corresponding to the different QoS flows. In some embodiments, different data processing operations are performed based on a first set of PDUs and a second set of PDUs corresponding to a first QoS flow.

In some embodiments, the first set of PDUs includes one or more sets of PDUs; and the second set of PDUs includes one or more sets of PDUs.

In some embodiments, different data processing operations are performed based on a first coded slice corresponding to the first QoS flow and a second coded slice corresponding to a second QoS flow. In some embodiments, different data processing operations are performed based on a first frame corresponding to the first QoS flow and a second frame corresponding to the second QoS flow. In some embodiments, different data processing operations are performed based on a first GOP corresponding to the first QoS flow and a second GOP corresponding to the second QoS flow.

Hereinafter, the set of PDUs is used as an example, but the present disclosure is also applicable to other cases, such as a coded slice, a frame, or a GOP, which is not limited herein. It should be noted that, in the present disclosure, performing different data processing operations based on the first set of PDUs corresponding to the first QoS flow and the second set of PDUs corresponding to the second QoS flow can be replaced with performing different data processing operations based on a first PDU in the first set of PDUs corresponding to the first QoS flow and a second PDU in the second set of PDUs corresponding to the second QoS flow. Alternatively, performing different data processing operations based on the first set of PDUs corresponding to the first QoS flow and the second set of PDUs corresponding to the second QoS flow can be replaced with performing different data processing operations based on a first PDU in the first set of PDUs corresponding to the first QoS flow and a second PDU in the first set of PDUs corresponding to the second QoS flow.

In some embodiments, different data processing operations are performed based on types of the first set of PDUs and the second set of PDUs. In some embodiments, different data processing operations are performed based on attributes, attribute levels, or indicators of the first set of PDUs and the second set of PDUs, wherein the attribute, attribute level, or indicator includes at least one of: association, dependency, importance, priority, decoding reliability, or reliability.

In some embodiments, different data processing operations are performed based on a first relationship between the first set of PDUs and the second set of PDUs, wherein the first relationship includes at least one of: an association relationship, a dependency relationship, an importance relationship, a priority relationship, a decoding reliability relationship, or a reliability relationship.

In some embodiments, the execution subject that performs the data processing based on the different pieces of first data corresponding to the different QoS flows is at least one of a UE or a network. In some embodiments, the network is an access network (e.g., gNB), or a core network (e.g., at least one of an SMF, a UPF, an AMF, or an AF).

In the following embodiments, the first data including a set of PDUs and the different pieces of first data being the first set of PDUs and the second set of PDUs are taken as examples for description.

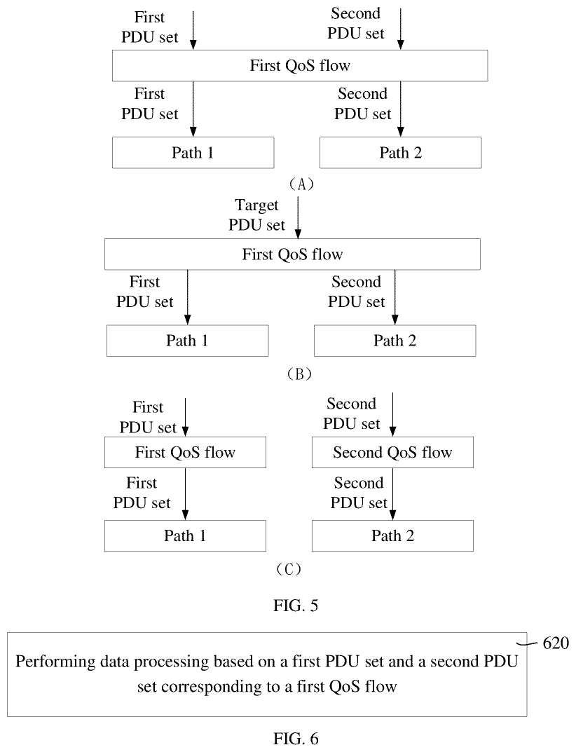

It should be noted that, for better illustrating the two cases included in process 420, reference is made to FIG. 5. FIG. 5 illustrates three possible cases of corresponding relationships between the QoS flow, the set of PDUs, and the path. In part (A) of FIG. 5, the first set of PDUs and the second set of PDUs are mapped to the first QoS flow, the first set of PDUs is mapped to path 1, and the second set of PDUs is mapped to path 2. In part (B) of FIG. 5, a target set of PDUs including the first set of PDUs and the second set of PDUs is mapped to the first QoS flow, the first set of PDUs is mapped to path 1, and the second set of PDUs is mapped to path 2. In this case, the first set of PDUs and the second set of PDUs are subsets of the target set of PDUs. In part (C) of FIG. 5, the first set of PDUs is mapped to the first QoS flow, the second set of PDUs is mapped to the second QoS flow, the first set of PDUs is mapped to path 1, and the second set of PDUs is mapped to path 2. In some embodiments, the cases illustrated in part (A) and part (B) of FIG. 5 are considered as the case (1) described above; and the case illustrated in part (C) of FIG. 5 is considered as the case (2) described above.

In summary, by performing data processing based on different first set of PDUs and second set of PDUs corresponding to different QoS flows, or performing data processing based on the first set of PDUs and the second set of PDUs corresponding to the first QoS flow, undifferentiated processing on the first set of PDUs and the second set of PDUs is avoided, thereby ensuring different processing requirements of different sets of PDUs and improving the efficiency of data processing.

By performing data processing based on different pieces of first data corresponding to at least one QoS flow, undifferentiated processing on the different pieces of first data is avoided.

For example, by performing data processing based on different first set of PDUs and second set of PDUs corresponding to at least one QoS flow, undifferentiated processing on the first set of PDUs and the second set of PDUs is avoided, and efficiency of data processing is improved.

FIG. 6 is a flowchart of a method for processing data according to some embodiments of the present disclosure. The method includes the following process.

In 620, data processing is performed based on the first set of PDUs and the second set of PDUs corresponding to the first QoS flow.

In some embodiments, different data processing operations are performed based on types of the first set of PDUs and the second set of PDUs. Illustratively, the type of the set of PDUs includes a frame, a coded slice, or a GOP.

In some embodiments, different data processing operations are performed based on attributes, attribute levels, or indicators of the first set of PDUs and the second set of PDUs. In some embodiments, the attribute, attribute level, or indicator includes at least one of: association, dependency, importance, priority, decoding reliability, or reliability.

The association means that one set of PDUs functions independently but functions together as a whole with other sets of PDUs. The dependency means that decoding, using, or functioning of one set of PDUs depends on one or more sets of PDUs, and the two sets of PDUs function together as a whole. The importance means an importance degree of a set of PDUs. The priority means a priority order of or a difference in priority of a set of PDUs in transmission or processing requirements. The decoding reliability means that one set of PDUs is decoded based on one or more other sets of PDUs. The reliability means high-reliability transmission or low-reliability transmission of a set of PDUs.

In some embodiments, different data processing operations are performed based on a first relationship between the first set of PDUs and the second set of PDUs. In some embodiments, the first relationship includes at least one of: an association relationship, a dependency relationship, an importance relationship, a priority relationship, a decoding reliability relationship, or a reliability relationship.

The association relationship means that the first set of PDUs and the second set of PDUs each function individually, but function together as a whole. The dependency relationship means that decoding, using, or functioning of the first set of PDUs depends on one or more second sets of PDUs (or decoding, using, or functioning of the second set of PDUs depends on one or more first sets of PDUs), and the two sets of PDUs function together as a whole. The importance relationship means an importance degree of at least one of the first set of PDUs or the second set of PDUs. The priority relationship means that the first set of PDUs and the second set of PDUs have a priority order in transmission or processing requirements, or have a difference in priority in transmission or processing requirements. The decoding reliability relationship means that the first set of PDUs is decoded based on the second set of PDUs (or the second set of PDUs is decoded based on the first set of PDUs). The reliability relationship means the high-reliability transmission or low-reliability transmission of at least one of the first set of PDUs or the second set of PDUs.

In some embodiments, the data processing includes at least one of the following processes.

1. Different first identifiers are configured for different paths.

2. First identifier is configured for at least one path.

3. A specific identifier is configured for the first QoS flow, a PDU session, or an SDAP.

4. Configuring or being configured with mapping relationships between the first QoS flow and different paths is performed.

In some embodiments, the path includes at least one of a DRB, a radio link control (RLC) channel, a logical channel (LCH), a PDCP entity, an RLC entity, or a MAC entity.

For example, the data packet transmitted over the first QoS flow is configured to map or is mapped to DRB 1 and DRB 2; and a data packet transmitted over the second QoS flow is configured to map or is mapped to DRB 3 and DRB 4.

For example, the data packet transmitted over the first QoS flow is configured to map or is mapped to PDCP 1 and PDCP 2; and the data packet transmitted over the second QoS flow is configured to map or is mapped to PDCP 3 and PDCP 4.

In some embodiments, the transmitter configures or is configured with different first identifiers for different paths; or, in some embodiments, the receiver configures or is configured with different first identifiers for different paths; or, in some embodiments, the network device configures or is configured with different first identifiers for different paths. The first identifier includes at least one of a type of a set of PDUs, a reliability identifier, an importance identifier, a reliability level, an importance level, a priority, a decoding dependency, a decoding reliability, a delay requirement, an identifier of the set of PDUs, a type of a frame, or a type of a coded slice.

In the case that the transmitter or the receiver is a terminal, the transmitter or the receiver is configured with the mapping relationships between the first QoS flow and different paths.

In the case that the transmitter or the receiver is an access network element or a core network element, the transmitter or the receiver configures the mapping relationships between the first QoS flow and different paths.

5. Configuring or being configured with mapping relationships between at least one of the first set of PDUs or the second set of PDUs and different paths is performed.

In some embodiments, the path includes at least one of a DRB, an RLC channel, an LCH, a PDCP entity, an RLC entity, or a MAC entity.

For example, the first set of PDUs transmitted over the first QoS flow is configured to map or is mapped to DRB 1, and the second set of PDUs transmitted over the first QoS flow is configured to map or is mapped to DRB 2.

For example, the first set of PDUs transmitted over the first QoS flow is configured to map or is mapped to PDCP 1, and the second set of PDUs transmitted over the first QoS flow is configured to map or is mapped to PDCP 3 or PDCP 4.

In some embodiments, the transmitter configures or is configured with different first identifiers for different paths; or, in some embodiments, the receiver configures or is configured with different first identifiers for different paths; or, in some embodiments, the network configures or is configured with different first identifiers for different paths. The first identifier includes at least one of: a type of a set of PDUs, a reliability identifier, an importance identifier, a reliability level, an importance level, a priority, a decoding dependency, a decoding reliability, a delay requirement, an identifier of a set of PDUs, a type of a frame, or a type of a coded slice.

In the case that the transmitter or the receiver is a terminal, the transmitter or the receiver is configured with the mapping relationships between at least one of the first set of PDUs or the second set of PDUs and different paths.

In the case that the transmitter or the receiver is an access network element or a core network element, the transmitter or the receiver configures the mapping relationships between at least one of the first set of PDUs or the second set of PDUs and different paths.

6. The first set of PDUs and the second set of PDUs are identified.

In some embodiments, the types of the first set of PDUs and the second set of PDUs are identified. For example, the first set of PDUs is identified as belonging to an I-frame, and the second set of PDUs is identified as belonging to a P-frame. For example, the first set of PDUs is identified as belonging to an I-coded slice, and the second set of PDUs is identified as belonging to a P-coded slice. For example, the first set of PDUs is identified as belonging to a first GOP, and the second set of PDUs is identified as belonging to a second GOP.

In some embodiments, the attribute, attribute level, or indicator of the first set of PDUs is identified, and the attribute, attribute level, or indicator of the second set of PDUs is identified. In some embodiments, the first relationship between the first set of PDUs and the second set of PDUs is identified.

In some embodiments, the transmitter identifies the first set of PDUs and the second set of PDUs using the data packet or packet header of the higher layer of the SDAP. In some embodiments, the transmitter identifies the first set of PDUs and the second set of PDUs using a general packet radio service tunnelling protocol-U (GTP-U) packet or a GTP-U packet header. In some embodiments, the transmitter identifies the first set of PDUs and the second set of PDUs using the data packet or packet header of reverse data. In some embodiments, the transmitter identifies the first set of PDUs and the second set of PDUs over inter-layer interaction.

7. Packet headers of different data packets of the first set of PDUs and the second set of PDUs are added or removed.

In some embodiments, the packet headers of the different data packets of the first set of PDUs and the second set of PDUs include at least one of:
at least one of the SN of the PDU in the first set of PDUs or the SN of the PDU in the second set of PDUs;
at least one of the SN of the first set of PDUs or the SN of the second set of PDUs;
(in some embodiments, the value of the SN is ranging from 0 to 2\hat{ }8-1.)
at least one of the association indicator of the first set of PDUs or the association indicator of the second set of PDUs;
at least one of the dependency indicator of the first set of PDUs or the dependency indicator of the second set of PDUs;
at least one of the type indicator of the first set of PDUs or the type indicator of the second set of PDUs;
at least one of the importance indicator of the first set of PDUs or the importance indicator of the second set of PDUs;
at least one of the priority indicator of the first PDU se or the priority indicator of the second set of PDUs;
at least one of the SN of the data packet of the first set of PDUs or the SN of the data packet of the second set of PDUs;
at least one of the association indicator of the data packet of the first set of PDUs or the association indicator of the data packet of the second set of PDUs;
at least one of the type indicator of the data packet of the first set of PDUs or the type indicator of the data packet of the second set of PDUs;
at least one of the dependency indicator of the data packet of the first set of PDUs or the dependency indicator of the data packet of the second set of PDUs;
at least one of the importance indicator of the data packet of the first set of PDUs or the importance indicator of the data packet of the second set of PDUs;
at least one of the priority indicator of the data packet of the first set of PDUs; or the priority indicator of the data packet of the second set of PDUs; or
at least one of the SN of the PDU in the first set of PDUs or the SN of the PDU in the second set of PDUs.

Here, the data packet of the first set of PDUs includes all or part of the PDUs in the first set of PDUs; and the data packet of the second set of PDUs includes all or part of the PDUs in the second set of PDUs. Alternatively, a plurality of data packets carry the data of the first set of PDUs or PDUs in the first set of PDUs. Alternatively, a plurality of data packets carry the data of the second set of PDUs or PDUs in the second set of PDUs.

In some embodiments, the SN of the data packet of the first set of PDUs is carried in the packet header of the data packet corresponding to the first set of PDUs, and the SN of the data packet of the second set of PDUs is carried in the packet header of the data packet corresponding to the second set of PDUs.

In some embodiments, the SN of the first set of PDUs is carried in the packet header of the first set of PDUs, and the SN of the second set of PDUs is carried in the packet header of the second set of PDUs. Alternatively, the SN of the first set of PDUs is carried in the packet header of the data packet corresponding to all or part of the PDUs in the first set of PDUs, and the SN of the second set of PDUs is carried in the packet header of the data packet corresponding to all or part of the PDUs in the second set of PDUs.

In some embodiments, the SN of the PDU in the first set of PDUs is carried in the packet header of the data packet corresponding to all or part of the PDUs int the first set of PDUs, and the SN of the PDU in the second set of PDUs is carried in the packet header of the data packet corresponding to all or part of the PDUs in the second set of PDUs.

In some embodiments, the data packet of the first set of PDUs is the SDAP PDU corresponding to the first set of PDUs; and the data packet of the second set of PDUs is the SDAP PDU corresponding to the second set of PDUs.

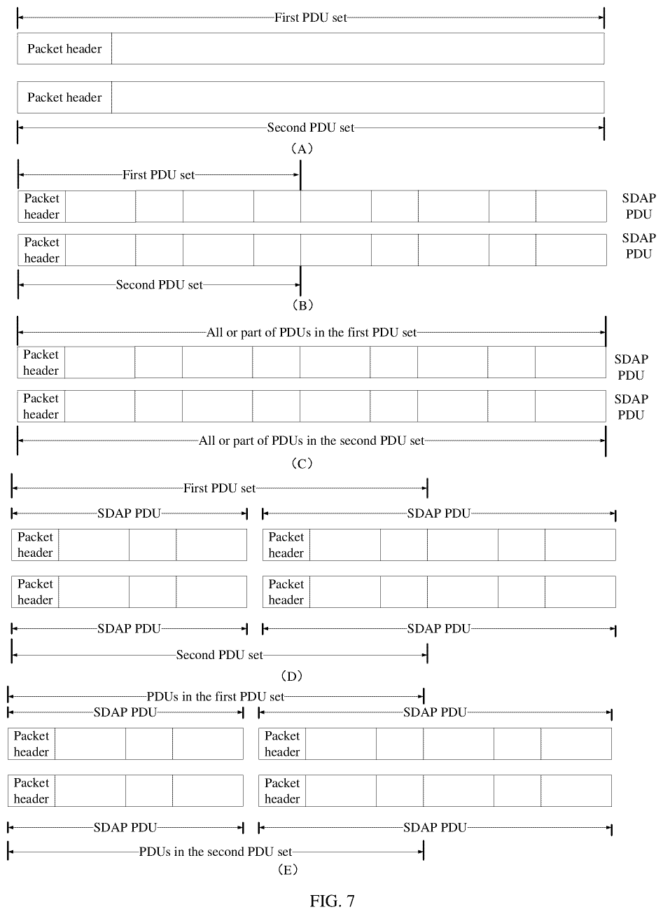

In some embodiments, referring to FIG. 7, part (A) of FIG. 7 illustrates the packet header of the first set of PDUs and the packet header of the second set of PDUs; and the packet header of the first set of PDUs includes the SN of the first set of PDUs and the packet header of the second set of PDUs includes the SN of the second set of PDUs. Part (B) of FIG. 7 illustrates an SDAP PDU for transmitting the first set of PDUs and an SDAP PDU for transmitting the second set of PDUs; and in this case, the SDAP PDU includes all of the PDUs in the set of PDUs, and the packet header of the SDAP PDU includes the SN of the SDAP PDU. Part (C) of FIG. 7 illustrates an SDAP PDU for transmitting all or part of the PDUs in the first set of PDUs and an SDAP PDU for transmitting all or part of the PDUs in the second set of PDUs; and in this case, the SDAP PDU include at least one of the SN of the set of PDUs or the SN of the SDAP PDU. Part (D) of FIG. 7 illustrates one or more SDAP PDUs for transmitting the first set of PDUs (exemplified by two SDAP PDUs in the figure) and one or more SDAP PDUs for transmitting the second set of PDUs (exemplified by two SDAP PDUs in the figure); and in this case, the one or more SDAP PDUs include all of the PDUs in the set of PDUs, and the packet header of the SDAP PDU includes the SN of the SDAP PDU. Part (E) of FIG. 7 illustrates one or more SDAP PDUs for transmitting the PDU in the first set of PDUs (exemplified by two SDAP PDUs in the figure) and one or more SDAP PDUs for transmitting the PDU in the second set of PDUs (exemplified by two SDAP PDUs in the figure); and in this case, the one or more SDAP PDUs include the PDU in the set of PDUs, and the packet header of the SDAP PDU includes the SN of the PDU in the set of PDUs.

8. A control PDU for first data or for the set of PDUs is added or removed.

In some embodiments, the control PDU for the first data or for the set of PDUs includes at least one of:
the SN of the control PDU (the SN of the control PDU of the first set of PDUs, and the SN of the control PDU of the second set of PDUs);
the identifier or SN of the set of PDUs corresponding to the control PDU (the identifier or SN of the first set of PDUs, and the identifier or SN of the second set of PDUs);
the start identifier or SN of the set of PDUs corresponding to the control PDU (the start identifier or SN of the set of PDUs, or at least one of the start identifier or SN of the first set of PDUs or the start identifier or SN of the second set of PDUs);
the end identifier or SN of the set of PDUs corresponding to the control PDU (the end identifier or SN of the set of PDUs, or at least one of the end identifier or SN of the first set of PDUs or the end identifier or SN of the second set of PDUs);
the number of sets of PDUs corresponding to the control PDU;
the start marker of the corresponding set of PDUs (the start marker of the first set of PDUs, and the start marker of the second set of PDUs);
the end marker of the corresponding set of PDUs (the end marker of the first set of PDUs, and the end marker of the second set of PDUs);
the association indicator of the corresponding set of PDUs (the association indicator of the first set of PDUs, and the association indicator of the second set of PDUs);
the dependency indicator of the corresponding set of PDUs (the dependency indicator of the first set of PDUs, and the dependency indicator of the second set of PDUs);
the type indicator of the corresponding set of PDUs (the type indicator of the first set of PDUs, and the type indicator of the second set of PDUs);
the importance indicator of the corresponding set of PDUs (the importance indicator of the first set of PDUs, and the importance indicator of the second set of PDUs);
the association level of the corresponding set of PDUs (the association level of the first set of PDUs, and the association level of the second set of PDUs);
the importance level of the corresponding set of PDUs (the importance level of the first set of PDUs, and the importance level of the second set of PDUs);
the bitmap indicator of the corresponding set of PDUs (the bitmap indicator of the first set of PDUs, and the bitmap indicator of the second set of PDUs); or
the type of the control PDU (the type of the control PDU of the first set of PDUs, and the type of the control PDU of the second set of PDUs).

In some embodiments, the bitmap indicator indicates the information of at least one set of PDUs. In some embodiments, the bitmap indicator includes at least one of: the SN of the control PDU; the type of the control PDU; the SN of the set of PDUs corresponding to the control PDU; the number of corresponding sets of PDUs; a routing path of the corresponding set of PDUs; or the identifier of the corresponding set of PDUs.

In some embodiments, the bitmap indicator indicates the information of at least one PDU in one set of PDUs. In some embodiments, the bitmap indicator includes at least one of: the SN of the control PDU; the type of the control PDU; the identifier or SN of the set of PDUs corresponding to the control PDU; the number of the PDUs in the corresponding set of PDUs; a routing path of at least one PDU in the corresponding set of PDUs; the identifier of the corresponding set of PDUs; the SN or identifier of at least one PDU in the corresponding set of PDUs; the start marker of at least one PDU in the corresponding set of PDUs; the end marker of at least one PDU in the corresponding set of PDUs; the association indicator of at least one PDU in the corresponding set of PDUs; the dependency indicator of at least one PDU in the corresponding set of PDUs; the type indicator of at least one PDU in the corresponding set of PDUs; the importance indicator of at least one PDU in the corresponding set of PDUs; the association level of at least one PDU in the corresponding set of PDUs; or the importance level of at least one PDU in the corresponding set of PDUs.

In some embodiments, the plurality of corresponding sets of PDUs are ordered or indicated in the control PDU in order (e.g., one of ascending order, descending order, the SN of the set of PDUs, earlier arrival, or later arrival).

In some embodiments, each control PDU corresponds to one set of PDUs.

In some embodiments, each control PDU corresponds to at least one set of PDUs.

In some embodiments, each control PDU corresponds to a plurality of sets of PDUs. For example, the control PDU corresponds to the set of PDUs of one GOP.

In some embodiments, the control PDU includes at least one of: a control PDU located between different sets of PDUs or located between a plurality of sets of PDUs, a PDU located at the start or end position between the plurality of sets of PDUs, a control PDU located before one or at least one set of PDUs, a control PDU located after one or at least one set of PDUs, a control PDU for distinguishing or spacing different sets of PDUs, a control PDU for identifying the start of the set of PDUs, or a control PDU for identifying the end of the set of PDUs.

In some embodiments, the control PDU and the set of PDUs are transmitted over the same path. In some embodiments, the control PDU and the corresponding set of PDUs are transmitted over the same path. In some embodiments, the control PDU is transmitted prior to the set of PDUs. In some embodiments, the control PDU is transmitted prior to the corresponding set of PDUs. In some embodiments, the control PDU is transmitted with the set of PDUs. In some embodiments, the control PDU is transmitted with the corresponding set of PDUs. In some embodiments, the control PDU and the set of PDUs are transmitted over different paths. In some embodiments, the control PDU and the corresponding set of PDUs are transmitted over different paths.

In some embodiments, at least one of the control PDU or the first set of PDUs is associated with an RLC acknowledgement mode (RLC AM mode), and the first set of PDUs is associated with an RLC AM or RLC un-acknowledgement mode (RLC UM mode). In some embodiments, the control PDU is transmitted over a first path. For example, the reliability, importance, priority, type (e.g., the type is I-frame), and other characteristics of the first set of PDUs and/or the reliability, importance, priority, type (e.g., the type is I-frame), and other characteristics of the first path correspond to each other. The reliability, importance, priority, type (e.g., the type is I-frame), and other characteristics of the second set of PDUs and/or the reliability, importance, priority, type (e.g., the type is I-frame), and other characteristics of the first path correspond to each other.

In some embodiments, a control PDU 1 corresponds to a set of PDUs 1, SN 1 is carried in the control PDU 1, and SN 1 is the SN of the control PDU 1 or the SN of the set of PDUs 1. The control PDU 1 is transmitted with the corresponding set of PDUs 1 and is located before the corresponding set of PDUs 1 (adjacent to the set of PDUs 1). In some embodiments, the control PDU 2 corresponds to a set of PDUs 2, SN 2 is carried in a control PDU 2, and SN 2 is the SN of the control PDU 2 or the SN of the set of PDUs 2. The control PDU 2 is transmitted with the corresponding set of PDUs 2 and is located before the corresponding set of PDUs 2 (adjacent to the set of PDUs 2 and located after the set of PDUs 1).

In some embodiments, the control PDU 1 corresponds to the set of PDUs 1 and the set of PDUs 2, SN 1 is carried in the control PDU 1, and SN 1 is the SN of the control PDU 1. The control PDU 1 may carry the SNs of the set of PDUs 1 and the set of PDUs 2. The control PDU 1 is transmitted with the corresponding set of PDUs 1 and set of PDUs 2 and is located before the corresponding set of PDUs 1 and set of PDUs 2 (adjacent to the set of PDUs 1 and the set of PDUs 2). The control PDU 2 corresponds to a set of PDUs 3 and a set of PDUs 4, SN 2 is carried in the control PDU 2, and SN 2 is the SN of the control PDU 2. The control PDU 2 may carry the SNs of the set of PDUs 3 and the set of PDUs 4. The control PDU 2 is transmitted with the corresponding set of PDUs 3 and set of PDUs 4 and is located before the corresponding set of PDUs 3 and set of PDUs 4 (adjacent to the set of PDUs 3 and the set of PDUs 4 and located after the set of PDUs 1 and the set of PDUs 2).

In some embodiments, the control PDU 1 corresponds to the set of PDUs 1, the set of PDUs 2, and the set of PDUs 3, SN 1 is carried in the control PDU 1, and SN 1 is the SN of the control PDU 1. The control PDU 1 may carry the SNs of the set of PDUs 1, the set of PDUs 2, and the set of PDUs 3. The control PDU 1 is transmitted with the corresponding set of PDUs 1, set of PDUs 2, and set of PDUs 3 and is located before the corresponding set of PDUs 1, set of PDUs 2, and set of PDUs 3 (adjacent to the set of PDUs 1 and the set of PDUs 2). The control PDU1 may further indicate that the set of PDUs 1 is transmitted over path 1, the set of PDUs 2 is transmitted over path 2, and the set of PDUs 3 is transmitted over path 1. In some embodiments, the set of PDUs 1, the set of PDUs 2, and the set of PDUs 3 are arranged or indicated in the control PDU based on the ascending or descending order of the SNs of the sets of PDUs.

9. Different control PDUs of the first set of PDUs and the second set of PDUs are added or removed.

In some embodiments, the different control PDUs of the first set of PDUs and the second set of PDUs include at least one of:
the SNs of the control PDUs;
the identifiers or SNs of the sets of PDUs corresponding to the control PDUs;
the start identifiers or SNs of the sets of PDUs corresponding to the control PDUs;
the end identifiers or SNs of the sets of PDUs corresponding to the control PDUs;
the number of sets of PDUs corresponding to the control PDUs;
the start markers of the corresponding sets of PDUs;
the end markers of the corresponding sets of PDUs;
the association indicators of the corresponding sets of PDUs;
the dependency indicators of the corresponding sets of PDUs;
the type indicators of the corresponding sets of PDUs;
the importance indicators n of the corresponding sets of PDUs;
the association level of the corresponding sets of PDUs;
the importance level of the corresponding sets of PDUs;
the bitmap indicator of the corresponding sets of PDUs; or the types of the control PDUs.

In some embodiments, the bitmap indicator indicates the information of at least one set of PDUs. In some embodiments, the bitmap indicator includes at least one of: the SN of the control PDU; the SN of the set of PDUs corresponding to the control PDU; the type of the control PDU; the number of corresponding sets of PDUs; a routing path of the corresponding set of PDUs; or the identifier of the corresponding set of PDUs.

In some embodiments, the bitmap indicator indicates the information of at least one PDU in one set of PDUs. In some embodiments, the bitmap indicator includes at least one of: the SN of the control PDU; the type of the control PDU; the identifier or SN of the set of PDUs corresponding to the control PDU; the number of the PDUs in the corresponding set of PDUs; the routing path of at least one PDU in the corresponding set of PDUs; the identifier of the corresponding set of PDUs; the SN or identifier of at least one PDU in the corresponding set of PDUs; the start marker of at least one PDU in the corresponding set of PDUs; the end marker of at least one PDU in the corresponding set of PDUs; the association indicator of at least one PDU in the corresponding set of PDUs; the dependency indicator of at least one PDU in the corresponding set of PDUs; the type indicator of at least one PDU in the corresponding set of PDUs; the importance indicator of at least one PDU in the corresponding set of PDUs; the association level of at least one PDU in the corresponding set of PDUs; or the importance level of at least one PDU in the corresponding set of PDUs.

In some embodiments, the plurality of corresponding sets of PDUs are ordered or indicated in the control PDU in order (e.g., one of ascending order, descending order, the SN of the set of PDUs, earlier arrival, or later arrival).

In some embodiments, each of the control PDUs corresponds to one set of PDUs. For example, a first control PDU corresponds to the first set of PDUs. For example, a second control PDU corresponds to the second set of PDUs.

In some embodiments, each of the control PDUs corresponds to at least one set of PDUs. For example, the first control PDU corresponds to at least one first set of PDUs and at least one second set of PDUs. For example, the second control PDU corresponds to at least one first set of PDUs and at least one second set of PDUs.

In some embodiments, each of the control PDUs corresponds to a plurality of sets of PDUs. For example, the first control PDU corresponds to the set of PDUs of the first GOP. For example, the second control PDU corresponds to the set of PDUs of the second GOP.

In some embodiments, the control PDU of the first set of PDUs includes at least one of: a PDU located between the first set of PDUs and the second set of PDUs, or located between the second set of PDUs and the second set of PDUs, or located between the first set of PDUs and the first set of PDUs, or located at the start or end position between a plurality of sets of PDUs within the first set of PDUs, a control PDU located between the plurality of sets of PDUs within the first set of PDUs, a control PDU located before one or at least one first set of PDUs, a control PDU located after one or at least one first set of PDUs, a control PDU for distinguishing or spacing different sets of PDUs, a control PDU for identifying the start of the first set of PDUs, or a control PDU for identifying the end of the first set of PDUs.

In some embodiments, the control PDU of the second set of PDUs includes at least one of: a control PDU located between the first set of PDUs and the second set of PDUs, or located between the second set of PDUs and the second set of PDUs, or located between the first set of PDUs and the first set of PDUs, or located between a plurality of second sets of PDUs, a control PDU located before one or at least one second set of PDUs, a control PDU located after one or at least one second set of PDUs, a control PDU for distinguishing or spacing different sets of PDUs, a control PDU for identifying the start of at least one second set of PDUs, or a control PDU for identifying the end of at least one second set of PDUs.

In some embodiments, the control PDU of the first set of PDUs corresponds to at least one first set of PDUs, and the control PDU of the second set of PDUs corresponds to at least one second set of PDUs.

In some embodiments, at least one of the control PDU or the first set of PDUs is associated with an RLC AM mode, and the first set of PDUs is associated with an RLC AM or RLC UM mode. In some embodiments, the control PDU is transmitted over a first path. For example, the reliability, importance, priority, type (e.g., the type is I-frame), and other characteristics of the first set of PDUs and/or the reliability, importance, priority, type (e.g., the type is I-frame), and other characteristics of the first path correspond to each other. The reliability, importance, priority, type (e.g., the type is I-frame), and other characteristics of the second set of PDUs and/or the reliability, importance, priority, type (e.g., the type is I-frame), and other characteristics of the first path correspond to each other.

In some embodiments, the first control PDU and the first set of PDUs are transmitted over the same path. In some embodiments, the second control PDU and the second set of PDUs are transmitted over the same path. In some embodiments, the first control PDU is transmitted prior to the first set of PDUs. In some embodiments, the second control PDU is transmitted prior to the second set of PDUs. In some embodiments, the first control PDU is transmitted with the first set of PDUs. In some embodiments, the second control PDU is transmitted with the second set of PDUs. In some embodiments, the first control PDU and the first set of PDUs are transmitted over different paths. In some embodiments, the second control PDU and the second set of PDUs are transmitted over different paths.

In some embodiments, the first control PDU corresponds to a set of PDUs 1, SN 1 is carried in the first control PDU, and SN 1 is the SN of the control PDU or the SN of the set of PDUs 1. The first control PDU is transmitted with the corresponding set of PDUs 1 and is located before the corresponding set of PDUs 1 (adjacent to the set of PDUs 1). The second control PDU corresponds to a set of PDUs 2, SN 2 is carried in the second control PDU, and SN 2 is the SN of the control PDU or the SN of the set of PDUs 2. The second control PDU is transmitted with the corresponding set of PDUs 2 and is located before the corresponding set of PDUs 2 (adjacent to the set of PDUs 2).

In some embodiments, the control PDU 1 corresponds to the set of PDUs 1 and indicates that the set of PDUs 1 is transmitted from path 1. In some embodiments, the control PDU 1 further indicates from which paths a plurality of PDUs in the corresponding set of PDUs are transmitted. In some embodiments, at least one PDU in the set of PDUs 1 is arranged or indicated in the control PDU based on the ascending or descending order of the SN of the PDU.

In some embodiments, the first set of PDUs includes one or more sets of PDUs; and the second set of PDUs includes one or more sets of PDUs.

10. A control PDU corresponding to at least one first set of PDUs and at least one second set of PDUs is added or removed.

In some embodiments, the control PDU corresponding to at least one first set of PDUs and at least one second set of PDUs includes at least one of: the SN of the control PDU, the identifier or SN of the set of PDUs corresponding to the control PDU, the type of the control PDU, the start identifier or SN of the set of PDUs corresponding to the control PDU, the end identifier or SN of the set of PDUs corresponding to the control PDU, the number of the sets of PDUs corresponding to the control PDU, the start markers corresponding to at least one first set of PDUs and at least one second set of PDUs, the end markers corresponding to at least one first set of PDUs and at least one second set of PDUs, the association indicators corresponding to at least one first set of PDUs and at least one second set of PDUs, the type indicators corresponding to at least one first set of PDUs and at least one second set of PDUs, the importance indicators corresponding to at least one first set of PDUs and at least one second set of PDUs, the association levels corresponding to at least one first set of PDUs and at least one second set of PDUs, the importance levels corresponding to at least one first set of PDUs and at least one second set of PDUs, the dependency indicators corresponding to at least one first set of PDUs and at least one second set of PDUs, or the bitmap indicators corresponding to at least one first set of PDUs and at least one second set of PDUs.

In some embodiments, the bitmap indicator indicates the information of at least one set of PDUs. In some embodiments, the bitmap indicator includes at least one of the SN of the control PDU, the identifier or SN of the set of PDUs corresponding to the control PDU, the type of the control PDU; the number of corresponding sets of PDUs, the number of corresponding first sets of PDUs, the identifier of the corresponding first set of PDUs, the number of the corresponding second sets of PDUs, the identifier of the corresponding second set of PDUs, the routing path of the corresponding set of PDUs, or the identifier of the corresponding set of PDUs.

In some embodiments, the bitmap indicator indicates the information of at least one PDU in one set of PDUs. In some embodiments, the bitmap indicator includes at least one of the SN of the control PDU, the identifier or SN of the set of PDUs corresponding to the control PDU, the type of the control PDU, the number of the PDUs in the corresponding set of PDUs, the routing path of at least one PDU in the corresponding set of PDUs, the identifier of the corresponding set of PDUs, the SN or identifier of at least one PDU in the corresponding set of PDUs, the start marker of at least one PDU in the corresponding set of PDUs, the end marker of at least one PDU in the corresponding set of PDUs, the association indicator of at least one PDU in the corresponding set of PDUs, the dependency indicator of at least one PDU in the corresponding set of PDUs, the type indicator of at least one PDU in the corresponding set of PDUs, the importance indicator of at least one PDU in the corresponding set of PDUs, the association level of at least one PDU in the corresponding set of PDUs, or the importance level of at least one PDU in the corresponding set of PDUs.

In some embodiments, the plurality of corresponding sets of PDUs are ordered in the control PDU in order (e.g., one of ascending order, descending order, the SN of the set of PDUs, earlier arrival, or later arrival).

In some embodiments, a third control PDU is the control PDU corresponding to at least one first set of PDUs and at least one second set of PDUs. In some embodiments, the third control PDU corresponds to at least one first set of PDUs and at least one second set of PDUs.

In some embodiments, the third control PDU includes at least one of: a control PDU located before the set of PDUs corresponding to the third control PDU, or located after the set of PDUs corresponding to the third control PDU, of a set of PDUs corresponding to each control PDU for spacing or distinguishing sets of PDUs corresponding to a plurality of third control PDUs, a control PDU located between at least one first set of PDUs and at least one second set of PDUs, a control PDU located between the first set of PDUs and the second set of PDUs, a control PDU located before at least one first set of PDUs and at least one second set of PDUs, a control PDU located after at least one first set of PDUs and at least one second set of PDUs, a control PDU for identifying the starts of at least one first set of PDUs and at least one second set of PDUs, a control PDU for identifying the ends of at least one first set of PDUs and at least one second set of PDUs, a control PDU located before at least one first set of PDUs, a control PDU located after at least one first set of PDUs, a control PDU for identifying the start of at least one second set of PDUs, or a control PDU for identifying the end of at least one second set of PDUs.

In some embodiments, the third control PDU is transmitted over the same path as the first set of PDUs and the second set of PDUs. In some embodiments, the third control PDU is transmitted over a different path from the first set of PDUs and the second set of PDUs. In some embodiments, the third control PDU is transmitted over the same path as at least one first set of PDUs and at least one second set of PDUs. In some embodiments, the third control PDU is transmitted over a different path from at least one first set of PDUs and at least one second set of PDUs. In some embodiments, the third control PDU and the corresponding set of PDUs are transmitted over the same path. In some embodiments, the third control PDU and the corresponding set of PDUs are transmitted ove different paths. In some embodiments, the third control PDU is transmitted prior to the corresponding set of PDUs. In some embodiments, the third control PDU is transmitted upon the corresponding set of PDUs. In some embodiments, the third control PDU is transmitted with the corresponding set of PDUs.

In some embodiments, the set of PDUs associated with the third control PDU is determined based on the SNs of the first set of PDUs and the second set of PDUs carried by the third control PDU, and/or the SN of the set of PDUs carrying the data packets of the first set of PDUs and the second set of PDUs.

In some embodiments, the set of PDUs associated with the third control PDU is determined based on the SN of the data packet corresponding to the SNs of the first set of PDUs and the second set of PDUs carried by the third control PDU, and/or the SN of the data packet carrying the first set of PDUs and the second set of PDUs.

In some embodiments, a third control PDU 1 corresponds to a set of PDUs 1, a set of PDUs 2, and a set of PDUs 3, SN 1 is carried in the third control PDU 1, and SN 1 is the SN of the third control PDU 1. The third control PDU 1 may carry the SNs of the set of PDUs 1 and the set of PDUs 2. The third control PDU 1 is transmitted with the corresponding set of PDUs 1 and set of PDUs 2 and is located before the corresponding set of PDUs 1 and set of PDUs 2 (adjacent to the set of PDUs 1 and the set of PDUs 2). In some embodiments, a third control PDU 2 corresponds to a set of PDUs 3 and a set of PDUs 4, SN 2 is carried in the third control PDU 2, and SN 2 is the SN of the third control PDU 2. The third control PDU 2 may carry the SNs of the set of PDUs 3 and the set of PDUs 4. The third control PDU 2 is transmitted with the corresponding set of PDUs 3 and set of PDUs 4 and is located before the corresponding set of PDUs 3 and set of PDUs 4 (adjacent to the set of PDUs 3 and the set of PDUs 4 and located after the set of PDUs 1 and the set of PDUs 2).

In some embodiments, the third control PDU 1 corresponds to the set of PDUs 1 and the set of PDUs 2, SN 1 is carried in the third control PDU 1, and SN 1 is the SN of the third control PDU 1. The third control PDU 1 may carry the SNs of the set of PDUs 1 and the set of PDUs 1. The third control PDU 1 is transmitted with the corresponding set of PDUs 1 and set of PDUs 2 and is located before the corresponding set of PDUs 1 and set of PDUs 2 (adjacent to the set of PDUs 1 and the set of PDUs 2). The third control PDU 2 corresponds to the set of PDUs 3 and the set of PDUs 4, SN 2 is carried in the third control PDU 2, and SN 2 is the SN of the third control PDU 2. The third control PDU 2 may carry the SNs of the set of PDUs 3 and the set of PDUs 4. The third control PDU 2 is transmitted with the corresponding set of PDUs 3 and set of PDUs 4 and is located before the corresponding set of PDUs 3 and set of PDUs 4 (adjacent to the set of PDUs 3 and the set of PDUs 4 and located after the set of PDUs 1 and the set of PDUs 2).

In some embodiments, the third control PDU corresponds to the set of PDUs 1 and indicates that the set of PDUs 1 is transmitted from path 1. In some embodiments, the third control PDU indicates from which paths a plurality of PDUs in the corresponding set of PDUs are transmitted. In some embodiments, at least one PDU in the set of PDUs 1 is arranged or indicated in the control PDU based on the ascending or descending order of the SN of the PDU.

In some embodiments, the third control PDU corresponds to the set of PDUs 1, the set of PDUs 2, and the set of PDUs 3, SN 1 is carried in the third control PDU 2, and SN 1 is the SN of the third control PDU. The third control PDU may carry the SNs of the set of PDUs 1, the set of PDUs 2, and the set of PDUs 3. The third control PDU is transmitted with the corresponding set of PDUs 1, set of PDUs 2, and set of PDUs 3 and is located before the corresponding set of PDUs 1, set of PDUs 2, and set of PDUs 3 (adjacent to the set of PDUs 1 and the set of PDUs 2). The third control PDU may indicate that the set of PDUs 1 is transmitted over path 1, the set of PDUs 2 is transmitted over path 2, and the set of PDUs 3 is transmitted over path 1. In some embodiments, the set of PDUs 1, the set of PDUs 2, and the set of PDUs 3 are arranged or indicated in the control PDU based on the ascending or descending order of the SNs of the sets of PDUs. In some embodiments, the third control PDU indicates from which paths a plurality of PDUs in the corresponding set of PDUs are transmitted. In some embodiments, at least one PDU in the set of PDUs 1 is arranged or indicated in the control PDU based on the ascending or descending order of the SN of the PDU.

11. The first set of PDUs and the second set of PDUs are routed to different paths.

In some embodiments, the transmitter routes the first set of PDUs and the second set of PDUs to different paths.

In some embodiments, the transmitter routes the first set of PDUs and the second set of PDUs to different paths based on first information.

In some embodiments, the first information includes at least one of: the mapping relationships between the first QoS flow and different paths, the mapping relationships between at least one of the first set of PDUs or the second set of PDUs and different paths, different types of the first set of PDUs and the second set of PDUs, different attributes, attribute levels, or indicators of the first set of PDUs and the second set of PDUs, the first relationship between the first set of PDUs and the second set of PDUs, different identifiers of different paths, a first identifier of a path, or an identifier configured for the first QoS flow, a PDU session, or an SDAP.

In some embodiments, the first information includes any one of: configuration information, predefined information, pre-configuration information, or indication information. In some embodiments, the first information is configured by a base station over RRC signaling. In some embodiments, the first information is configured by the base station over system information or dedicated signaling. In some embodiments, the first information is for a UE, an MAC entity, a cell, a QoS flow, a PDU session, a DRB, or a PDCP. In some embodiments, the first information is identification information, and the first information identifies corresponding relationships between the first set of PDUs and the second set of PDUs and different paths.

For example, the first set of PDUs is routed to the first path based on the identifier of the first path, and the second set of PDUs is routed to the second path based on the identifier of the second path.

For example, the first set of PDUs is routed to the first path based on the identifier of the first path. Accordingly, the second set of PDUs is routed to the second path.

For example, the first set of PDUs is routed to a path for transmitting I-frames, and the second set of PDUs is routed to a path for transmitting P-frames, based on the first set of PDUs being an I-frame and the second set of PDUs being a P-frame.

In some embodiments, the first information is configured by RRC.

12. The first set of PDUs and the second set of PDUs are reordered.

In some embodiments, the receiver reorders the first set of PDUs and the second set of PDUs. The specific reordering method is described in detail hereinafter.

13. Different data packets of the first set of PDUs and the second set of PDUs are reordered.

In some embodiments, the receiver reorders the different data packets of the first set of PDUs and the second set of PDUs.

14. At least one of the first set of PDUs or the second set of PDUs is deleted or fed back deletion.

In some embodiments, in the case that part of the data packets in the first set of PDUs exceed a packet delay budget (PDB), or in the case that part of the data packets in the first set of PDUs exceed the duration of a PDCP discard timer, or in the case that the timer of the first set of PDUs times out, or in the case that the timer of the PDU of the first set of PDUs times out, or in the case that one of the first control PDU/the second control PDU/the third control PDU is lost, or in the case that the first set of PDUs exceeds the PDB of the corresponding set of PDUs, or in the case that the arrival duration, transmission duration, or generation duration of part of the data packets in the first set of PDUs exceeds the PDB, or in the case that the arrival duration, transmission duration, or generation duration of part of the data packets in the first set of PDUs exceeds the duration of the PDCP discard timer, or in the case that the arrival duration, transmission duration, or generation duration of the first set of PDUs exceeds the PDB of the corresponding set of PDUs, the transmitter deletes the remaining data packets of the first set of PDUs, or the transmitter deletes the first set of PDUs, or the transmitter deletes the data packets of the first set of PDUs, or the transmitter deletes the second set of PDUs, or the transmitter deletes part of the data packets of the second set of PDUs, or the transmitter deletes all of the data packets of the second set of PDUs.

In some embodiments, in the case that part of the data packets in the second set of PDUs exceed a packet delay budget (PDB), or in the case that part of the data packets in the second set of PDUs exceed the duration of a PDCP discard timer, or in the case that the timer of the second set of PDUs times out, or in the case that the timer of the PDU of the second set of PDUs times out, or in the case that one of the first control PDU/the second control PDU/the third control PDU is lost, or in the case that the second set of PDUs exceeds the PDB of the corresponding set of PDUs, or in the case that the arrival duration, transmission duration, or generation duration of part of the data packets in the second set of PDUs exceeds the PDB, or in the case that the arrival duration, transmission duration, or generation duration of part of the data packets in the second set of PDUs exceeds the duration of the PDCP discard timer, or in the case that the arrival duration, transmission duration, or generation duration of the second set of PDUs exceeds the PDB of the corresponding set of PDUs, the transmitter deletes the remaining data packets of the second set of PDUs, or the transmitter deletes the second set of PDUs, or the transmitter deletes the data packets of the second set of PDUs, or the transmitter deletes the first set of PDUs, or the transmitter deletes part of the data packets of the first set of PDUs, or the transmitter deletes all of the data packets of the first set of PDUs.

In some embodiments, in the case that a data packet in the first set of PDUs is lost, or in the case that part of the data packets in the first set of PDUs are lost, the transmitter deletes the remaining data packets of the first set of PDUs, or the transmitter deletes the first set of PDUs, or the transmitter deletes the data packets of the first set of PDUs, or the transmitter deletes the second set of PDUs, or the transmitter deletes part of the data packets of the second set of PDUs, or the transmitter deletes all of the data packets of the second set of PDUs.

In some embodiments, in the case that a data packet in the second set of PDUs is lost, or in the case that part of the data packets in the second set of PDUs are lost, the transmitter deletes the remaining data packets of the second set of PDUs, or the transmitter deletes the second PDU set, or the transmitter deletes the data packets of the second set of PDUs, or the transmitter deletes the first set of PDUs, or the transmitter deletes part of the data packets of the first set of PDUs, or the transmitter deletes all of the data packets of the first set of PDUs.

In some embodiments, in the case that a data packet in the first set of PDUs is lost, or in the case that part of the data packets in the first set of PDUs are lost, the receiver feeds back the transmission state (e.g., ACK/NACK) of the first set of PDUs to the transmitter, or the receiver feeds back the transmission state (e.g., ACK/NACK) of at least one data packet in the first set of PDUs to the transmitter, or the receiver feeds back the transmission state (e.g., ACK/NACK) of the lost data packet of the first set of PDUs to the transmitter, or the receiver feeds back to the transmitter to delete the remaining data packets of the first set of PDUs, or the receiver feeds back deletion of the first set of PDUs to the transmitter, or the receiver feeds back deletion of the data packet of the first set of PDUs to the transmitter, or the receiver feeds back deletion of the set of PDUs having the first relationship with the first set of PDUs to the transmitter, or the receiver feeds back deletion of the data packet of the set of PDUs having the first relationship with the first set of PDUs to the transmitter, or the transmitter deletes part of the data packets of the second set of PDUs, or the transmitter deletes all of the data packets of the second set of PDUs.

In some embodiments, in the case that a data packet in the second set of PDUs is lost, or in the case that part of the data packets in the second set of PDUs are lost, the receiver feeds back the transmission state (e.g., ACK/NACK) of the second set of PDUs to the transmitter, or the receiver feeds back the transmission state (e.g., ACK/NACK) of at least one data packet in the second set of PDUs to the transmitter, or the receiver feeds back the transmission state (e.g., ACK/NACK) of the lost data packet of the second set of PDUs to the transmitter, or the receiver feeds back deletion of the remaining data packets of the second set of PDUs to the transmitter, or the receiver feeds back deletion of the second set of PDUs to the transmitter, or the receiver feeds back deletion of the data packet of the second set of PDUs to the transmitter, or the receiver feeds back deletion of the set of PDUs having the first relationship with the second set of PDUs to the transmitter, or the receiver feeds back deletion of the data packet of the set of PDUs having the first relationship with the second set of PDUs to the transmitter, or the transmitter deletes part of the data packets of the first set of PDUs, or the transmitter deletes all of the data packets of the first set of PDUs.

In some embodiments, in the case that an SDAP protocol layer at the receiver receives the indication of a PDCP protocol layer, part or all of the data packets in the set of PDUs are deleted or fed back deletion, and/or part or all of the data packets of the set of PDUs having the first relationship with the indicated set of PDUs are deleted or fed back deletion, and/or feedback information or a feedback indication is transmitted to the transmitter. In some embodiments, in the case that the delay of the set of PDUs is greater than the PDB of the set of PDUs, part or all of the data packets in the set of PDUs are deleted or fed back deletion, and/or feedback information or a feedback indication is transmitted to the transmitter. In some embodiments, in the case that the set of PDUs is indicated to be NACK or lost, part or all of the data packets in the set of PDUs are deleted or fed back deletion, and/or feedback information or a feedback indication is transmitted to the transmitter.

15. At least one of the first set of PDUs or the second set of PDUs is retransmitted or fed back retransmission.

In some embodiments, in the case that a data packet in the first set of PDUs is lost, or in the case that part of the data packets in the first set of PDUs are lost, the transmitter retransmits the lost part, all, or important part of the first set of PDUs; and/or in the case that a data packet in the second set of PDUs is lost, or in the case that part of the data packets in the second set of PDUs are lost, the transmitter retransmits the lost part, all, or important part of the second set of PDUs. In some embodiments, in at least one of the cases that a data packet in the first set of PDUs is lost, part of the data packets in the first set of PDUs are lost, a data packet in the second set of PDUs is lost, one of the first control PDU/the second control PDU/the third control PDU is lost, and part of the data packets in the second set of PDUs are lost, the transmitter retransmits the lost part, all, or important part of the first set of PDUs; and/or the transmitter retransmits the lost part, all, or important part of the second set of PDUs.

In some embodiments, in the case that a data packet in the first set of PDUs is lost, or in the case that part of the data packets in the first set of PDUs are lost, the receiver feeds back retransmission of the lost part, all, or important part of the first set of PDUs to the transmitter; and/or in the case that a data packet in the second set of PDUs is lost, or in the case that part of the data packets in the second set of PDUs are lost, the receiver feeds back retransmission of the lost part, all, or important part of the second set of PDUs to the transmitter. In some embodiments, in at least one of the cases that a data packet in the first set of PDUs is lost, part of the data packets in the first set of PDUs are lost, a data packet in the second set of PDUs is lost, one of the first control PDU/the second control PDU/the third control PDU is lost, and part of the data packets in the second set of PDUs are lost, the receiver feeds back retransmission of the lost part, all, or important part of the first set of PDUs to the transmitter; and/or the receiver feeds back retransmission of the lost part, all, or important part of the second set of PDUs to the transmitter.

16. SNs of the first set of PDUs and the second set of PDUs are added or removed.

In some embodiments, the transmitter adds the SNs to the first set of PDUs and the second set of PDUs, or the transmitter adds the SNs to the data packet of the first set of PDUs and the data packet of the second set of PDUs, or the transmitter adds the SNs to the sets of PDUs, or the transmitter adds the SNs to the data packets of the sets of PDUs, thereby ensuring that the receiver can deliver the data packets to the higher layer in order based on the SN numbers, or ensuring that the receiver delivers the data packets to the higher layer in order upon reordering based on the SN numbers.

17. Association indicators of the first set of PDUs and the second set of PDUs are added or removed.

In some embodiments, the transmitter adds the association indicators of the first set of PDUs and the second set of PDUs, or the transmitter adds the association indicators to the data packet of the first set of PDUs and the data packet of the second set of PDUs, or the transmitter adds the association indicators to the sets of PDUs, or the transmitter adds the association indicators to the data packets of the sets of PDUs, thereby ensuring that the receiver identifies the association relationship between the first set of PDUs and the second set of PDUs based on the association indicators.

18. Type indicators of the first set of PDUs and the second set of PDUs are added or removed.

In some embodiments, the transmitter adds the type indicators of the first set of PDUs and the second set of PDUs, or the transmitter adds the type indicators to the data packet of the first set of PDUs and the data packet of the second set of PDUs, or the transmitter adds the type indicators to the sets of PDUs, or the transmitter adds the type indicators to the data packets of the sets of PDUs, thereby ensuring that the receiver identifies the types of the first set of PDUs and the second set of PDUs based on the type indicators.

19. Importance indicators of the first set of PDUs and the second set of PDUs are added or removed.

In some embodiments, the transmitter adds the importance indicators of the first set of PDUs and the second set of PDUs, or the transmitter adds the importance indicators to the data packet of the first set of PDUs and the data packet of the second set of PDUs, or the transmitter adds the importance indicators to the sets of PDUs, or the transmitter adds the importance indicators to the data packets of the sets of PDUs, thereby ensuring that the receiver identifies the importance or the importance levels of the first set of PDUs and the second set of PDUs based on the importance indicators.

20. Dependency indicators of the first set of PDUs and the second set of PDUs are added or removed.

In some embodiments, the transmitter adds the dependency indicators of the first set of PDUs and the second set of PDUs, or the transmitter adds the dependency indicators to the data packet of the first set of PDUs and the data packet of the second set of PDUs, or the transmitter adds the dependency indicators to the sets of PDUs, or the transmitter adds the dependency indicators to the data packets of the sets of PDUs, thereby ensuring that the receiver identifies the dependency levels of or the dependency relationship between the first set of PDUs and the second set of PDUs based on the dependency indicators.

21. Reliability indicators of the first set of PDUs and the second set of PDUs are added or removed.

In some embodiments, the transmitter adds the reliability indicators of the first set of PDUs and the second set of PDUs, or the transmitter adds the reliability indicators to the data packet of the first set of PDUs and the data packet of the second set of PDUs, or the transmitter adds the reliability indicators to the sets of PDUs, or the transmitter adds the reliability indicators to the data packets of the sets of PDUs, thereby ensuring that the receiver identifies the reliability levels of or the reliability relationship between the first set of PDUs and the second set of PDUs based on the reliability indicators.

22. Priority indicators of the first set of PDUs and the second set of PDUs are added or removed.

In some embodiments, the transmitter adds the priority indicators of the first set of PDUs and the second set of PDUs, or the transmitter adds the priority indicators to the data packet of the first set of PDUs and the data packet of the second set of PDUs, or the transmitter adds the priority indicators to the sets of PDUs, or the transmitter adds the priority indicators to the data packets of the sets of PDUs, thereby ensuring that the receiver identifies the priority levels of or the priority relationship between the first set of PDUs and the second set of PDUs based on the priority indicators.

23. A data packet or a general packet radio service tunnelling protocol-U (GPRS tunnelling protocol-U, GTP-U) data packet corresponding to the first QoS flow is received from a higher layer of an access stratum (AS).

In some embodiments, the transmitter receives the data packet or the GTP-U data packet corresponding to the first QoS flow from the higher layer of the AS, wherein the data packet of the first QoS flow or the GTP-U data packet includes the first set of PDUs and the second set of PDUs.

In some embodiments, the transmitter receives the data packet corresponding to the first QoS flow from a higher layer of a layer where the first data is processed, wherein the data packet of the first QoS flow includes the first set of PDUs and the second set of PDUs.

In some embodiments, the transmitter receives information of the first set of PDUs and the second set of PDUs from the higher layer of the layer where the first data is processed for set of PDUs identification or for data processing.

24. A data packet or an SDAP SDU corresponding to the first QoS flow is received from a higher layer of the SDAP.

In some embodiments, the transmitter receives the data packet or the SDAP SDU corresponding to the first QoS flow from the higher layer of the SDAP, wherein the data packet of the first QoS flow or the SDAP SDU includes the first set of PDUs and the second set of PDUs.

In some embodiments, the transmitter receives information of the first set of PDUs and the second set of PDUs from the higher layer of the SDAP for set of PDUs identification or for data processing.

25. A data packet corresponding to the first QoS flow is received from a lower layer.

In some embodiments, the receiver receives the data packet corresponding to the first QoS flow from a lower layer of a layer where the first data is processed, wherein the data packet of the first QoS flow includes the first set of PDUs and the second set of PDUs.

26. A data packet or an SDAP PDU corresponding to the first QoS flow is received from a lower layer of the SDAP.

In some embodiments, the receiver receives the data packet or the SDAP PDU corresponding to the first QoS flow from the lower layer of the SDAP, wherein the data packet of the first QoS flow or the SDAP PDU includes the first set of PDUs and the second set of PDUs.

27. The first set of PDUs and the second set of PDUs are delivered in order.

In some embodiments, the receiver delivers the first set of PDUs and the second set of PDUs to the higher layer of the layer where the first data is processed based on a reordered sequence.

In some embodiments, the receiver delivers the first set of PDUs and the second set of PDUs to the higher layer of the SDAP based on the reordered sequence.

In summary, by performing data processing based on the first set of PDUs and the second set of PDUs corresponding to the first QoS flow, independent processing on the first set of PDUs and the second set of PDUs is avoided, the different processing requirements of different sets of PDUs are ensured and the efficiency of data processing is improved.

For example, the first set of PDUs and the second set of PDUs are mapped with the first QoS flow, wherein the first set of PDUs representing the I-frame is mapped and routed to path 1, and the second set of PDUs representing the P-frame is mapped and routed to path 2 (the compression decoding of the P-frame depending on the I-frame), thereby ensuring the different processing requirements of the I-frame and the P-frame, improving the efficiency of data processing, and avoiding undifferentiated processing on the set of PDUs representing the I-frame and the set of PDUs representing the P-frame.

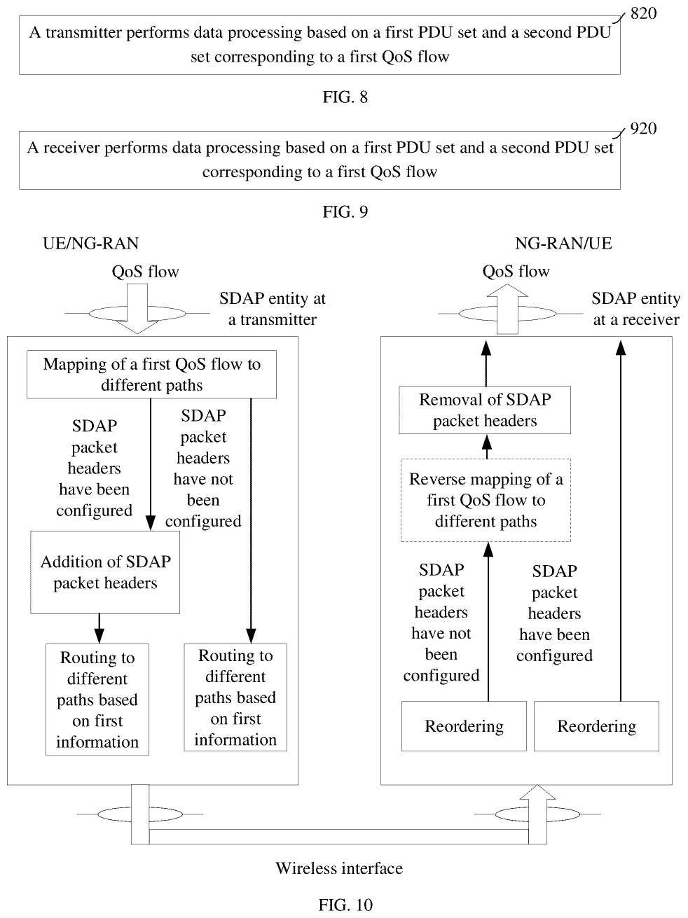

Based on the flowchart of the method for processing data as illustrated in FIG. 6, in the case that the method for processing data is performed by the transmitter, FIG. 8 is a flowchart of a method for processing data according to some embodiments of the present disclosure. The method includes the following process.

In 820, the transmitter performs data processing based on the first set of PDUs and the second set of PDUs corresponding to the first QoS flow.

In some embodiments, the data processing includes at least one of.
1. configuring different first identifiers for different paths;
2. configuring the first identifier configured for at least one path;
3. configuring an identifier for the first QoS flow, a PDU session, or an SDAP;
4. configuring or being configured with the mapping relationships between the first QoS flow and different paths;
5. configuring or being configured with the mapping relationships between at least one of the first set of PDUs or the second set of PDUs and different paths;
6. identifying the first set of PDUs and the second set of PDUs are identified;
7. adding packet headers of different data packets of the first set of PDUs and the second set of PDUs;
8. adding a control PDU for the first data or for the set of PDUs;
9. adding different control PDUs of the first set of PDUs and the second set of PDUs;
10. adding a control PDU corresponding to at least one first set of PDUs and at least one second set of PDUs;
11. routing the first set of PDUs and the second set of PDUs to different paths;
12. deleting at least one of the first set of PDUs or the second set of PDUs;
13. retransmitting at least one of the first set of PDUs or the second set of PDUs;
14. adding SNs of the first set of PDUs and the second set of PDUs;
15. adding SNs of the data packet of the first set of PDUs and the data packet of the second set of PDUs;
16. adding association indicators of the first set of PDUs and the second set of PDUs;
17. adding type indicators of the first set of PDUs and the second set of PDUs;
18. adding importance indicators of the first set of PDUs and the second set of PDUs;
19. adding dependency indicators of the first set of PDUs and the second set of PDUs;
20. adding reliability indicators of the first set of PDUs and the second set of PDUs;
21. adding priority indicators of the first set of PDUs and the second set of PDUs;
22. receiving a data packet or a GTP-U data packet corresponding to the first QoS flow from a higher layer of the AS; or
23. receiving a data packet or an SDAP SDU corresponding to the first QoS flow from a higher layer of the SDAP.

In summary, the transmitter performs the data processing based on the first set of PDUs and the second set of PDUs corresponding to the first QoS flow, thereby avoiding undifferentiated processing on the first set of PDUs and the second set of PDUs, ensuring the different processing requirements of different sets of PDUs, and improving the efficiency of data processing.

Based on the flowchart of the method for processing data as illustrated in FIG. 6, in the case that the method for processing data is performed by the receiver, FIG. 9 is a flowchart of a method for processing data according to some embodiments of the present disclosure. The method includes the following process.

In 920, the receiver performs data processing based on the first set of PDUs and the second set of PDUs corresponding to the first QoS flow.

In some embodiments, the data processing includes at least one of:
1. configuring different first identifiers for different paths;
2. configuring the first identifier for at least one path;
3. configuring an identifier for the first QoS flow, a PDU session, or an SDAP;
4. configuring or being configured with the mapping relationships between the first QoS flow and different paths;
5. configuring or being configured with the mapping relationships between at least one of the first set of PDUs or the second set of PDUs and different paths;
6. identifying the first set of PDUs and the second set of PDUs;
7. removing different packet headers of the first set of PDUs and the second set of PDUs;
8. removing a control PDU for the first data or for the set of PDUs;
9. removing different control PDUs of the first set of PDUs and the second set of PDUs;
10. removing a control PDU corresponding to at least one first set of PDUs and at least one second set of PDUs;
11. recoding the first set of PDUs and the second set of PDUs;
12. recording different data packets of the first set of PDUs and the second set of PDUs;
13. deleting or feeding back deletion of at least one of the first set of PDUs or the second set of PDUs;
14. feeding back a transmission state of at least one of the first set of PDUs and the second set of PDUs;
15. freeding back a transmission state of at least one data packet in at least one of the first set of PDUs and the second set of PDUs;
16. feeding back retransmission of at least one of the first set of PDUs or the second set of PDUs;
17. removing SNs of the first set of PDUs and the second set of PDUs;
18. removing the SN of the data packet of the first set of PDUs and the SN of the data packet of the second set of PDUs;
19. removing association indicators of the first set of PDUs and the second set of PDUs;
20. removing type indicators of the first set of PDUs and the second set of PDUs;
21. removing importance indicators of the first set of PDUs and the second set of PDUs;
22. removing dependency indicators of the first set of PDUs and the second set of PDUs;
23. removing reliability indicators of the first set of PDUs and the second set of PDUs;
24. removing priority indicators of the first set of PDUs and the second set of PDUs;
25. receiving a data packet corresponding to the first QoS flow from a lower layer;
26. receiving a data packet or an SDAP PDU corresponding to the first QoS flow from a lower layer of the SDAP; or
27. delivering the first set of PDUs and the second set of PDUs in order.

In summary, the receiver performs the data processing based on the first set of PDUs and the second set of PDUs corresponding to the first QoS flow, thereby avoiding undifferentiated processing on the first set of PDUs and the second set of PDUs, ensuring the different processing requirements of different sets of PDUs, and improving the efficiency of data processing.

Referring to FIG. 10, in some embodiments, the SDAP layer of the transmitter receives the first set of PDUs representing the I-frame and the second set of PDUs representing the P-frame from the higher layer over the first QoS flow. The first set of PDUs generates an SDAP PDU 1 in the SDAP and adds a packet header to the SDAP PDU 1 (the packet header includes the SN number of the SDAP PDU 1), and the second set of PDUs generates an SDAP PDU 2 in the SDAP and adds a packet header to the SDAP PDU 2 (the packet header includes the SN number of the SDAP PDU 2, e.g., the SN of the SDAP PDU 2 is 2). The SDAP layer of the transmitter maps and routes the SDAP PDU 1 to DRB 1, and the SDAP layer of the transmitter maps and routes the SDAP PDU 2 to DRB 2. The SDAP layer of the receiver receives the first set of PDUs over the SDAP PDU 1 and the second set of PDUs over the SDAP PDU 2 from the lower layer, and performs reordering based on the packet header of the SDAP PDU 1 (the packet header includes the SN number of the SDAP PDU 1, e.g., the SN of the SDAP PDU 1 is 1) and the packet header of the SDAP PDU 2 (the packet header includes the SN number of the SDAP PDU 2). The first set of PDUs and the second set of PDUs are delivered to the higher layer in order based on the reordered sequence.

In some embodiments, the SN of the SDAP PDU 1 is 1, the SN of the SDAP PDU 2 is 2, the receiving order of the SDAP layer of the receiver is 2 and 1, the SDAP PDUs are reordered to 1 and 2 based on the SN numbers of the SDAP PDUs, and the first set of PDUs and the second set of PDUs are delivered to the higher layer.

Referring to FIG. 10, in some embodiments, the SDAP layer of the transmitter receives the first set of PDUs representing the I-frame and the second set of PDUs representing the P-frame from the higher layer over the first QoS flow. The SDAP layer generates a plurality of SDAP PDUs for transmitting the first set of PDUs and adds a packet header to each of the plurality of SDAP PDUs (the packet header includes at least one of the SN number of the SDAP PDU or the SN number of the first set of PDUs), and the SDAP layer generates a plurality of SDAP PDUs for transmitting the second set of PDUs and adds a packet header to each of the plurality of SDAP PDUs (the packet header includes at least one of the SN number of the SDAP PDU or the SN number of the second set of PDUs). The transmitter maps and routes the plurality of the SDAP PDUs for transmitting the first set of PDUs to DRB 1, and the transmitter maps and routes the plurality of the SDAP PDUs for transmitting the second set of PDUs to DRB 2. The SDAP layer of the receiver receives the first set of PDUs over the plurality of the SDAP PDUs and the second set of PDUs over the plurality of the SDAP PDUs from the lower layer, and performs reordering based on the packet headers of the SDAP PDUs (the packet headers include at least one of the SN numbers of the SDAP PDUs or the SN numbers of the sets of PDUs). The first set of PDUs and the second set of PDUs are delivered to the higher layer in order based on the reordered sequence.

For example, the SN numbers of three SDAP PDUs for transmitting the first set of PDUs are 1, 2, and 3, the SN numbers of three SDAP PDUs for transmitting the second set of PDUs are 4, 5, and 6, the receiving order of the SDAP layer of the receiver is 1, 3, 2, 4, 6, and 5, the SDAP PDUs are reordered to 1, 2, 3, 4, 5, and 6 based on the SN numbers of the SDAP PDUs, and the first set of PDUs and the second set of PDUs are delivered to the higher layer.

For example, the SN numbers of the first set of PDUs corresponding to three SDAP PDUs for transmitting the first set of PDUs are 1, 1, and 1, the SN numbers of the second set of PDUs corresponding to three SDAP PDUs for transmitting the second set of PDUs are 2, 2, and 2, the receiving order of the SDAP layer of the receiver is 1, 2, 2, 1, 1, and 2, the PDUs are reordered to 1, 1, 1, 2, 2, and 2 based on the SN numbers of the sets of PDUs, and the first set of PDUs and the second set of PDUs are delivered to the higher layer.

Referring to FIG. 10, in some embodiments, the SDAP layer of the transmitter receives the first set of PDUs representing the I-frame and the second set of PDUs representing the P-frame from the higher layer over the first QoS flow. The packet header of the first set of PDUs includes the SN of the first set of PDUs, and the packet header of the second set of PDUs includes the SN of the second set of PDUs. The SDAP layer of the transmitter maps and routes the first set of PDUs to DRB 1, and the SDAP layer of the transmitter maps and routes the second set of PDUs to DRB 2. The SDAP layer of the receiver receives the first set of PDUs representing the I-frame and the second set of PDUs representing the P-frame over the lower layer, performs reordering based on the SN of the first set of PDUs and the SN of the second set of PDUs, and delivers the first set of PDUs and the second set of PDUs to the higher layer in order.

For example, the SN of the first set of PDUs is 1, the SN of the second set of PDUs is 2, the receiving order of the SDAP layer of the receiver is 2 and 1, the sets of PDUs are reordered to 1 and 2 based on the SN numbers of the sets of PDUs, and the first set of PDUs and the second set of PDUs are delivered to the higher layer.

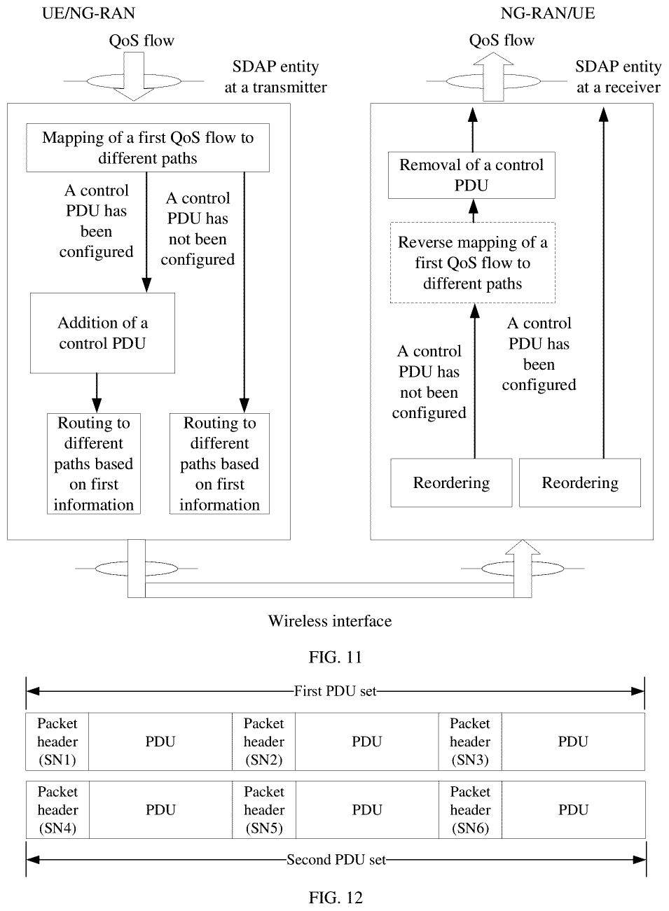

Referring to FIG. 11, in some embodiments, the SDAP layer of the transmitter receives the first set of PDUs representing the I-frame and the second set of PDUs representing the P-frame from the higher layer over the first QoS flow. The SDAP layer of the transmitter adds a first control PDU to the first set of PDUs and adds a second control PDU to the second set of PDUs. The SDAP layer of the transmitter maps and transmits the first set of PDUs to DRB 1 (e.g., the first control PDU is transmitted over DRB 1 and precedes the data packet of the first set of PDUs), and the SDAP layer of the transmitter maps and transmits the second set of PDUs to DRB 2 (e.g., the second control PDU is transmitted over DRB 2 and precedes the data packet of the second set of PDUs). The SDAP layer of the receiver receives the first set of PDUs representing the I-frame and the second set of PDUs representing the P-frame from the lower layer, performs reordering based on information of the first control PDU and information of the second control PDU, and delivers the first set of PDUs and the second set of PDUs to the higher layer in order.

Referring to FIG. 11, in some embodiments, the SDAP layer of the transmitter receives the first set of PDUs representing the I-frame and the second set of PDUs representing the P-frame from the higher layer over the first QoS flow. The SDAP layer of the transmitter adds a third control PDU to the first set of PDUs and the second set of PDUs. The SDAP layer of the transmitter maps and transmits the first set of PDUs to DRB 1, and the SDAP layer of the transmitter maps and transmits the second set of PDUs to DRB 2 (in addition, for example, the third control PDU is transmitted by the transmitter over DRB 1 or DRB 2 and precedes the data packet of the first set of PDUs, or precedes the data packet of the second set of PDUs). The SDAP layer of the receiver receives the first set of PDUs representing the I-frame and the second set of PDUs representing the P-frame from the lower layer, performs reordering based on information of the third control PDU, and delivers the first set of PDUs and the second set of PDUs to the higher layer in order.

Referring to FIG. 11, in some embodiments, the SDAP layer of the transmitter receives the first set of PDUs 1 representing the I-frame and the second set of PDUs 1 representing the P-frame from the higher layer over the first QoS flow. The SDAP layer of the transmitter adds a third control PDU 1 to the first set of PDUs 1 and the second set of PDUs 1. The SDAP layer of the transmitter maps and transmits the first set of PDUs 1 to DRB 1, and the SDAP layer of the transmitter maps and transmits the second set of PDUs 1 to DRB 2. In addition, for example, the third control PDU1 is transmitted by the transmitter over DRB 1 or DRB 2 and precedes the data packet of the first set of PDUs 1, or precedes the data packet of the second set of PDUs 1. The SDAP layer of the receiver receives the first set of PDUs 1 representing the I-frame and the second set of PDUs 1 representing the P-frame from the lower layer, and performs reordering based on information of the third control PDU1. Further, the SDAP layer of the transmitter receives the first set of PDUs 2 representing the I-frame and the second set of PDUs 2 representing the P-frame from the higher layer over the first QoS flow. The SDAP layer of the transmitter adds a third control PDU2 to the first set of PDUs 2 and the second set of PDUs 2. The SDAP layer of the transmitter maps and transmits the first set of PDUs 2 to DRB 1, and the SDAP layer of the transmitter maps and transmits the second set of PDUs 2 to DRB 2. In addition, for example, the third control PDU 2 is transmitted by the transmitter over DRB 1 or DRB 2 and precedes the data packet of the first set of PDUs 2, or precedes the data packet of the second set of PDUs 2. The SDAP layer of the receiver receives the first set of PDUs 2 representing the I-frame and the second set of PDUs 2 representing the P-frame from the lower layer, and performs reordering based on information of the third control PDU 2. The SDAP layer of the receiver reorders the first set of PDUs 1, the second set of PDUs 1, the first set of PDUs 2 and the second set of PDUs 2 based on the SNs in the third control PDU 1 and the third control PDU 2, and delivers the first set of PDUs 1, the second set of PDUs 1, the first set of PDUs 2, and the second set of PDUs 2 to the higher layer in order.

It should be noted that, in the present disclosure, the data packet refers to an AS PDU. In some embodiments, the AS PDU is an SDAP PDU.

It should be noted that, in the present disclosure, the SDAP of the receiver may be replaced by a PDCP of the receiver, or replaced by a primary PDCP of the receiver, or replaced by a target PDCP of the receiver. In addition, the SDAP of the transmitter may be replaced by a PDCP of the transmitter, or replaced by a primary PDCP of the transmitter, or replaced by a target PDCP of the transmitter. That is, the corresponding functions can be implemented by the PDCP, or by the primary PDCP, or by the target PDCP.

Based on the method embodiments illustrated in FIG. 6 or FIG. 9, the following possible embodiments are present for reordering the first set of PDUs and the second set of PDUs by the receiver.

In a first possible embodiment: the first set of PDUs and the second set of PDUs are reordered based on the SNs of the first set of PDUs and the second set of PDUs, or based on the SN of the data packet (SDAP PDU) of the first set of PDUs and the SN of the data packet (SDAP PDU) of the second set of PDUs, or based on the SN of the data packet (SDAP PDU) of the PDU in the first set of PDUs and the SN of the data packet (SDAP PDU) of the PDU in the second set of PDUs, or based on at least one of the SN of the PDU in the first set of PDUs and the SN of the PDU in the second set of PDUs, the type indicators of the first set of PDUs and the second set of PDUs, the dependency indicators of the first set of PDUs and the second set of PDUs, the priority indicators of the first set of PDUs and the second set of PDUs, the association indicators of the first set of PDUs and the second set of PDUs, and the importance indicators of the first set of PDUs and the second set of PDUs.

For example, the receiver receives the data packets corresponding to the first set of PDUs and the second set of PDUs, and reorders the first set of PDUs and the second set of PDUs based on the SN of the data packet of the first set of PDUs and the SN of the data packet of the second set of PDUs.

For example, the receiver receives the data packets corresponding to the first set of PDUs and the second set of PDUs, and reorders the first set of PDUs and the second set of PDUs based on the SNs of the first set of PDUs and the second set of PDUs.

For example, the receiver receives the data packets corresponding to the first set of PDUs and the second set of PDUs or corresponding to the PDUs in the first set of PDUs and the second set of PDUs, and reorders the first set of PDUs and the second set of PDUs based on the SN of the PDU in the first set of PDUs and the SN of the PDU in the second set of PDUs.

For example, the receiver receives the data packets corresponding to the first set of PDUs and the second set of PDUs or corresponding to the PDUs in the first set of PDUs and the second set of PDUs, and reorders the first set of PDUs and the second set of PDUs based on the SN of the data packet of the PDU in the first set of PDUs and the SN of the data packet of the PDU in the second set of PDUs.

For example, the data packets of the first set of PDUs and the second set of PDUs are from different paths of the lower layer, and/or the data packets of the first set of PDUs and the second set of PDUs are from the same path of the lower layer.

In a second possible embodiment: at least one of the first set of PDUs or the second set of PDUs are reordered based on information of a first packet header; and/or at least one of the first set of PDUs or the second set of PDUs are reordered based on information of a second packet header; and/or at least one of the first set of PDUs or the second set of PDUs are reordered based on the information of the first packet header and the information of the second packet header, wherein the first packet header is a packet header corresponding to the first set of PDUs, and the second packet header is a packet header corresponding to the second set of PDUs; or the first packet header is a packet header of at least one data packet corresponding to the first set of PDUs, and the second packet header is a packet header of at least one data packet corresponding to the second set of PDUs.

In some embodiments, the first packet header includes at least one of the SN of the first set of PDUs corresponding to the data packet to which the first packet header belongs, the association indicator of the first set of PDUs corresponding to the data packet to which the first packet header belongs, the type indicator of the first set of PDUs corresponding to the data packet to which the first packet header belongs, or the importance indicator of the first set of PDUs corresponding to the data packet to which the first packet header belongs.

In some embodiments, the second packet header includes at least one of the SN of the second set of PDUs corresponding to the data packet to which the second packet header belongs, the association indicator of the second set of PDUs corresponding to the data packet to which the second packet header belongs, the type indicator of the second set of PDUs corresponding to the data packet to which the second packet header belongs, or the importance indicator of the second set of PDUs corresponding to the data packet to which the second packet header belongs.

In some embodiments, the first packet header includes at least one of the SN of the first set of PDUs corresponding to the data packet to which the first packet header belongs, the SN of the data packet to which the first packet header belongs, or the SN of the data packet of the PDU in the first set of PDUs corresponding to the data packet to which the first packet header belongs.

In some embodiments, the second packet header includes at least one of the SN of the second set of PDUs corresponding to the data packet to which the second packet header belongs, the SN of the data packet to which the second packet header belongs, or the SN of the data packet of the PDU in the second set of PDUs corresponding to the data packet to which the second packet header belongs.

In some embodiments, the first packet header includes at least one of the SN of the first set of PDUs corresponding to the data packet to which the first packet header belongs, the SN of the data packet to which the first packet header belongs, the SN of the data packet of the PDU in the first set of PDUs corresponding to the data packet to which the first packet header belongs, the association indicator of the first set of PDUs corresponding to the data packet to which the first packet header belongs, the type indicator of the first set of PDUs corresponding to the data packet to which the first packet header belongs, or the importance indicator of the first set of PDUs corresponding to the data packet to which the first packet header belongs.

In some embodiments, the second packet header includes at least one of the SN of the second set of PDUs corresponding to the data packet to which the second packet header belongs, the SN of the data packet to which the second packet header belongs, the SN of the data packet of the PDU in the second set of PDUs corresponding to the data packet to which the second packet header belongs, the association indicator of the second set of PDUs corresponding to the data packet to which the second packet header belongs, the type indicator of the second set of PDUs corresponding to the data packet to which the second packet header belongs, or the importance indicator of the second set of PDUs corresponding to the data packet to which the second packet header belongs.

In some embodiments, the format of at least one of the first packet header or the second packet header is the format of a target packet header (new packet header).

In some embodiments, the receiver receives a plurality of data packets corresponding to the first set of PDUs, and reorders the plurality of data packets of the first set of PDUs based on the SNs of the plurality of data packets corresponding to the first set of PDUs included in the packet headers of the data packets (the SNs of the data packets to which the packet headers belong).

In some embodiments, the receiver receives a plurality of data packets corresponding to the first set of PDUs, and reorders the plurality of data packets of the first set of PDUs based on the SNs of the PDUs in the corresponding first set of PDUs included in the packet headers of the data packets (the SNs of the PDUs in the set of PDUs included in the data packets to which the packet headers belong).

In some embodiments, the receiver receives the data packets corresponding to the first set of PDUs and the second set of PDUs, and reorders the first set of PDUs and the second set of PDUs based on the SN of the data packet of the first set of PDUs and the SN of the data packet of the second set of PDUs that are included in the packet header of the data packet.

In some embodiments, the receiver receives the data packets corresponding to the first set of PDUs and the second set of PDUs, and reorders the first set of PDUs and the second set of PDUs based on the SNs of the first set of PDUs and the second set of PDUs included in the packet header of the data packet.

In some embodiments, the receiver receives the data packets corresponding to the first set of PDUs and the second set of PDUs, and reorders the first set of PDUs and the second set of PDUs based on the SN of the PDU in the first set of PDUs and the SN of the PDU in the second set of PDUs that are included in the packet header of the data packet.

In some embodiments, the receiver receives the data packets corresponding to the first set of PDUs and the second set of PDUs or corresponding to the PDUs in the first set of PDUs and the second set of PDUs, and reorders the first set of PDUs and the second set of PDUs based on the SN of the data packet of the PDU in the first set of PDUs and the SN of the data packet of the PDU in the second set of PDUs that are included in the packet header of the data packet.

In some embodiments, the data packets of the first set of PDUs and the second set of PDUs are from different paths of the lower layer, and/or the data packets of the first set of PDUs and the second set of PDUs are from the same path of the lower layer.

In a third possible embodiment (possibly including at least one of the following sub-embodiments):

In a first sub-embodiment, the first set of PDUs and the second set of PDUs are reordered based on the SN of the data packet of the first set of PDUs corresponding to the first packet header and the SN of the data packet of the second set of PDUs corresponding to the second packet header.

For example, the SN of the data packet of the first set of PDUs corresponding to the first packet header is the SN of the data packet to which the first packet header belongs.

Referring to FIG. 12, the SN numbers of all or part of the data packets of the first set of PDUs are 1, 2, and 3, and the SN numbers of all or part of the data packets of the second set of PDUs are 4, 5, and 6. In the case that the receiver receives the data packets of the first set of PDUs and the second set of PDUs, the data packets are received in an order of 1, 2, 4, 5, 3, and 6, and then the receiver reorders the first set of PDUs and the second set of PDUs to 1, 2, 3, 4, 5, and 6 based on the SN numbers of all or part of the data packets of the first set of PDUs and the SN numbers of all or part of the data packets of the second set of PDUs.

For example, the data packets of the first set of PDUs and the second set of PDUs are from different paths of the lower layer, and/or the data packets of the first set of PDUs and the second set of PDUs are from the same path of the lower layer.

In a second sub-embodiment, the first set of PDUs and the second set of PDUs are reordered based on the SN of the PDU in the first set of PDUs corresponding to the first packet header and the SN of the PDU in the second set of PDUs corresponding to the second packet header.

For example, the SN of the PDU in the first set of PDUs corresponding to the first packet header is the SN of the PDU in the set of PDUs in the data packet to which the first packet header belongs.

Referring to FIG. 12, the SN numbers of the PDUs in the first set of PDUs are 1, 2, and 3, and the SN numbers of the PDUs in the second set of PDUs are 4, 5, and 6. In the case that the receiver receives the data packets of the first set of PDUs and the second set of PDUs, an order of the SNs of the PDUs corresponding to the received data packets is 1, 2, 4, 5, 3, and 6, and then the receiver reorders the first set of PDUs and the second set of PDUs or the PDUs in the first set of PDUs and the second set of PDUs to 1, 2, 3, 4, 5, and 6 based on the SNs of the PDUs in the first set of PDUs and the SNs of the PDUs in the second set of PDUs corresponding to the second packet header.

For example, the data packets of the first set of PDUs and the second set of PDUs are from different paths of the lower layer, and/or the data packets of the first set of PDUs and the second set of PDUs are from the same path of the lower layer.

In a third sub-embodiment, the first set of PDUs and the second set of PDUs are reordered based on the SN of the first set of PDUs corresponding to the first packet header and the SN of the second set of PDUs corresponding to the second packet header.

For example, the SN of the first set of PDUs corresponding to the first packet header is the SN of the set of PDUs in the data packet to which the first packet header belongs.

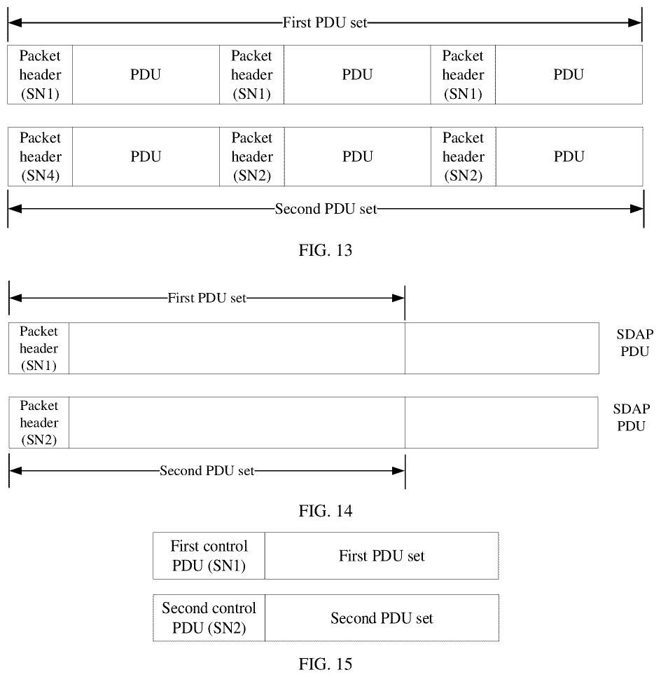

Referring to FIG. 13, the SN numbers of the first set of PDUs corresponding to all or part of the data packets of the first set of PDUs are 1, 1, and 1, and the SN numbers of the first set of PDUs corresponding to all or a part of the data packets of the second set of PDUs are 2, 2, and 2. In the case that the receiver receives the data packets of the first set of PDUs and the second set of PDUs, the data packets or the sets of PDUs of the data packets are received in an order of 1, 1, 2, 2, 1, and 2, and then the receiver reorders the first set of PDUs and the second set of PDUs to 1, 1, 1, 2, 2, and 2 based on the SN numbers of the first set of PDUs and the SN numbers of the second set of PDUs.

Referring to FIG. 14, the SN number of the first set of PDUs corresponding to all data packets of the first set of PDUs is 1, and the SN number of the first set of PDUs corresponding to all data packets of the second set of PDUs is 2. In the case that the receiver receives the data packets of the first set of PDUs and the second set of PDUs, the data packets or sets of PDUs are received in an order of 2 and 1, and then the receiver reorders the first set of PDUs and the second set of PDUs to 1 and 2 based on the SN number of the first set of PDUs and the SN number of the second set of PDUs.

For example, the data packets of the first set of PDUs and the second set of PDUs are from different paths of the lower layer, and/or the data packets of the first set of PDUs and the second set of PDUs are from the same path of the lower layer.

In a fourth possible embodiment: the receiver operates based on the identifier or SN of the data packet, and/or operates based on a reordering timer. In some embodiments, the reordering timer is predefined or configured by a network device.

It should be noted that the following sub-embodiments may be used alone or in combination.

In a first sub-embodiment, in the case that the receiver receives the data packet, upon receipt of at least one of the first control PDU, the second control PDU, and the third control PDU, a reordering timer corresponding to the control PDU is started. Alternatively, in the case that the timer is not running and RX_REORD (the SN of the SDAP PDU that triggers the reordering timer) is updated to RX_NEXT (the SN of a next SDAP PDU that is expected to be received), the reordering timer is started.

For example, in the case that the reordering timer is running and RX_DELIV (the SN of the earliest SDAP PDU not yet transmitted to a higher layer) is greater than or equal to RX_REORD, the reordering timer is stopped and reset.

For example, in the case that the reordering timer is not running and RX_DELIV is less than RX_NEXT, RX_REORD is updated to RX_NEXT. For example, in the case that the reordering timer is not running and RX_DELIV is less than RX_NEXT, the reordering timer is started.

In a second sub-embodiment, in the case that the timer times out, the receiver directly delivers the data packets to the higher layer, or the receiver delivers the data packets to the higher layer in order.

For example, in the case that the reordering timer times out, the SDAP entity of the receiver performs at least one of the following operations.

In the case that the packet header is not decompressed, the SDAP SDUs are transmitted to the higher layer in an ascending order of the associated numerical values upon the packet header being decompressed. In some embodiments, all stored SDAP SDU(s) with associated numerical values less than RX_REORD are delivered to the higher layer in order. In some embodiments, all stored SDAP SDUs starting from RX_REORD are delivered to the higher layer in order. In some embodiments, all stored SDAP SDUs with continuity starting from RX_REORD are delivered to the higher layer in order.

RX_DELIV is updated to a numerical value of the 1st SDAP SDU not yet delivered to the higher layer, wherein the numerical value is greater than or equal to RX_REORD. In some embodiments, in the case that RX_DELIV is less than RX_NEXT, RX_REORD is updated to RX_NEXT. In some embodiments, in the case that RX_DELIV is less than RX_NEXT, reordering is started.

In a third sub-embodiment, in the case that the timer is reconfigured, the timer is stopped and restarted.

For example, in the case that the reordering timer is running and the numerical value of the reordering timer has been reconfigured by the higher layer, the SDAP entity of the receiver shall perform at least one of the following operations.

RX_REORD is updated to RX_NEXT.

The reordering timer is stopped and restarted.

In a fourth sub-embodiment, the receiver operates based on the identifier or SN of the data packet.

In some embodiments, the receiver directly delivers the data packets to the higher layer based on the identifier or SN of the data packet, or delivers the data packets to the higher layer in order based on the identifier or SN of the data packet.

For example, in the case that RCVD_COUNT (the numerical value of the received SDAP PDU) is equal to RX_DELIV, the SDAP PDUs are transmitted to the higher layer in an ascending order of the associated numerical values. For example, in the case that RCVD_COUNT (the numerical value of the received SDAP PDU) is equal to RX_DELIV, all stored SDAP SDU(s) that are continuous starting from a numerical value equal to RX_DELIV are delivered to the higher layer in order. For example, in the case that RCVD_COUNT (the numerical value of the received SDAP PDU) is equal to RX_DELIV, all stored SDAP SDU(s) starting from a numerical value equal to RX_DELIV are delivered to the higher layer in order.

In a fifth sub-embodiment, in the case that out-of-order delivery has been configured, the receiver delivers the data packets to the higher layer, or does not perform the reordering operation.

For example, in the case that out-of-order delivery has been configured, the acquired SDAP SDUs are delivered to the higher layer.

It should be noted that the fourth possible embodiment may be used in combination with other embodiments or alone.

In a fifth possible embodiment: at least one of the first set of PDUs or the second set of PDUs is reordered based on the information of the first control PDU; and/or at least one of the first set of PDUs or the second set of PDUs is reordered based on the information of the second control PDU; and/or at least one of the first set of PDUs or the second set of PDUs is reordered based on the information of the first control PDU and the information of the second control PDU; and/or the first set of PDUs and the second set of PDUs is reordered based on the information of the third control PDU, wherein the first control PDU is a control PDU corresponding to the first set of PDUs, the second control PDU is a control PDU corresponding to the second set of PDUs, and the third control PDU is a control PDU corresponding to the first set of PDUs and the second set of PDUs.

In some embodiments, the information of the first control PDU includes at least one of the SN of the first control PDU, the SN of the corresponding first set of PDUs, the type of the control PDU, the start marker of the corresponding first set of PDUs, the end marker of the corresponding first set of PDUs, the association indicator of the corresponding first set of PDUs, the type indicator of the corresponding first set of PDUs, the importance indicator of the corresponding first set of PDUs, the association level of the corresponding first set of PDUs, the importance level of the corresponding first set of PDUs, or the bitmap indicator of the corresponding first set of PDUs.

In some embodiments, the information of the second control PDU includes at least one of the SN of the second control PDU, the SN of the corresponding second set of PDUs, the type of the control PDU, the start marker of the corresponding second set of PDUs, the end marker of the corresponding second set of PDUs, the association indicator of the corresponding second set of PDUs, the type indicator of the corresponding second set of PDUs, the importance indicator of the corresponding second set of PDUs, the association level of the corresponding second set of PDUs, the importance level of the corresponding second set of PDUs, or the bitmap indicator of the corresponding second set of PDUs.

In some possible embodiments, the information of the first control PDU includes at least one of: the SN of the first control PDU, the SN of the corresponding first set of PDUs, the SNs of a plurality of PDUs in the corresponding first set of PDUs, the type of the control PDU; the start marker of the corresponding first set of PDUs, the end marker of the corresponding first set of PDUs, the association indicator of the corresponding first set of PDUs, the type indicator of the corresponding first set of PDUs, the importance indicator of the corresponding first set of PDUs, the association level of the corresponding first set of PDUs, the importance level of the corresponding first set of PDUs, or the bitmap indicator of the corresponding first set of PDUs.

In some possible embodiments, the information of the second control PDU includes at least one of the SN of the second control PDU, the SN of the corresponding second set of PDUs, the SNs of a plurality of PDUs in the corresponding second set of PDUs, the type of the control PDU, the start marker of the corresponding second set of PDUs, the end marker of the corresponding second set of PDUs, the association indicator of the corresponding second set of PDUs, the type indicator of the corresponding second set of PDUs, the importance indicator of the corresponding second set of PDUs, the association level of the corresponding second set of PDUs, the importance level of the corresponding second set of PDUs, or the bitmap indicator of the corresponding second set of PDUs.

In some possible embodiments, the information of the third control PDU includes at least one of the SN of the third control PDU, the SN of the corresponding first set of PDUs, the SN of the corresponding second set of PDUs, the type of the control PDU, the start marker corresponding to the first set of PDUs and the second set of PDUs, the end marker corresponding to the first set of PDUs and the second set of PDUs, the association indicator corresponding to the first set of PDUs and the second set of PDUs, the type indicator corresponding to the first set of PDUs and the second set of PDUs, the importance indicator corresponding to the first set of PDUs and the second set of PDUs, the association level corresponding to the first set of PDUs and the second set of PDUs, the importance level corresponding to the first set of PDUs and the second set of PDUs, or the bitmap indicator corresponding to the first set of PDUs and the second set of PDUs.

For example, the receiver receives the first control PDU corresponding to the first set of PDUs, and reorders the plurality of PDUs in the first set of PDUs based on information in the control PDU.

For example, the receiver receives the second control PDU corresponding to the second set of PDUs, and reorders the plurality of PDUs in the second set of PDUs based on information in the control PDU.

For example, the receiver receives the first control PDU corresponding to the first set of PDUs and the second control PDU corresponding to the second set of PDUs, and reorders the first set of PDUs and the second set of PDUs based on the information in the control PDUs.

For example, the receiver receives the third control PDU corresponding to the first set of PDUs and the second set of PDUs, and reorders the first set of PDUs and the second set of PDUs based on the bitmap indicator in the control PDU (e.g., the first set of PDUs and the second set of PDUs are in an ascending order or a descending order in the bitmap, and the corresponding path bit positions respectively indicate routing paths of the first set of PDUs and the second set of PDUs).

For example, the receiver receives the third control PDU 1 corresponding to the first set of PDUs and the second set of PDUs, and reorders the first set of PDUs and the second set of PDUs based on the bitmap indicator in the third control PDU 1 (e.g., the first set of PDUs and the second set of PDUs are in an ascending order or a descending order in the bitmap, and the corresponding path bit positions respectively indicate routing paths of the first set of PDUs and the second set of PDUs). The receiver receives the third control PDU 2 corresponding to the third set of PDUs and the fourth set of PDUs, and reorders the third set of PDUs and the fourth set of PDUs based on the bitmap indicator in the third control PDU 2 (e.g., the third set of PDUs and the fourth set of PDUs are in an ascending order or a descending order in the bitmap, and the corresponding path bit positions respectively indicate routing paths of the third set of PDUs and the fourth set of PDUs). The receiver reorders the first set of PDUs, the second set of PDUs, the third set of PDUs and the fourth set of PDUs based on the control PDU information (e.g., an SN value is 1) in the third control PDU 1 and the control PDU information (e.g., an SN value is 2) in the third control PDU 2, or reorders the third control PDU 1 and the third control PDU 2 based on the control PDU information in the third control PDU 1 and the control PDU information in the third control PDU 2.

For example, the data packets of the first set of PDUs and the second set of PDUs are from different paths of the lower layer, and/or the data packets of the first set of PDUs and the second set of PDUs are from the same path of the lower layer.

In a sixth possible embodiment: the first set of PDUs and the second set of PDUs are reordered based on the SN of the first control PDU and the SN of the second control PDU; and/or the first set of PDUs and the second set of PDUs are reordered based on the SN of the first control PDU, the SN of the second control PDU, and the SN of the third control PDU; and/or the set of PDUs corresponding to the first control PDU and the set of PDUs corresponding to the second control PDU are reordered based on the SN of the first control PDU, the SN of the second control PDU, and the SN of the third control PDU, wherein the first control PDU is a control PDU corresponding to the first set of PDUs, the second control PDU is a control PDU corresponding to the second set of PDUs, and the third control PDU is a control PDU corresponding to the first set of PDUs and the second set of PDUs, or the third control PDU is a control PDU corresponding to the set of PDUs of the first control PDU and the set of PDUs of the second control PDU.

In some embodiments, the information of the first control PDU includes at least one of the SN of the first control PDU, the SN of the corresponding first set of PDUs, the type of the control PDU, the start marker of the corresponding first set of PDUs, the end marker of the corresponding first set of PDUs, the association indicator of the corresponding first set of PDUs, the type indicator of the corresponding first set of PDUs, the importance indicator of the corresponding first set of PDUs, the association level of the corresponding first set of PDUs, the importance level of the corresponding first set of PDUs, or the bitmap indicator of the corresponding first set of PDUs.

In some embodiments, the information of the second control PDU includes at least one of the SN of the second control PDU, the SN of the corresponding second set of PDUs, the type of the control PDU, the start marker of the corresponding second set of PDUs, the end marker of the corresponding second set of PDUs, the association indicator of the corresponding second set of PDUs, the type indicator of the corresponding second set of PDUs, the importance indicator of the corresponding second set of PDUs, the association level of the corresponding second set of PDUs, the importance level of the corresponding second set of PDUs, or the bitmap indicator of the corresponding second set of PDUs.

In some embodiments, the information of the third control PDU includes at least one of the SN of the third control PDU, the SN of the corresponding first set of PDUs, the SN of the corresponding second set of PDUs, the type of the control PDU; the start marker corresponding to the first set of PDUs and the second set of PDUs, the end marker corresponding to the first set of PDUs and the second set of PDUs, the association indicator corresponding to the first set of PDUs and the second set of PDUs, the type indicator corresponding to the first set of PDUs and the second set of PDUs, the importance indicator corresponding to the first set of PDUs and the second set of PDUs, the association level corresponding to the first set of PDUs and the second set of PDUs, the importance level corresponding to the first set of PDUs and the second set of PDUs, or the bitmap indicator corresponding to the first set of PDUs and the second set of PDUs.

For example, the receiver receives the first control PDU corresponding to the first set of PDUs and the second control PDU corresponding to the second set of PDUs, and reorders the first set of PDUs and the second set of PDUs based on the SN numbers in the control PDUs.

For example, the receiver receives the third control PDU corresponding to the first set of PDUs and the second set of PDUs, and reorders the first set of PDUs and the second set of PDUs based on the bitmap indicator in the control PDU (e.g., the first set of PDUs and the second set of PDUs are in an ascending order or a descending order in the bitmap, and the corresponding path bit positions respectively indicate routing paths of the first set of PDUs and the second set of PDUs).

For example, the receiver receives the third control PDU 1 corresponding to the first set of PDUs and the second set of PDUs, and reorders the first set of PDUs and the second set of PDUs based on the bitmap indicator in the third control PDU 1 (e.g., the first set of PDUs and the second set of PDUs are in an ascending order or a descending order in the bitmap, and the corresponding path bit positions respectively indicate routing paths of the first set of PDUs and the second set of PDUs). The receiver receives the third control PDU 2 corresponding to the third set of PDUs and the fourth set of PDUs, and reorders the third set of PDUs and the fourth set of PDUs based on the bitmap indicator in the third control PDU 2 (e.g., the third set of PDUs and the fourth set of PDUs are in an ascending order or a descending order in the bitmap, and the corresponding path bit positions respectively indicate routing paths of the third set of PDUs and the fourth set of PDUs). The receiver reorders the first set of PDUs, the second set of PDUs, the third set of PDUs and the fourth set of PDUs based on the SN of the control PDU (e.g., a value is 1) in the third control PDU 1 and the SN of the control PDU (e.g., a value is 2) in the third control PDU 2, or reorders the third control PDU 1 and the third control PDU 2 based on the SN of the control PDU in the third control PDU 1 and the SN of the control PDU in the third control PDU 2.

For example, the data packets of the first set of PDUs and the second set of PDUs are from different paths of the lower layer, and/or the data packets of the first set of PDUs and the second set of PDUs are from the same path of the lower layer.

For example, referring to FIG. 15, the first set of PDUs and the second set of PDUs are reordered based on SN 1 of the first control PDU and SN 2 of the second control PDU.

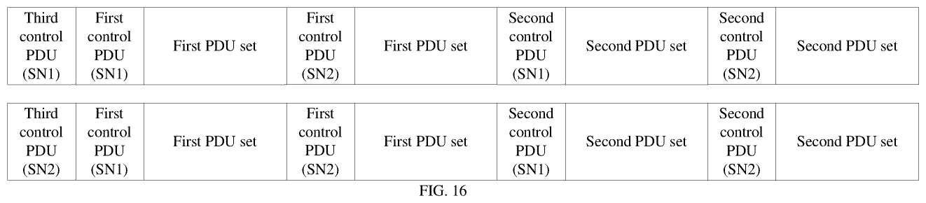

For example, referring to FIG. 16, the first set of PDUs and the second set of PDUs are reordered based on the third control PDU with the SN number 1 and the third control PDU with the SN number 2.

In at least one first set of PDUs and at least one second set of PDUs corresponding to the third control PDU with the SN number 1, the first set of PDUs corresponding to the first control PDU with the SN number 1, the first set of PDUs corresponding to the first control PDU with the SN number 2, the second set of PDUs corresponding to the second control PDU with the SN number 1, and the second set of PDUs corresponding to the second control PDU with the SN number 2 are reordered.

Alternatively, in at least one first set of PDUs and at least one second set of PDUs corresponding to the third control PDU with the SN number 2, the first set of PDUs corresponding to the first control PDU with the SN number 1, the first set of PDUs corresponding to the first control PDU with the SN number 2, the second set of PDUs corresponding to the second control PDU with the SN number 1, and the second set of PDUs corresponding to the second control PDU with the SN number 2 are reordered.

Alternatively, the set of PDUs corresponding to the third control PDU with the SN number being 1 and the set of PDUs corresponding to the third control PDU with the SN number being 2 are reordered.

In a seventh possible embodiment: the first set of PDUs and the second set of PDUs are reordered based on the bitmap indicator of the first control PDU; and/or the first set of PDUs and the second set of PDUs are reordered based on the bitmap indicator of the second control PDU; and/or the first set of PDUs and the second set of PDUs are reordered based on the bitmap indicator of the third control PDU, wherein the first control PDU is a control PDU corresponding to the first set of PDUs, the second control PDU is a control PDU corresponding to the second set of PDUs, and the third control PDU is a control PDU corresponding to the first set of PDUs and the second set of PDUs.

In some embodiments, the bitmap indicator indicates the information of at least one set of PDUs. The bitmap indicator includes at least one of the SN of the control PDU, the SN of the corresponding first set of PDUs, the SN of the corresponding second set of PDUs, the type of the control PDU, the number of corresponding sets of PDUs, the routing path of the corresponding set of PDUs, or the identifier of the corresponding set of PDUs.

The bitmap indicator indicates at least one of: which path the set of PDUs corresponding to the control PDU to which the bitmap indicator belongs is delivered to, which paths other sets of PDUs are delivered to, which sets of PDUs are delivered to the first path, which sets of PDUs are delivered to the second path, which sets of PDUs are delivered to a specific path, which path at least one set of PDUs between the start markers is delivered to, which path at least one set of PDUs between the end markers is delivered to, or which path at least one set of PDUs between the start marker and the end marker is delivered to.

The detailed process for reordering the first set of PDUs and the second set of PDUs based on the bitmap indicator will be described hereinafter. It should be noted that the bitmap indicator adopted in the following description may be acquired by combining, distinguishing, or segmenting at least one of the bitmap indicator in the first control PDU, the bitmap indicator in the second control PDU, or the bitmap indicator in the third control PDU.

In some embodiments, the bitmap indicator indicates a routing path of at least one set of PDUs by implicit representation. The following will be described by three possible design modes.

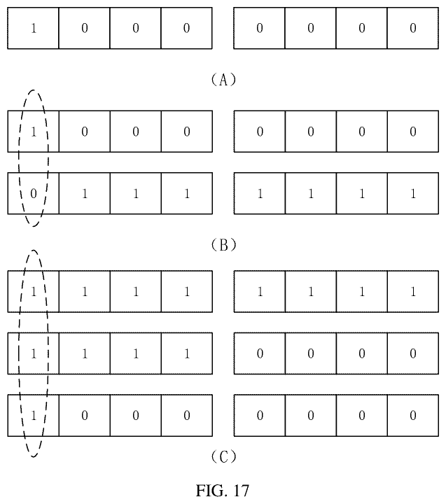

In a design mode 1, referring to part (A) of FIG. 17, the bitmap indicator includes 8 bits, wherein “1” indicates transmission over path 1, “0” indicates transmission over path 2, and the bitmap indicator of the control PDU of a plurality of sets of PDUs, or the bitmap indicator of at least one first set of PDUs and at least one second set of PDUs, or the bitmap indicator of a group of the first sets of PDUs (or a group of the second sets of PDUs), or the bitmap indicator of the control PDU of the first set of PDUs (or the control PDU of the second set of PDUs) is 1000 0000, which sequentially corresponds to the first set of PDUs to the eighth set of PDUs from left to right. As indicated by the bitmap indicator, the first set of PDUs is transmitted over path 1, and the second set of PDUs to the eighth set of PDUs are transmitted over path 2.

It should be noted that in the design mode 1, the bitmap indicator of the control PDU of the first set of PDUs supporting indicating the paths for a plurality of sets of PDUs is taken as an example. In some embodiments, the bitmap indicator of the control PDU of the second set of PDUs also adopts the design mode 1. That is, the bitmap indicator of the control PDU of the second set of PDUs also supports indicating the paths for a plurality of sets of PDUs.

It should be further noted that in the design mode 1, the bitmap indicator of the control PDU of the first set of PDUs supporting indicating the paths for a plurality of sets of PDUs is taken as an example. In some embodiments, the bitmap indicator of the control PDU of the first set of PDUs also supports indicating at least one of the paths for a plurality of PDUs in the first set of PDUs or the paths for a plurality of PDUs in the second set of PDUs. Correspondingly, in the case that the bitmap indicator of the control PDU of the second set of PDUs also adopts the design mode 1, the bitmap indicator of the control PDU of the second set of PDUs supports indicating at least one of the paths for a plurality of PDUs in the first set of PDUs or the paths for a plurality of PDUs in the second set of PDUs.

In a design mode 2, referring to part (B) of FIG. 17, the bitmap indicator includes 16 bits, wherein “10” indicates transmission over path 1 and “01” indicates transmission over path 2, or “10” indicates transmission over path 1, “01” indicates transmission over path 2, and “11” indicates transmission over path 3, and then the bitmap indicator of the control PDU of a plurality of sets of PDUs, or the bitmap iindicator of at least one first set of PDUs and at least one second set of PDUs, or the bitmap indicator of a group of the first sets of PDUs (or a group of the second sets of PDUs), or the bitmap indicator of the control PDU of the first set of PDUs (or the control PDU of the second set of PDUs) has two rows, wherein the first row is 1000 0000 and the second row is 0111 1111. Then, as indicated by the bitmap indicator, the first set of PDUs is transmitted over path 1 (the first row being 1, and the second row being 0), and the second set of PDUs to the eighth set of PDUs are transmitted over path 2 (the first row being 0, and the second row being 1).

It should be noted that in the design mode 2, the bitmap indicator of the control PDU of the first set of PDUs supporting indicating the paths for a plurality of sets of PDUs is taken as an example. In some embodiments, the bitmap indicator of the control PDU of the second set of PDUs also adopts the design mode 2. That is, the bitmap indicator of the control PDU of the second set of PDUs also supports indicating the paths for a plurality of sets of PDUs.

It should be further noted that in the design mode 2, the bitmap indicator of the control PDU of the first set of PDUs supporting indicating the paths for a plurality of sets of PDUs is taken as an example. In some embodiments, the bitmap indicator of the control PDU of the first set of PDUs also supports indicating at least one of the paths for a plurality of PDUs in the first set of PDUs or the paths for a plurality of PDUs in the second set of PDUs. Correspondingly, in the case that the bitmap indicator of the control PDU of the second set of PDUs also adopts the design mode 2, the bitmap indicator of the control PDU of the second set of PDUs supports indicating at least one of the paths for a plurality of PDUs in the first set of PDUs or the paths for a plurality of PDUs in the second set of PDUs.

In a design mode 3, the bitmap indicator includes 8N bits for indicating that at least one set of PDUs is transmitted over N paths. With transmission over three paths as an example, referring to part (C) of FIG. 17, “111” indicates transmission over path 1, “110” indicates transmission over path 2, and “100” indicates transmission over path 3, and then the bitmap indicator of the control PDU of a plurality of sets of PDUs, or the bitmap indicator of at least one first set of PDUs and at least one second set of PDUs, or the bitmap indicator of a group of the first sets of PDUs (or a group of the second sets of PDUs), or the bitmap indicator of the control PDU of the first set of PDUs (or the control PDU of the second set of PDUs) has three rows, wherein the first row is 1111 1111, the second row is 1111 0000, and the third row is 1000 0000. Then, as indicated by the bitmap indicator, the first set of PDUs is transmitted over path 1 (the first row is 1, the second row is 1, and the third row is 1), the second set of PDUs to the fourth set of PDUs are transmitted over path 2 (the first row being 1, the second row being 1, and the third row being 0), and the fifth set of PDUs to the eighth set of PDUs are transmitted over path 3 (the first row being 1, the second row being 0, and the third row being 0). Similarly, in the case that N paths are present, it is only necessary to design N rows to enable the bitmap indicator to indicate that at least one set of PDUs is transmitted over the N paths. It can be understood that the N rows may not be arranged in order, and the path can be determined by the quantity of “1.” For example, “111” contains three “Is”, and then transmission is performed over path 1; “110” has two “Is”, and then transmission is performed over path 2; and “100” has a single “1”, and then transmission is performed over path 3.

It should be noted that in the design mode 3, the bitmap indicator of the control PDU of the first set of PDUs supporting indicating the paths for a plurality of sets of PDUs is taken as an example. In some embodiments, the bitmap indicator of the control PDU of the second set of PDUs also adopts the design mode 3. That is, the bitmap indicator of the control PDU of the second set of PDUs also supports indicating the paths for a plurality of sets of PDUs.

It should be further noted that in the design mode 3, the bitmap indicator of the control PDU of the first set of PDUs supporting indicating the paths for a plurality of sets of PDUs is taken as an example. In some embodiments, the bitmap indicator of the control PDU of the first set of PDUs also supports indicating at least one of the paths for a plurality of PDUs in the first set of PDUs or the paths for a plurality of PDUs in the second set of PDUs. Correspondingly, in the case that the bitmap indicator of the control PDU of the second set of PDUs also adopts the design mode 3, the bitmap indicator of the control PDU of the second set of PDUs supports indicating at least one of the paths for a plurality of PDUs in the first set of PDUs or the paths for a plurality of PDUs in the second set of PDUs.

It should be noted that the above three design modes are basic design modes, and a new design mode may be acquired by combining or distinguishing or splitting the three design modes, and the acquired new design mode shall fall within protection scope of the present disclosure.

In some embodiments, in the above implicit representation, it is default that the order of the bits of the bitmap indicator is from the first set of PDUs to the eighth set of PDUs. In addition, the bitmap indicator may indicate the corresponding relationship between any set of PDUs and the path by explicit representation.

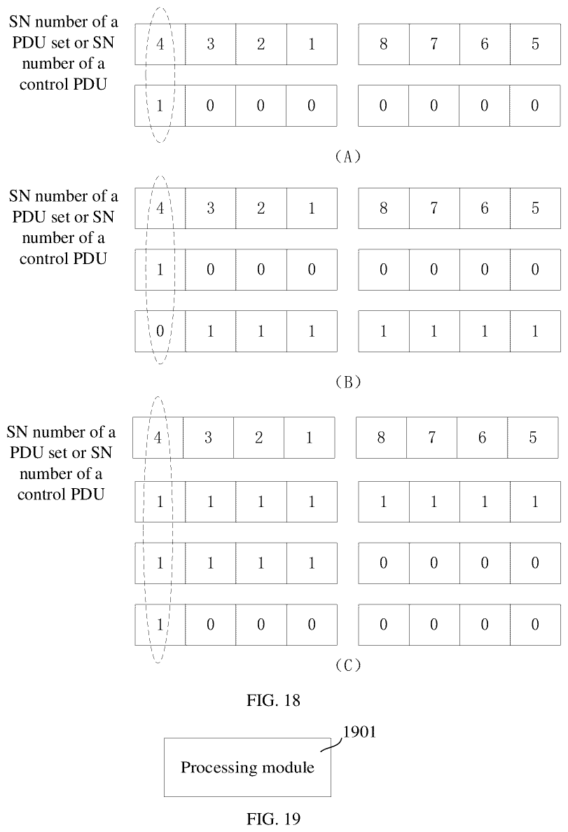

In some embodiments, based on the above three possible design modes, a row indicating the SN number of the set of PDUs or the SN number of the control PDU is further added to the bitmap indicator. Referring to FIG. 18, part (A) of FIG. 18 is different from part (A) of FIG. 17 in that a new row is added, part (B) of FIG. 18 is different from part (B) of FIG. 17 in that a new row is added, and part (C) of FIG. 18 is different from part (C) of FIG. 17 in that a new row is added. Part (A) of FIG. 18 illustrates that the fourth set of PDUs is transmitted over path 1 and other sets of PDUs are transmitted over path 2. Part (B) of FIG. 18 illustrates that the fourth set of PDUs is transmitted over path 1 and other sets of PDUs are transmitted over path 2. Part (C) of FIG. 18 illustrates that the fourth set of PDUs is transmitted over path 1, the third set of PDUs to the first set of PDUs are transmitted over path 2, and the eighth set of PDUs to the fifth set of PDUs are transmitted over path 3.

In some embodiments, based on the above three possible design modes, identification information indicating the SN number of the set of PDUs or the SN number of the control PDU is further added for indicating at least one of an identifier of the corresponding control PDU or an identifier of the set of PDUs, or an identifier of the control PDU and/or a start identifier and a quantity of the set of PDUs, or an identifier of the control PDU and/or an end identifier and a quantity of the set of PDUs.

In some other embodiments, the bitmap indicator indicates the corresponding relationship between one set of PDUs and the path by explicit representation. For example, the SN number of the set of PDUs or the SN number of the control PDU is indicated, and the path corresponding to the set of PDUs is indicated. The path indicator may be a path identifier, or a bitmap indicator of the path (for example, the mode as described in one of the above design mode 1, 2 or 3).

In some embodiments, in the case that the control PDU is lost, the corresponding PDU is considered to be lost or deleted.

It should be noted that the above seven possible embodiments for reordering may be combined with and/or distinguished from each other, and therefore, other possible reordering methods may be generated, which shall fall within the protection scope of the present disclosure.

In summary, data processing is performed based on the first set of PDUs and the second set of PDUs corresponding to the first QoS flow, such that the requirements of the first set of PDUs and the second set of PDUs are considered, and the efficiency of data processing is improved.

For example, the first set of PDUs and the second set of PDUs are mapped with the first QoS flow, and the first set of PDUs representing the I-frame transmitted over path 1 and the second set of PDUs representing the P-frame transmitted over path 2 (the compression decoding of the P-frame depending on the I-frame) are reordered, such that the efficiency of data processing is improved, and different transmission requirements of the set of PDUs representing the I-frame and the set of PDUs representing the P-frame are satisfied.

Hereinafter, a process of data processing by a core network element, an access network element, and a terminal in the transmission scenario is described.

With respect to the case that data processing is performed based on the first set of PDUs and the second set of PDUs corresponding to the first QoS flow:

### In Downlink Transmission:

The core network element maps the first set of PDUs and the second set of PDUs to the first QoS flow. In some embodiments, the core network element further indicates parameter information at the set of PDUs level.

In some embodiments, the core network element further indicates to perform processing based on the parameter information at the set of PDUs level, and/or the core network element indicates to perform data processing based on the first set of PDUs and the second set of PDUs corresponding to the first QoS flow.

In some embodiments, the core network element is one of an AMF, a PCF, an SMF, or a UPF.

Referring to parts (A) and (B) of FIG. 5, the core network element maps the first set of PDUs and the second set of PDUs to the first QoS flow, which may be that the core network element respectively maps the first set of PDUs and the second set of PDUs to the first QoS flow, or that the core network element maps a target set of PDUs to the first QoS flow, wherein the target set of PDUs includes the first set of PDUs and the second set of PDUs.

Further, in some embodiments, the first set of PDUs and the second set of PDUs belong to different sub-QoS flows.

In some embodiments, the parameter information at the set of PDUs level includes at least one of: a packet loss rate of the first set of PDUs, a packet loss rate of the second set of PDUs, an importance of the first set of PDUs, an importance of the second set of PDUs, a dependency of the first set of PDUs, a dependency of the second set of PDUs, a packet error rate of the first set of PDUs, a packet error rate of the second set of PDUs, a reliability requirement of the first set of PDUs, a reliability requirement of the second set of PDUs, a delay budget of the first set of PDUs, or a delay budget of the second set of PDUs.

In some embodiments, the core network element is the SMF. In some embodiments, the core network element maps the first set of PDUs and the second set of PDUs to the first QoS flow based on information of the PCF.

In some embodiments, the core network element is the UPF. In some embodiments, the core network element maps the first set of PDUs and the second set of PDUs to the first QoS flow based on information of the PCF/SMF.

The access network element performs the processing based on set of PDUs information based on the parameter information at the set of PDUs level indicated by at least one of the core network element, a QoS rule or indication information of the core network element, and/or performs data processing on the first set of PDUs and the second set of PDUs corresponding to the first QoS flow based on the parameter information at the set of PDUs level indicated by at least one of the core network element, the QoS rule or the indication information of the core network element. In some embodiments, reference is made to the method embodiments illustrated in FIG. 6 for details of data processing by the access network element.

The terminal performs the processing based on the set of PDUs information based on the parameter information at the set of PDUs level indicated by the core network element or the access network element and/or the QoS rule and/or the indication information of the access network element or the core network element, and/or performs data processing on the first set of PDUs and the second set of PDUs corresponding to the first QoS flow based on the parameter information at the set of PDUs level indicated by the core network element or the access network element and/or the QoS rule and/or the indication information of the access network element or the core network element.

### In Uplink Transmission:

The core network element indicates a QoS rule to at least one of a base station or the terminal. In some embodiments, the core network element further indicates parameter information at the set of PDUs level.

The QOS rule indicates mapping relationships between the first and second sets of PDUs and the first QoS flow, or indicates QoS parameters, or indicates QoS profiles.

In some embodiments, the core network element further indicates to perform processing based on the parameter information at the set of PDUs level, and/or the core network element indicates to perform data processing based on the first set of PDUs and the second set of PDUs corresponding to the first QoS flow.

In some embodiments, the core network element is one of an AMF, a PCF, an SMF, or a UPF.

In some embodiments, the core network element indicates the QoS rule to at least one of the terminal or the access network element upon establishing a PDU session; and/or the core network element indicates the QoS rule to at least one of the terminal or the access network element upon modifying the PDU session.

In some embodiments, the parameter information at the set of PDUs level includes at least one of: a packet loss rate of the first set of PDUs, a packet loss rate of the second set of PDUs, an importance of the first set of PDUs, an importance of the second set of PDUs, a dependency of the first set of PDUs, a dependency of the second set of PDUs, a packet error rate of the first set of PDUs, a packet error rate of the second set of PDUs, a reliability requirement of the first set of PDUs, a reliability requirement of the second set of PDUs, a delay budget of the first set of PDUs, or a delay budget of the second set of PDUs.

In some embodiments, the core network element is the SMF. In some embodiments, the core network element determines the QoS rule based on information of the PCF.

In some embodiments, the core network element is the UPF. In some embodiments, the core network element determines the QoS rule based on information of the PCF/SMF.

Referring to parts (A) and (B) of FIG. 5, the mapping relationships between the first and second sets of PDUs and the first QoS flow indicated by the QoS rule may be understood as the mapping relationships between the first set of PDUs and the first QoS flow and between the second set of PDUs and the first QoS flow, or understood as a mapping relationship between a target set of PDUs and the first QoS flow, wherein the target set of PDUs includes the first set of PDUs and the second set of PDUs.

The access network element determines QoS parameters of the first QoS flow based on the indication of the core network element. In some embodiments, the access network element further performs processing for the set of PDUs level based on the parameter information at the set of PDUs level. In some embodiments, the access network element further performs different data processing operations on the first set of PDUs and the second set of PDUs corresponding to the first QoS flow based on the indication information indicated by the core network element for data processing based on the first set of PDUs and the second set of PDUs corresponding to the first QoS flow.

In some embodiments, reference is made to the method embodiments illustrated in FIG. 6 for details of data processing by the access network element.

The terminal performs the processing based on the set of PDUs information based on the parameter information at the set of PDUs level indicated by the core network element or the access network element and/or the QoS rule and/or the indication information of the access network element or the core network element, and/or performs data processing on the first set of PDUs and the second set of PDUs corresponding to the first QoS flow based on the parameter information at the set of PDUs level indicated by the core network element or the access network element and/or the QoS rule and/or the indication information of the access network element or the core network element.

With respect to the case that data processing is performed based on the first set of PDUs corresponding to the first QoS flow and the second set of PDUs corresponding to a second QoS flow:

### In Downlink Transmission:

The core network element maps the first set of PDUs to the first QoS flow and maps the second set of PDUs to the second QoS flow.

In some embodiments, the core network element further indicates parameter information at the set of PDUs level.

In some embodiments, the core network element further indicates to perform processing based on the parameter information at the set of PDUs level, and/or the core network element indicates to perform data processing based on the first set of PDUs and the second set of PDUs corresponding to the first QoS flow.

In some embodiments, the core network element is one of an AMF, a PCF, an SMF, or a UPF.

In some embodiments, the core network element is the SMF. In some embodiments, the core network element maps the first set of PDUs to the first QoS flow and maps the second set of PDUs to the second QoS flow based on information of the PCF.

In some embodiments, the core network element is the UPF. In some embodiments, the core network element maps the first set of PDUs to the first QoS flow and maps the second set of PDUs to the second QoS flow based on information of the PCF/SMF.

The access network element determines QoS parameters of the first QoS flow and QoS parameters of the second QoS flow based on the indication of the core network element, and performs different data processing operations based on the QoS parameters of the first QoS flow and the QoS parameters of the second QoS flow.

In some embodiments, in the case that the access network element further indicates to perform the processing based on the parameter information at the set of PDUs level, the access network element determines the QoS parameters of the first QoS flow and the QoS parameters of the second QoS flow based on the indication of the core network element, and performs different data processing operations based on the QoS parameters of the first QoS flow and the QoS parameters of the second QoS flow. In some embodiments, reference is made to the method embodiments illustrated in FIG. 6 for details of data processing by the access network element.

### In Uplink Transmission:

The core network element indicates a QoS rule to at least one of the terminal or the access network element.

The QoS rule indicates a mapping relationship between the first set of PDUs and the first Qos flow and a mapping relationship between the second set of PDUs and the second QoS flow, or indicates QoS parameters, or indicates QoS profiles.

In some embodiments, the core network element further indicates to perform processing based on the parameter information at the set of PDUs level, and/or the core network element indicates to perform data processing based on the first set of PDUs corresponding to the first QoS flow and the second set of PDUs corresponding to the second QoS flow.

In some embodiments, the core network element is one of an AMF, a PCF, an SMF, or a UPF.

In some embodiments, the core network element indicates the QoS rule to at least one of the terminal or the access network element upon establishing a PDU session; and/or the core network element indicates the QoS rule to at least one of the terminal or the access network element upon modifying the PDU session.

The access network element determines QoS parameters of the first QoS flow and QoS parameters of the second QoS flow based on the indication of the core network element, and performs different data processing operations based on the QoS parameters of the first QoS flow and the QoS parameters of the second QoS flow.

In some embodiments, in the case that the access network element further indicates to perform the processing based on the parameter information at the set of PDUs level, the access network element determines the QoS parameters of the first QoS flow and the QoS parameters of the second QoS flow based on the indication of the core network element, and performs different data processing operations based on the QoS parameters of the first QoS flow and the QoS parameters of the second QoS flow.

In some embodiments, reference is made to the method embodiments illustrated in FIG. 6 for details of data processing by the access network element.

The terminal maps the first set of PDUs to the first QoS flow and maps the second set of PDUs to the second QoS flow based on the QoS rule indicated by the core network element, and/or performs the processing on the parameter information at the set of PDUs level. In some embodiments, the terminal further performs different data processing operations by mapping or filtering the first set of PDUs and the second set of PDUs based on their respective QoS flows, and at least one of a filter or a QoS flow ID (QFI).

In some embodiments, reference is made to the method embodiments illustrated in FIG. 6 for details of data processing by the terminal.

In summary, data processing is performed based on different first set of PDUs and second set of PDUs corresponding to different QoS flows, or data processing is performed based on the first set of PDUs and the second set of PDUs corresponding to the first QoS flow, such that the first set of PDUs and the second set of PDUs are subjected to targeted processing, and the efficiency of data processing is improved.

A discussion will be expanded hereinafter of how to use or configure or activate a first function. The first function refers to a function for performing data processing based on the first set of PDUs and the second set of PDUs corresponding to the first QoS flow.

In some embodiments, the first function is used or configured or activated by combining with at least one of the following situations.

1. The first function is used or configured or activated in the case that the first QoS flow is configured with different paths.

2. The first function is used or configured or activated in the case that the first QoS flow is mapped to different paths.

3. The first function is used or configured or activated in the case that the first set of PDUs and the second set of PDUs are mapped to different paths.

4. The first function is used or configured or activated in the case that the first set of PDUs and the second set of PDUs are configured with different paths.

5. The first function is used or configured or activated in the case that a target SDAP PDU or a target packet header of an SDAP PDU is configured or activated or used.

In some embodiments, the target packet header includes at least one of an SN of a set of PDUs, an association indicator of the set of PDUs, a dependency indicator of the set of PDUs, a type indicator of the set of PDUs, an importance indicator of the set of PDUs, a priority indicator of the set of PDUs, an SN of a data packet of the set of PDUs, an association indicator of the data packet of the set of PDUs, a type indicator of the data packet of the set of PDUs, a dependency indicator of the data packet of the set of PDUs; an importance indicator of the data packet of the set of PDUs, or a priority indicator of the data packet of the set of PDUs. The data packet of the set of PDUs includes all or part of PDUs in the set of PDUs. Alternatively, a plurality of data packets carry data of the set of PDUs or the PDUs in the set of PDUs.

In some embodiments, the SN of the data packet of the set of PDUs is carried in a packet header of the data packet of the corresponding set of PDUs.

In some embodiments, the SN of the set of PDUs is carried in a packet header of the set of PDUs; or the SN of the set of PDUs is carried in a packet header of the data packet corresponding to all or part of the PDUs in the set of PDUs.

In some embodiments, SNs of the PDUs in the set of PDUs are carried in the packet header of the data packet corresponding to all or part of the PDUs in the set of PDUs.

In some embodiments, the data packet is an AS PDU. In some embodiments, the data packet is an SDAP PDU. In some embodiments, the packet header of a target data packet is the target packet header.

6. The first function is used or configured or activated in the case that a target control PDU is configured or activated or used.

In some embodiments, the target control PDU includes at least one of an SN of the control PDU, an identifier or SN of a set of PDUs corresponding to the control PDU, a start identifier or SN of the set of PDUs corresponding to the control PDU, an end identifier or SN of the set of PDUs corresponding to the control PDU, the number of sets of PDUs corresponding to the control PDU, a start marker of the corresponding set of PDUs, an end marker of the corresponding set of PDUs, an association indicator of the corresponding set of PDUs, a dependency indicator of the corresponding set of PDUs, a type indicator of the corresponding set of PDUs, an importance indicator of the corresponding set of PDUs, an association level of the corresponding set of PDUs, an importance level of the corresponding set of PDUs, or a bitmap indicator of the corresponding set of PDUs.

In some embodiments, the target control PDU is at least one of a first control PDU, a second control PDU, or a third control PDU. In some embodiments, the first control PDU is a control PDU corresponding to the first set of PDUs, the second control PDU is a control PDU corresponding to the second set of PDUs, and the third control PDU is a control PDU corresponding to the set of PDUs that corresponds to the first control PDU and the set of PDUs that corresponds to the second control PDU.

In some embodiments, the control PDU of the first set of PDUs includes at least one of a PDU located between the first set of PDUs and the second set of PDUs, between the second set of PDUs and the second set of PDUs, between the first set of PDUs and the first set of PDUs, or located at the start or end position between a plurality of sets of PDUs within the first set of PDUs; a control PDU located between the plurality of sets of PDUs within the first set of PDUs; a control PDU located before one or at least one first set of PDUs; a control PDU located after one or at least one first set of PDUs; a control PDU for distinguishing or spacing different sets of PDUs; a control PDU for identifying the start of the first set of PDUs; or a control PDU for identifying the end of the first set of PDUs.

In some embodiments, the control PDU of the second set of PDUs includes at least one of a control PDU located between the first set of PDUs and the second set of PDUs, between the second set of PDUs and the second set of PDUs, between the first set of PDUs and the first set of PDUs, or between a plurality of second sets of PDUs; a control PDU located before one or at least one second set of PDUs; a control PDU located after one or at least one second set of PDUs; a control PDU for distinguishing or spacing different sets of PDUs; a control PDU for identifying the start of at least one second set of PDUs; or a control PDU for identifying the end of at least one second set of PDUs.

In some embodiments, the third control PDU corresponds to at least one first set of PDUs and at least one second set of PDUs.

In some embodiments, the third control PDU includes at least one of a control PDU located before the set of PDUs corresponding to the third control PDU, located after the set of PDUs corresponding to the third control PDU, of a set of PDUs corresponding to each control PDU for spacing or distinguishing sets of PDUs corresponding to a plurality of third control PDUs, or located between at least one first set of PDUs and at least one second set of PDUs; a control PDU located between the first set of PDUs and the second set of PDUs; a control PDU located before at least one first set of PDUs and at least one second set of PDUs; a control PDU located after at least one first set of PDUs and at least one second set of PDUs; a control PDU for identifying the starts of at least one first set of PDUs and at least one second set of PDUs; a control PDU for identifying the ends of at least one first set of PDUs and at least one second set of PDUs; a control PDU located before at least one first set of PDUs, a control PDU located after at least one first set of PDUs; a control PDU for identifying the start of at least one second set of PDUs; or a control PDU for identifying the end of at least one second set of PDUs.

7. The first function is used or configured or activated in the case that the terminal supports a first capability or supports a first format or reports a first indication.

In some embodiments, the first indication includes at least one of an indicator of a capability of the terminal for supporting the target SDAP, the terminal supporting the target SDAP PDU, the terminal supporting the configuration of the target SDAP PDU, the terminal supporting the target control PDU, the terminal supporting the configuration of the target control PDU, the terminal supporting the first function, the terminal being a terminal that supports an extended reality (XR) service, or the terminal being a terminal of a target protocol version.

In some embodiments, the first capability or the first format includes a capability of at least one of the terminal for supporting the target SDAP or the terminal supporting the target SDAP PDU.

In some embodiments, the target SDAP includes at least one of: an SDAP supporting the first function, an SDAP supporting the target SDAP PDU, an SDAP supporting the configuration of the target SDAP PDU, an SDAP supporting the target control PDU, or an SDAP supporting the configuration of the target control PDU.

In some embodiments, supporting the target SDAP PDU is understood as supporting a format of the target SDAP PDU.

8. The first function is used or configured or activated in the case that a first identifier is present in at least one of different paths configured by a network device.

In some embodiments, the first identifier includes at least one of: the type of a set of PDUs, a reliability identifier, an importance identifier, a reliability level, an importance level, a priority, a decoding dependency, an identifier of a set of PDUs, the type of a frame, the type of a coded slice, a decoding reliability, or a delay requirement.

9. The first function is used or configured or activated in the case that at least one path is activated.

10. The first function is used or configured or activated in the case that at least one non-default path is activated.

11. The first function is used or configured or activated in the case that more than one default path is activated.

12. The first function is used or configured or activated in the case that different first identifiers are configured for different paths.

13. The first function is used or configured or activated in the case that a first identifier is configured for at least one path.

14. The first function is used or configured or activated in the case that an identifier is configured for the first QoS flow or a PDU session or an SDAP.

In summary, various situations of using or configuring or activating the first function are provided, thereby ensuring data processing based on the first set of PDUs and the second set of PDUs corresponding to the first QoS flow.

In the related art, one or more QoS flows may be mapped to one path. A data packet of one PDU session may correspond to a plurality of paths. One PDU session corresponds to one default path. In the case that a mapping relationship of the QoS flow to the path is not stored, the SDAP SDU will be mapped to the default path.

The scheme in which the first QoS flow can be mapped to a plurality of paths is provided above. As such, a discussion will be expanded hereinafter of how to map the first set of PDUs and the second set of PDUs corresponding to the first QoS flow to a path in the case that the mapping relationship between the QoS flow and the path is not stored or present.

The access network element configures at least one default path, or the access network element configures at least one default path for one PDU session. The terminal is configured with at least one default path, or the terminal is configured with at least one default path for one PDU session.

In a first embodiment, the access network element configures a first default path and a second default path, or the access network element configures a first default path and a second default path for one PDU session; and the terminal is configured with the first default path and the second default path, or the terminal is configured with the first default path and the second default path for one PDU session.

In the case that the mapping relationship between the QoS flow and the path is not stored, the first set of PDUs is mapped to the first default path based on information of the first set of PDUs and a first identifier of the first default path; and the second set of PDUs is mapped to the second default path based on information of the second set of PDUs and a first identifier of the second default path.

In some embodiments, the first identifier includes at least one of: a type of a set of PDUs, a reliability identifier, an importance identifier, a reliability level, an importance level, a priority, a dependency, a decoding dependency, an identifier of a set of PDUs, a type of a frame, a type of a coded slice, a decoding reliability, or a delay requirement.

In some embodiments, the information of the first set of PDUs includes at least one of: importance, reliability, delay, dependency, priority, decoding reliability, or type of the first set of PDUs; and the information of the second set of PDUs includes at least one of: importance, reliability, delay, dependency, priority, decoding reliability, or type of the second set of PDUs.

In the case that the mapping relationship between the QoS flow and the path is not stored, the first set of PDUs is mapped to the first default path and the second set of PDUs is mapped to the second default path based on at least one of: the information of the first set of PDUs, the first identifier of the first default path, the information of the second set of PDUs, or the first identifier of the second default path.

In the case that the mapping relationship between the QoS flow and the path is not stored and the first function is configured or activated, the first set of PDUs is mapped to the first default path based on the information of the first set of PDUs and the first identifier of the first default path; and the second set of PDUs is mapped to the second default path based on the information of the second set of PDUs and the first identifier of the second default path.

In some embodiments, the first function refers to a function for performing data processing based on the first set of PDUs and the second set of PDUs corresponding to the first QoS flow.

In the case that the mapping relationship between the QoS flow and the path is not stored and the first function is configured or activated, the first set of PDUs is mapped to the first default path and the second set of PDUs is mapped to the second default path based on at least one of: the information of the first set of PDUs, the first identifier of the first default path, the information of the second set of PDUs, or the first identifier of the second default path.

In the case that the mapping relationship between the QoS flow and the path is present, the first set of PDUs and the second set of PDUs are mapped to different paths based on at least one of: mapping relationships between the first QoS flow and the different paths or first identifiers of the different paths.

In the case that the mapping relationship between the QoS flow and the path is present and the first function is configured or activated, the first set of PDUs and the second set of PDUs are mapped to different paths based on at least one of: the mapping relationships between the first QoS flow and the different paths or the first identifiers of the different paths.

In a second embodiment, the access network element configures a third default path and a first additional path, or the access network element configures a third default path and a first additional path for one PDU session; and the terminal is configured with the third default path and the first additional path, or the terminal is configured with the third default path and the first additional path for one PDU session.

In the case that the mapping relationship between the QoS flow and the path is not stored, the first set of PDUs is mapped to the third default path based on information of the first set of PDUs and a first identifier of the third default path; and the second set of PDUs is mapped to the first additional path based on information of the second set of PDUs and a first identifier of the first additional path.

In the case that the mapping relationship between the QoS flow and the path is not stored, the first set of PDUs is mapped to the third default path and the second set of PDUs is mapped to the first additional path based on the information of the first set of PDUs, the information of the second set of PDUs, and the first identifier of the third default path.

In the case that the mapping relationship between the QoS flow and the path is not stored, the first set of PDUs is mapped to the third default path and the second set of PDUs is mapped to the first additional path based on the information of the first set of PDUs, the information of the second set of PDUs, and the first identifier of the first additional path.

In the case that the mapping relationship between the QoS flow and the path is not stored, the first set of PDUs is mapped to the third default path and the second set of PDUs is mapped to the first additional path based on at least one of: the information of the first set of PDUs, the information of the second set of PDUs, the first identifier of the first additional path, or the first identifier of the third default path.

In the case that the mapping relationship between the QoS flow and the path is not stored and the first function is configured or activated, the first set of PDUs is mapped to the third default path based on the information of the first set of PDUs and the first identifier of the third default path; and the second set of PDUs is mapped to the first additional path based on the information of the second set of PDUs and the first identifier of the first additional path.

In the case that the mapping relationship between the QoS flow and the path is not stored and the first function is configured or activated, the first set of PDUs is mapped to the third default path and the second set of PDUs is mapped to the first additional path based on the information of the first set of PDUs, the information of the second set of PDUs, and the first identifier of the third default path.

In the case that the mapping relationship between the QoS flow and the path is not stored and the first function is configured or activated, the first set of PDUs is mapped to the third default path and the second set of PDUs is mapped to the first additional path based on the information of the first set of PDUs, the information of the second set of PDUs, and the first identifier of the first additional path.

In the case that the mapping relationship between the QoS flow and the path is not stored and the first function is configured or activated, the first set of PDUs is mapped to the third default path and the second set of PDUs is mapped to the first additional path based on at least one of: the information of the first set of PDUs, the information of the second set of PDUs, the first identifier of the first additional path, or the first identifier of the third default path.

In the case that the mapping relationship between the QoS flow and the path is not stored and the first function is not configured or activated, the first set of PDUs and the second set of PDUs are mapped to the third default path.

In the case that the mapping relationship between the QoS flow and the path is not stored, the first set of PDUs and the second set of PDUs are mapped to the third default path.

In a third embodiment, the access network element configures a fourth default path, or the access network element configures a fourth default path for one PDU session; and the terminal is configured with the fourth default path, or the terminal is configured with the fourth default path for one PDU session.

In the case that the mapping relationship between the QoS flow and the path is not stored, the SDAP SDU or SDAP PDU is mapped to the fourth default path, the fourth default path corresponding to one PDU session.

Alternatively, in the case that the mapping relationship between the QoS flow and the path is not stored and the first function is not configured or activated, the SDAP SDU or SDAP PDU is mapped to the fourth default path, the fourth default path corresponding to one PDU session.

In the case that the mapping relationship between the QoS flow and the path is present, the first set of PDUs and the second set of PDUs are mapped to different paths based on at least one of mapping relationships between the first QoS flow and the different paths or first identifiers of the different paths.

In the case that the mapping relationship between the QoS flow and the path is present and the first function is not configured or activated, the first set of PDUs and the second set of PDUs are mapped to the first additional path.

In the case that the mapping relationship between the QoS flow and the path is present and the first function is configured or activated, the first set of PDUs and the second set of PDUs are mapped to different paths based on at least one of the mapping relationships between the first QoS flow and the different paths or the first identifiers of the different paths.

In the case that the mapping relationship between the QoS flow and the path is present and the first function is not configured or activated, the SDAP SDU or SDAP PDU is mapped to the corresponding path.

In the case that the mapping relationship between the QoS flow and the path is present, the SDAP SDU or SDAP PDU is mapped to the corresponding path.

In the case that the mapping relationship between the QoS flow and the path is present and the first function is not configured or activated, the first set of PDUs and the second set of PDUs are mapped to the corresponding path based on the mapping relationship between the first QoS flow and the path.

In summary, the QoS flow and the default path are ensured to be mapped to each other in the case that the mapping relationship between the QoS flow and the path is not stored.

A discussion will be expanded hereinafter of how to transmit an end-marker control PDU in the case that the SDAP entity needs to transmit the end-marker control PDU to the lower layer.

The end-marker control PDU is generated in the case that the mapping relationships between the first QoS flow and the different paths change; and/or the end-marker control PDU is mapped and delivered to a changed path.

In a first embodiment: a target path is determined based on the mapping relationships between the first QoS flow and different paths after the change and/or the mapping relationships between the first QoS flow and different paths before the change and/or the first identifiers of different paths and/or the first identifiers of the paths, the target path being the changed path; and the end-marker control PDU is mapped and delivered to the corresponding target path.

In some embodiments, the target path includes one path, or the target path includes a plurality of paths.

In some embodiments, the target path includes a path before the change, and/or the target path includes a path after the change.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 1, and the second set of PDUs after the change is mapped to path 3, the target path is determined to be path 2. The end-marker control PDU is mapped and delivered to the target path.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 1, and the second set of PDUs after the change is mapped to path 3, the target path is determined to be path 2 and path 3. The end-marker control PDU is mapped and delivered to the target path (for example, upon completion of the transmission of the data packet of path 2, the end-marker control PDU is added to path 2 and path 3).

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 3, and the second set of PDUs after the change is mapped to path 4, the target path is determined to be path 1 and path 2. The end-marker control PDU is mapped and delivered to the target path.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 3, and the second set of PDUs after the change is mapped to path 4, the target path is determined to be path 3 and path 4. The end-marker control PDU is mapped and delivered to the target path (for example, upon completion of the transmission of the data packets of path 1 and path 2, the end-marker control PDU is added to path 1, path 2, path 3, and path 4).

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 1, and the second set of PDUs after the change is mapped to path 3, the target path is determined to be at least one of path 2 and path 3. The end-marker control PDU is mapped and delivered to the target path.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 3, and the second set of PDUs after the change is mapped to path 4, the target path is determined to include at least one of path 1 and path 3, and at least one of path 2 and path 4. The end-marker control PDU is mapped and delivered to the corresponding target path.

In some embodiments, the access network element indicates to the terminal that the mapping relationships between the first QoS flow and different paths change over an RRC configuration or a DL data packet or the packet header of the lower layer of the SDAP.

In some embodiments, the terminal determines that the mapping relationships between the first QoS flow and different paths change by receiving an RRC configuration or a DL data packet or the packet header of the lower layer of the SDAP from the access network element.

In a second embodiment: a target path is determined based on the mapping relationships between the first QoS flow and different paths after the change and/or the mapping relationships between the first QoS flow and different paths before the change and/or the first identifiers of different paths and/or the first identifiers of the paths in the case that the end-marker control PDU is a target end-marker control PDU, the target path being the changed path; and the end-marker control PDU is mapped and delivered to the corresponding target path based on the first identifier of the target path and/or the information of the set of PDUs corresponding to the end-marker control PDU.

In some embodiments, the target end-marker control PDU includes at least one of: the SN of the control PDU; the type of the control PDU; the end marker of the corresponding set of PDUs; the association indicator of the corresponding set of PDUs; the type indicator of the corresponding set of PDUs; the importance indicator of the corresponding set of PDUs; the dependency indicator of the corresponding set of PDUs; the priority indicator of the corresponding set of PDUs; the association level of the corresponding set of PDUs; the importance level of the corresponding set of PDUs; or the bitmap indicator of the corresponding set of PDUs.

In some embodiments, the first identifier includes at least one of: the type of a set of PDUs, a reliability identifier, an importance identifier, a dependency identifier, a reliability level, an importance level, a priority, a decoding dependency, a decoding reliability, a delay requirement, an identifier of a set of PDUs, the type of a frame, or the type of a coded slice; and the information of the set of PDUs includes importance, reliability, delay, dependency, priority, decoding reliability, and type of the set of PDUs.

In some embodiments, the target path includes one path, or the target path includes a plurality of paths.

In some embodiments, the target path includes a path before the change, and/or the target path includes a path after the change.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 1, and the second set of PDUs after the change is mapped to path 3, the target path is determined to be path 2. The end-marker control PDU is mapped and delivered to path 2, or the end-marker control PDU carrying the information of path 2 and/or path 3 is mapped and delivered to path 2.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 1, and the second set of PDUs after the change is mapped to path 3, the target path is determined to be path 2 and path 3. The end-marker control PDU is mapped and delivered to path 2 and path 3, or the end-marker control PDU carrying the information of path 2 and/or path 3 is mapped and delivered to path 2 and path 3 (for example, upon completion of the transmission of the data packet of path 2, the end-marker control PDU is added to path 2 and path 3).

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 3, and the second set of PDUs after the change is mapped to path 4, the target path is determined to be path 1 and path 2. The end-marker control PDU is mapped and delivered to path 1 and path 2; or the end-marker control PDU carrying the information of path 1 and/or path 3 is mapped and delivered to path 1, and the end-marker control PDU carrying the information of path 2 and/or path 4 is mapped and delivered to path 2.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 3, and the second set of PDUs after the change is mapped to path 4, the target path is determined to be path 3 and path 4. The end-marker control PDU is mapped and delivered to path 3 and path 4. Alternatively, the end-marker control PDU is mapped and delivered to path 1 and path 3; or the end-marker control PDU carrying the information of path 1 and/or path 3 is mapped and delivered to path 3, and the end-marker control PDU carrying the information of path 2 and/or path 4 is mapped and delivered to path 4 (for example, upon completion of the transmission of the data packets of path 1 and path 2, the end-marker control PDU is added).

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 1, and the second set of PDUs after the change is mapped to path 3, the target path is determined to be at least one of path 2 and path 3. The end-marker control PDU is mapped and delivered to path 2 based on the information of the second set of PDUs corresponding to the end-marker control PDU and/or the first identifier of path 2.

In some embodiments, the first set of PDUs corresponding to the first QoS flow before the change is mapped to path 1, the second set of PDUs corresponding to the first QoS flow before the change is mapped to path 2, the first set of PDUs after the change is mapped to path 3, and the second set of PDUs after the change is mapped to path 4, the target path is determined to include at least one of path 1 and path 3, and at least one of path 2 and path 4. The end-marker control PDU is mapped and delivered to path 2 based on the information of the second set of PDUs corresponding to the end-marker control PDU and/or the first identifier of path 2.

In some embodiments, the access network element indicates to the terminal that the mapping relationships between the first QoS flow and different paths change over an RRC configuration or a DL data packet or the packet header of the lower layer of the SDAP.

In some embodiments, the terminal determines that the mapping relationships between the first QoS flow and different paths change by receiving an RRC configuration or a DL data packet or the packet header of the lower layer of the SDAP from the access network element.

In summary, the embodiments for transmitting the end-marker control PDU in the case that the SDAP entity needs to transmit the end-marker control PDU to the lower layer are provided.

Hereinafter, the method for processing data according to the present disclosure will be described by several embodiments.

Embodiment 0 (Different processing operations are performed on different data. For example, different data is mapped to one or more QoS flows):

In scheme 1: different data is mapped to different QoS flows.

### For DL:

1. The core network maps different data to different QoS flows. In some embodiments:
a) The core network is the SMF.
b) The core network maps different data to different QoS flows based on information of the PCF.
c) The different data is data of different sets of PDUs, or data (sets of PDUs) of different importance, or data (sets of PDUs) of different relevance.

2. The base station performs different processing on different data. In some embodiments:
a) The base station performs different processing on different data based on different Qos requirements according to parameters of the QoS flows of the core network (generated by the SMF and informed to the base station over the AMF).

### For UL:

1. The core network determines QoS rules, such as mapping different data to different QoS flows (filter, QFI, or the like). In some embodiments:
a) The core network is the SMF.
b) The core network maps different data with different QoS flows based on information of the PCF.
c) The different data is data of different sets of PDUs, or data (sets of PDUs) of different importance, or data (sets of PDUs) of different relevance.
d) The core network indicates the QoS rules, such as mapping different data to different Qos flows (filter, QFI, or the like) to the UE. In some embodiments, the core network indicates the QoS rules, such as mapping different data to different QoS flows (filter, QFI, or the like) to the UE in the case that the PDU session is established or modified.

2. The base station performs different processing for different QoS flows. In some embodiments:
a) The base station determines QoS parameters of the QoS flows based on the indication of the core network.
b) Different processing is performed based on the different QoS parameters.
c) The indication of the core network is generated by the SMF and acquired over the AMF.

3. The UE performs different processing on different data. In some embodiments:
a) The UE determines relationships between different data and the QFI/QoS flow/path based on the filter and/or QFI according to the QoS rules (generated by the SMF and informed to the base station over the AMF) of the core network, and performs different processing on different data based on different QoS flow configurations.

In scheme 2: different data is mapped to one QoS flow.

Background: it is assumed that data of an association relationship, or data of different importance is carried in one QoS flow or radio bearer. In an existing radio data transmission and processing, the data of one QoS flow or radio bearer generally uses the same QoS requirement/logical channel or transmission rules, rather than using different QoS/logical channel processing methods due to the different data. Therefore, for different data, different processing adopted based on parameters or configurations of the different data (sets of PDUs) can better embody the difference, or improve the performance and user experience of the multimedia service.

### For DL:

1. The core network maps different data to the same QoS flow. In some embodiments:
a) The core network is the SMF.
b) The core network maps different data to the same QoS flow based on information of the PCF.
c) The different data is data of different sets of PDUs, or data (sets of PDUs) of different importance, or data (sets of PDUs) of different relevance.
d) The core network also indicates parameter information at the set of PDUs level, such as a packet loss rate, importance, dependency, or a packet error rate.

2. The base station performs different processing on different data. In some embodiments:
a) The base station acquires data of one QoS flow.
b) The base station performs different processing on different data based on different relevance/importance/packet loss rate/dependency requirements according to the parameter information at the set of PDUs level of the core network (generated by the SMF and informed to the base station over the AMF).

### For UL:

1. The core network determines QoS rules, such as mapping different data to the same QoS flow (filter, QFI, or the like). In some embodiments:
a) The core network is the SMF.
b) The core network maps different data with the same QoS flow based on information of the PCF.
c) The different data is data of different sets of PDUs, or data (sets of PDUs) of different importance, or data (sets of PDUs) of different relevance.
d) The core network indicates the QoS rules to the UE. In some embodiments, the core network indicates the QoS rules to the UE in the case that the PDU session is established or modified.
e) The core network also indicates parameter information at the set of PDUs level, such as a packet loss rate, importance, dependency, or a packet error rate.

2. The base station performs different processing for different data. In some embodiments:
a) The base station determines QOS parameters of the QoS flow based on the indication of the core network.
b) The indication of the core network is generated by the SMF and acquired over the AMF.
c) The core network also indicates parameter information at the set of PDUs level, such as a packet loss rate, importance, dependency, or a packet error rate.
d) The base station performs different processing based on the parameter information at the set of PDUs level.

3. The UE performs different processing on different data. In some embodiments:
a) The UE maps different data to one QFI/QOS flow/path based on the filter and/or QFI according to the QoS rules of the core network (generated by the SMF and informed to the base station over the AMF).
b) The UE performs different processing on different data based on the parameter information at the set of PDUs level indicated by the core network or configuration information at the set of PDUs level configured by the base station.

Embodiment 1 (Different processing is performed on different data corresponding to one Qos flow. In some embodiments, for different data, the transmitter performs at least one of: routing different data to different paths, identifying different data, or generating data packets with identification information (such as SN numbers, or association information). In some embodiments, for different data, the receiver performs at least one of: receiving data from different lower-layer paths, performing reordering based on the SN numbers, or performing a packet deletion operation based on the association information. In some embodiments, the transmitter and/or the receiver are located at the SDAP layer).

The applicable scenarios include at least one of the following.

The embodiment is applicable to the case where different sets of PDUs (e.g., the I-frame, the P-frame, and the B-frame) are mapped to one QoS flow. The different sets of PDUs may be data (sets of PDUs) of different importance, or data (sets of PDUs) of different relevance, or data (sets of PDUs) of different dependency.

The specific implementation is as follows (applicable to both UL and DL).

### 1. For the Transmitter:

The transmitter may be configured at either the UE or the network side.

The peer entities for the transceiving processing are UE-gNB.

The new function or the new protocol includes at least one of:
identifying different data (e.g., identifying each or different sets of PDUs, or identifying associated PDUs, or identifying the association or dependency relationship between sets of PDUs, or identifying importance of different sets of PDUs), routing different data to different paths (the paths and the corresponding relationships thereof may be configured to the transmitter (UE) by the base station, e.g., over RRC signaling), or generating data packets with identification information (such as SN numbers, or association information, wherein the SN numbers ensure that the receiver can deliver the data packets to the higher layer in order based on the SN numbers, or ensure that the receiver can deliver the data packets to the higher layer in order after reordering based on the SN numbers; and the association information is used by the receiver for performing unified processing on the associated packets, such as delivering the associated packets to the higher layer together or deleting the associated packets).

A new function is added to the existing AS layer.

The existing AS layer may be an SDAP.

### 2. For the Receiver:

The receiver may be configured at either the UE or the network side.

The peer entities for the transceiving processing are UE-gNB.

The new function or the new protocol includes at least one of:
reordering (such as based on the SN numbers, with a purpose to ensure that the sets of PDUs are delivered to the higher layer in order), removing a PDU packet header (including acquiring identifier related information), receiving a buffer (for buffering data in the sets of PDUs and processing the data together, or buffering the associated sets of PDUs and processing the sets of PDUs together), packet deletion (performing a packet deletion operation based on the association information, for example, deleting the remaining data in the same set of PDUs or the associated set of PDUs in the case that part of data is lost), or feedback (for the transmitter to perform packet deletion or retransmission).

A new function is added to the existing AS layer.

The existing AS layer may be an SDAP.

One embodiment is as follows.

For the transmitter (for TX):

In process 0: the RRC configures mapping relationships between one QoS flow and a plurality of paths, wherein the one QoS flow corresponds to a plurality of DRBs or PDCPs.

Different DRBs or PDCPs are correspondingly configured with different indicators (e.g., I/P-frames), or different DRBs or PDCPs are correspondingly configured with different identifiers (e.g., reliable or low-reliability, or important or unimportant, or the like, or different importance levels, or different reliability levels).

In process 1: the SDAP identifies different data.

For example, for identifying different sets of PDUs, the SDAP acquires the type of the set of PDUs over higher layer information. The different data is identified by a data packet header of the higher layer, or which piece of data goes to which path is identified by an indicator in the DL SDAP packet header.

In process 2: the SDAP SDU of one QoS flow received from the higher layer transmits the SDAP entity: (at least one of the following actions).

For each packet, a PDU with a new SDAP packet header is generated. At least the SN of the corresponding set of PDUs and/or the association indicator are included in the PDU. Further, a frame type or importance indicator may also be carried in the PDU.

In some embodiments, the value of the SN is ranging from 0 to 2\hat{ }8-1. The value of the SN starts from 0.

Routing is performed. For example, the PDU is transmitted to the corresponding/correct lower-layer path based on the mapping relationship configured by the RRC.

### For the Receiver (for RX):

In process 0: in the case that the RX is the base station, the base station configures mapping relationships between one QoS flow and a plurality of paths, wherein the one QoS flow corresponds to a plurality of DRBs or PDCPs. The base station indicates information to the UE over the RRC.

In some embodiments, different DRBs or PDCPs are correspondingly configured with different indicators (e.g., I/P-frames), or different DRBs or PDCPs are correspondingly configured with different identifiers (e.g., reliable or low-reliability, or important or unimportant, or the like, or different importance levels, or different reliability levels).

In process 1-a: the SDAP PDU of one QoS flow received from the lower layer receives the SDAP entity (at least one of the following actions).

The SDAP SDU is acquired from a DL SDAP data PDU using a new packet header.

Reordering is performed using SN information.

The acquired SDAP SDU is delivered to the higher layer.

In process 2-b: the SDAP PDU of one QoS flow received from the lower layer receives the SDAP entity.

In the case that the associated set of PDUs is lost, the remaining sets of PDUs are deleted. For example, in the case that the SDAP receives an indication of the PDCP, or the delay of the set of PDUs is greater than the PDB of the set of PDUs, the set of PDUs is deleted.

The beneficial effects are as follows. For the data transmitter and/or the data receiver, different processing for different data is performed using the identification information of the packet header and/or the network configuration. Therefore, different requirements of different data are ensured. In Embodiment 1, different processing is performed by the transmitter and/or the receiver based on the packet header information in the SDAP data PDU.

Embodiment 2 (Different processing is performed on different data corresponding to one Qos flow. In some embodiments, for different data, the transmitter performs at least one of: routing different data to different paths, identifying different data, or generating SDAP control PDUs with identifiers. In some embodiments, for different data, the receiver performs at least one of: receiving data from different lower-layer paths, performing reordering based on the SDAP control PDUs with the identifiers, or performing a packet deletion operation based on the SDAP control PDUs with the identifiers. In some embodiments, the transmitter and/or the receiver are located at the SDAP layer).

The applicable scenarios include at least one of the following.

The embodiment is applicable to the case where different sets of PDUs (e.g., the I-frame, the P-frame, and the B-frame) are mapped to one QoS flow. The different sets of PDUs may be data (sets of PDUs) of different importance, or data (sets of PDUs) of different relevance, or data (sets of PDUs) of different dependency.

The specific implementation is as follows (applicable to both UL and DL).

### 1. For the Transmitter:

The transmitter may be configured at either the UE or the network side.

The peer entities for the transceiving processing are UE-gNB.

The new function or the new protocol includes at least one of:
identifying different data (e.g., identifying each or different sets of PDUs, or identifying associated PDUs, or identifying the association or dependency relationship between sets of PDUs, or identifying importance of different sets of PDUs), routing different data to different paths (the paths and the corresponding relationships thereof may be configured to the transmitter (UE) by the base station, e.g., over RRC signaling), or generating SDAP control PDUs with identifiers (e.g., at least one of set of PDUs start markers, set of PDUs end markers, SN numbers of the SDAP control PDUs, or association information, wherein the SN numbers ensure that the receiver can deliver the data packets to the higher layer in order based on the SN numbers, or ensure that the receiver can deliver the data packets to the higher layer in order after reordering based on the SN numbers; the markers are used by the receiver for determining whether the received data packet is a set of PDUs; and the association information is used by the receiver for performing unified processing on the associated packets, such as delivering the associated packets to the higher layer together or deleting the associated packets).

A new function is added to the existing AS layer.

The existing AS layer may be an SDAP.

### 2. For the Receiver:

The receiver may be configured at either the UE or the network side.

The peer entities for the transceiving processing are UE-Gnb (terminal-base station).

The new function or the new protocol includes at least one of:
reordering (such as reordering based on the SN numbers of the SDAP control PDUs, with a purpose to ensure that the sets of PDUs are delivered to the higher layer in order), removing a PDU packet header (including acquiring identifier related information), receiving a buffer (for buffering packets in the sets of PDUs and processing the packets together, or buffering the associated sets of PDUs and processing the sets of PDUs together), packet deletion (performing a packet deletion operation based on the association information, for example, deleting the remaining packets in the same set of PDUs or the associated set of PDUs in the case that part of the packets are lost), feedback (for the transmitter to perform packet deletion or retransmission), or determining whether a lower-layer packet is a set of PDUs or whether all the packets of the set of PDUs are received (based on the markers in the SDAP control PDU).

A new function is added to the existing AS layer.

The existing AS layer may be an SDAP.

One embodiment is as follows.

For the transmitter (for TX):

In process 0: the RRC configures mapping relationships between one QoS flow and a plurality of paths, wherein the one QoS flow corresponds to a plurality of DRBs or PDCPs.

In some embodiments, different DRBs or PDCPs are correspondingly configured with different indicators (e.g., I/P-frames), or different DRBs or PDCPs are correspondingly configured with different identifiers (e.g., reliable or low-reliability, or important or unimportant, or the like, or different importance levels, or different reliability levels).

In process 1: the SDAP identifies different data.

For example, for identifying different sets of PDUs, the SDAP acquires the type of the set of PDUs over higher layer information. The different data is identified by a data packet header of the higher layer, or which piece of data goes to which path is identified by an indicator in the DL SDAP packet header.

In process 2: the SDAP SDU of one QoS flow received from the higher layer transmits the SDAP entity: (at least one of the following actions).

For each packet, a PDU with a new SDAP packet header is generated. At least the SN of the corresponding set of PDUs and/or the association indicator are included in the PDU. Further, a frame type or importance indicator may also be carried in the PDU.

In some embodiments, the value of the SN is ranging from 0 to 2\hat{ }8-1. The SN starts from 0.

For each set of PDUs, one SDAP control PDU is generated, which is located before/after all data packets of each set of PDUs or the boundary of each set of PDUs.

The SDAP control PDU at least includes the SN of the control PDU.

The SDAP control PDU may further include at least one of: a set of PDUs start marker, a set of PDUs end marker, an association indicator, a frame type, an importance indicator, an association level, or an importance level.

The SDAP control PDU may further include a bitmap indicator. The bitmap indicator is used for the transmission path for the set of PDUs, e.g., the leg id or leg index (e.g., 0/1) of transmission.

Routing is performed. For example, the PDU is mapped to the corresponding/correct lower-layer path based on the mapping relationship configured by the RRC.

### For the Receiver (for RX):

In process 0: in the case that the RX is the base station, the base station configures mapping relationships between one QoS flow and a plurality of paths, wherein the one QoS flow corresponds to a plurality of DRBs or PDCPs. The base station indicates information to the UE over the RRC.

In some embodiments, different DRBs or PDCPs are correspondingly configured with different indicators (e.g., I/P-frames), or different DRBs or PDCPs are correspondingly configured with different identifiers (e.g., reliable or low-reliability, or important or unimportant, or the like, or different importance levels, or different reliability levels).

In process 1-a: the SDAP PDU of one QoS flow received from the lower layer receives the SDAP entity (at least one of the following actions).

The SDAP SDU is acquired from a DL SDAP data PDU using an existing packet header.

The SDAP control PDU is received.

It is determined whether a lower-layer packet is a set of PDUs or whether all the packets of the set of PDUs are received, or different sets of PDUs of one lower-layer path are distinguished based on the information of the SDAP control PDU or the position of the SDAP control PDU.

Reordering of SDAP SDUs or SDAP PDUs of different lower-layer paths is performed based on the information of the SDAP control PDU, such as the SN.

The acquired SDAP SDU is delivered to the higher layer.

In process 2-b: the SDAP PDU of one QoS flow received from the lower layer receives the SDAP entity.

In the case that the associated set of PDUs is lost or an important set of PDUs is lost, the remaining sets of PDUs are deleted. For example, in the case that the SDAP receives an indication of the PDCP, or the delay of the set of PDUs is greater than the PDB of the set of PDUs, the set of PDUs is deleted.

Embodiment 3 (a use or configuration or activation method of different processing of different PDU data of one QoS flow is provided).

The applicable scenarios include at least one of the following.

The embodiment is applicable to the case where different sets of PDUs (e.g., the I-frame, the P-frame, and the B-frame) are mapped to one QoS flow. The different sets of PDUs may be data (sets of PDUs) of different importance, or data (sets of PDUs) of different relevance, or data (sets of PDUs) of different dependency.

The specific implementation is as follows (applicable to both UL and DL).

The entity of the transmitter and/or the receiver uses or configures or activates different processing of different PDU data of one QoS flow in at least one of the following cases. Alternatively, the SDAP data PDU of Embodiment 1 coexists with the old data PDU, or the SDAP control PDU of Embodiment 2 is used.

In case 1: in the case that one QoS flow/SDAP entity is configured with a plurality of DRBs/PDCPs, the configuration may be configuration for each Qos flow or configuration for each DRB or configuration for each PDU session or configuration for each UE.

In case 2: the RRC configures whether to use a new SDAP data PDU or a new packet header of the SDAP data PDU (the method of Embodiment 1). The configuration may be configuration for each Qos flow or configuration for each DRB or configuration for each PDU session or configuration for each UE.

In case 3: the RRC configures whether to use a new SDAP control PDU (the method of Embodiment 2). The configuration may be configuration for each Qos flow or configuration for each DRB or configuration for each PDU session or configuration for each UE.

In case 4: the UE reports an indicator of a capability for supporting the enhanced SDAP, or the UE indicates that it is a UE supporting the extended reality (XR) service or a UE of version R18. Both the network and the UE use the new SDAP data format by default, otherwise the original SDAP format is used. The application scope may be the Qos flow corresponding to the XR service or all Qos flows of the UE.

In case 5: the UE reports an indicator of a capability for supporting the enhanced SDAP, or the UE indicates that it is a UE supporting the XR service or a UE of version R18, and the network configures one QoS flow corresponding to a plurality of PDCPs or DRBs.

In case 6: the UE reports an indicator of a capability for supporting the enhanced SDAP, or the UE indicates that it is a UE supporting the XR service or a UE of version R18, and the PDCP or the DRB configured by the network includes a special tag (e.g., important or unimportant, XR, or a set of PDUs distinguishing identifier).

In case 7: the PDCP or the DRB configured by the network includes a special tag (e.g., important or unimportant, XR, or a DPU set distinguishing identifier).

In case 8: based on at least one of cases 1-7, more than one PDCP/DRB is activated or a non-default PDCP/DRB is activated.

The beneficial effects are as follows. A use case is provided for different processing for different data, which may be used in combination with at least one of Embodiments 0/1/2.

Embodiment 4 (for one QoS flow corresponding to a plurality of PDCPs/DRBs, a use or definition method for the default DRB is provided).

The applicable scenarios include at least one of the following.

The embodiment is applicable to the case where different sets of PDUs (e.g., the I-frame, the P-frame, and the B-frame) are mapped to one QoS flow. The different sets of PDUs may be data (sets of PDUs) of different importance, or data (sets of PDUs) of different relevance, or data (sets of PDUs) of different dependency.

Background: in the existing process, one or more QoS flows may be mapped to one DRB. A packet of one PDU session may correspond to a plurality of DRBs. One PDU session may correspond to a 1st default DRB.

Meanwhile, in the case that the mapping relationship of the QoS flow to the DRB is not stored, the SDAP SDU is mapped to the default DRB; otherwise, the SDAP SDU is mapped to the DRB corresponding to the stored mapping relationship of the QoS flow to the DRB.

In this embodiment, one QoS flow of one PDU session may be mapped to a plurality of DRBs. Therefore, a problem of how to set the default DRB needs to be considered.

The specific implementation is as follows (applicable to both UL and DL).

In mode 1: two default DRBs are configured, one corresponding to X and the other one corresponding to Y.

### For Example:

i. The base station configures two SDAP configurations (both configurations of the default DRBs) for one PDU session, wherein one is the default DRB corresponding to X, and the other one is the default DRB corresponding to Y. In some embodiments, X is an I-frame or data of high importance, and Y is a P-frame or data of low importance.

ii. The UE receives a configuration of the base station.

iii. In the case that the mapping relationship of the QoS flow to the DRB is not stored, the transmitter maps the SDAP SDU to different default DRBs based on the information (such as importance and frame type) of the set of PDUs. Otherwise, the transmitter maps the SDAP SDU to the corresponding DRB based on the stored mapping relationship of the QoS flow to the DRB and a mark corresponding to the DRB (importance, frame type, or the like).

In mode 2: two dedicated DRBs are configured, one as a default DRB, and the other one as an additional DRB.

### For Example:

i. The base station configures two SDAP configurations (both configurations of the dedicated DRBs) for one PDU session, one as the default DRB, and the other one as the additional DRB. In some embodiments, the data corresponding to the default DRB is an I-frame or data of high importance, and the data corresponding to the additional DRB is a P-frame or data of low importance, or vice versa.

ii. The UE receives a configuration of the base station.

iii. In the case that the mapping relationship of the QoS flow to the DRB is not stored, in the case that one QoS flow to a plurality of DRBs is configured or activated, the transmitter maps the SDAP SDU to two dedicated DRBs based on the information (such as importance and frame type) of the set of PDUs. Otherwise, the transmitter maps the SDAP SDU to the default DRB.

iv. Otherwise, the transmitter stores the mapping relationship of the QoS flow to the DRB. In the case that one QoS flow to a plurality of DRBs is configured or activated, the transmitter maps the SDAP SDU to the corresponding DRB based on the stored mapping relationship of the QoS flow to the DRB and a mark corresponding to the DRB (importance, frame type, or the like). Otherwise, the transmitter maps the SDAP SDU to the corresponding additional DRB based on the stored mapping relationship of the QoS flow to the DRB.

In mode 3: one default DRB is configured.

### For Example:

i. The base station configures one SDAP configuration (a configuration of the default DRB) for one PDU session.

ii. The UE receives a configuration of the base station.

iii. In the case that the mapping relationship of the QoS flow to the DRB is not stored, the transmitter maps the SDAP SDU to the default DRB.

iv. Otherwise, in the case that the transmitter stores the mapping relationship of the QoS flow to the DRB (indicated by a RRC configuration or a downlink packet header): in the case that one QoS flow to a plurality of DRBs is configured or activated, the transmitter maps the SDAP SDU to the corresponding DRB based on the stored mapping relationship of the QoS flow to the DRB and a mark corresponding to the DRB (importance, frame type, or the like). Otherwise, the transmitter maps the SDAP SDU to the corresponding DRB based on the stored mapping relationship of the QoS flow to the DRB.

Therefore, in the case that one QoS flow configuration corresponds to a plurality of DRBs/PDCPs, or for at least one of the above three modes, in the case that the SDAP entity needs to transmit an end-marker control PDU, one of the following processing modes may be present for transmitting the end-marker control PDU.

In case 1: using the indication by a RRC configuration or a downlink packet header (DL header), the network indicates that the mapping relationship of the QoS flow to the DRB changes, wherein the mappings of one QoS flow to a plurality of DRBs all change.

In solution 1: an end-marker PDU is used. It is determined that of which QoS flow the DRB mapping changes based on the mapping of the QoS flow to the DRB. Based on this, the end-marker PDU is mapped and delivered to each corresponding old DRB.

In solution 2: an enhanced end-marker PDU is used. It is determined that of which QoS flow the DRB mapping changes based on the mapping of the QoS flow to the DRB. It is determined which type of control packet is transmitted to which type of DRB based on the identifier of the DRB itself. The end-marker PDU including X information is mapped to an old DRB corresponding to the X information, and the end-marker PDU including Y information is mapped to an old DRB corresponding to the Y information (X is an I-frame or has high importance, and Y is a P-frame or has low importance).

In case 2: using the indication by a RRC configuration or a downlink packet header (DL header), the network indicates that the mapping relationship of the QoS flow to the DRB changes, wherein only one of the mappings of one QoS flow to a plurality of DRBs changes.

In solution 1: the existing end-marker PDU is used. It is determined which type of DRB of which QoS flow changes based on the mapping of the QoS flow to the DRB and the identifier of the DRB itself. Based on this, the end-marker PDU is mapped and delivered to the old DRB corresponding to the changed DRB.

In solution 2: an enhanced end-marker PDU is used. It is determined which type of DRB of which QoS flow changes based on the mapping of the QoS flow to the DRB and the identifier of the DRB itself. Based on this, the end-marker PDU including X information is mapped to the DRB corresponding to the X information, or the end-marker PDU including Y information is mapped to the DRB corresponding to the Y information. X is an I-frame or has high importance, and Y is a P-frame or has low importance.

It should be noted that, for example, the changed DRB mark or frame type corresponding to the mapping of the QoS flow to the DRB is indicated by the downlink packet header.

The beneficial effects are as follows. A method for using a default DRB is provided in the case that one QoS flow is mapped to a plurality of DRBs.

Embodiment 4 may be used in combination with at least one of Embodiments 0/1/2/3.

FIG. 19 is a structural block diagram of an apparatus for processing data according to some embodiments of the present disclosure. The apparatus includes: a processing module 1901.

The processing module 1901 is configured to perform data processing based on different pieces of first data corresponding to at least one QoS flow.

In some embodiments, the processing module 1901 is further configured to perform the data processing based on different pieces of first data corresponding to the same QoS flow.

In some embodiments, the processing module 1901 is further configured to perform the data processing based on different pieces of first data corresponding to different QoS flows.

In some embodiments, the processing module 1901 is further configured to perform the data processing based on a first set of PDUs and a second set of PDUs corresponding to a first QoS flow.

In some embodiments, the processing module 1901 is further configured to perform different data processing operations based on the first set of PDUs and the second set of PDUs corresponding to the first QoS flow.

In some embodiments, the processing module 1901 is further configured to perform the different data processing operations based on types of the first set of PDUs and the second set of PDUs; perform the different data processing operations based on attributes or attribute levels or indicators of the first set of PDUs and the second set of PDUs, the attribute or attribute level or indicator including at least one of: association, dependency, importance, priority, decoding reliability, or reliability; or perform the different data processing operations based on a first relationship between the first set of PDUs and the second set of PDUs, the first relationship including at least one of: an association relationship, a dependency relationship, an importance relationship, a priority relationship, a decoding reliability relationship, or a reliability relationship.

In some embodiments, the processing module 1901 is further configured to:
configure different first identifiers for different paths;
configure the first identifier for at least one path;
configure an identifier for the first QoS flow, a PDU session, or an SDAP;
configure or be configured with mapping relationships between the first QoS flow and different paths;
configure or be configured with mapping relationships between at least one of the first set of PDUs or the second set of PDUs and different paths;
identify the first set of PDUs and the second set of PDUs;
add or remove packet headers of different data packets of the first set of PDUs and the second set of PDUs;
add or remove a control PDU for a set of PDUs;
add or remove different control PDUs of the first set of PDUs and the second set of PDUs;
add or remove a control PDU corresponding to the first set of PDUs and the second set of PDUs;
route the first set of PDUs and the second set of PDUs to different paths;
reorder the first set of PDUs and the second set of PDUs;
reorder the different data packets of the first set of PDUs and the second set of PDUs;
delete or feed back deletion of at least one of the first set of PDUs and the second set of PDUs;
retransmit or feed back retransmission of at least one of the first set of PDUs and the second set of PDUs;
add or remove SNs of the first set of PDUs and the second set of PDUs;
add or remove association indicators of the first set of PDUs and the second set of PDUs;
add or remove type indicators of the first set of PDUs and the second set of PDUs;
add or remove importance indicators of the first set of PDUs and the second set of PDUs;
add or remove dependency indicators of the first set of PDUs and the second set of PDUs;
add or remove reliability indicators of the first set of PDUs and the second set of PDUs;
add or remove priority indicators of the first set of PDUs and the second set of PDUs;
receive a data packet or a GTP-U data packet corresponding to the first QoS flow from a higher layer of an AS;
receive a data packet or an SDAP SDU corresponding to the first QoS flow from a higher layer of the SDAP;
receive a data packet or an SDAP PDU corresponding to the first QoS flow from a lower layer of the SDAP;
receive a data packet corresponding to the first QoS flow from a lower layer; or deliver the first set of PDUs and the second set of PDUs in order.

In some embodiments, the packet headers of the different data packets of the first set of PDUs and the second set of PDUs include at least one of:
at least one of an SN of a PDU of the first set of PDUs or an SN of a PDU of the second set of PDUs;
at least one of an SN of the first set of PDUs or an SN of the second set of PDUs;
at least one of an association indicator of the first set of PDUs or an association indicator of the second set of PDUs;
at least one of a dependency indicator of the first set of PDUs or a dependency indicator of the second set of PDUs;
at least one of a type indicator of the first set of PDUs or a type indicator of the second set of PDUs;
at least one of an importance indicator of the first set of PDUs or an importance indicator of the second set of PDUs;
at least one of a priority indicator of the first set of PDUs or a priority indicator of the second set of PDUs;
at least one of an SN of a data packet of the first set of PDUs or an SN of a data packet of the second set of PDUs;
at least one of an association indicator of the data packet of the first set of PDUs or an association indicator of the data packet of the second set of PDUs;
at least one of a type indicator of the data packet of the first set of PDUs or a type indicator of the data packet of the second set of PDUs;
at least one of a dependency indicator of the data packet of the first set of PDUs or a dependency indicator of the data packet of the second set of PDUs;
at least one of an importance indicator of the data packet of the first set of PDUs or an importance indicator of the data packet of the second set of PDUs; or
at least one of a priority indicator of the data packet of the first set of PDUs or a priority indicator of the data packet of the second set of PDUs.

The data packet of the first set of PDUs includes all or part of PDUs in the first set of PDUs; and the data packet of the second set of PDUs includes all or part of PDUs in the second set of PDUs. In some embodiments, the SN of the first set of PDUs is carried in a packet header of the first set of PDUs, and the SN of the second set of PDUs is carried in a packet header of the second set of PDUs.

In some embodiments, the SN of the first set of PDUs is carried in a packet header of an SDAP PDU corresponding to all or part of the PDUs in the first set of PDUs, and the SN of the second set of PDUs is carried in a packet header of an SDAP PDU corresponding to all or part of the PDUs in the second set of PDUs.

In some embodiments, the SN of the data packet of the first set of PDUs is carried in a packet header of a data packet corresponding to the first set of PDUs, and/or the SN of the data packet of the second set of PDUs is carried in a packet header of a data packet corresponding to the second set of PDUs.

In some embodiments, the SN of a PDU in the first set of PDUs is carried in a packet header of a data packet corresponding to all or part of the PDUs in the first set of PDUs, and/or the SN of a PDU in the second set of PDUs is carried in a packet header of a data packet corresponding to all or part of the PDUs in the second set of PDUs.

In some embodiments, the processing module 1901 is further configured to route the first set of PDUs and the second set of PDUs to different paths based on first information, wherein the first information includes at least one of: the mapping relationships between the first QoS flow and different paths, the mapping relationships between at least one of the first set of PDUs or the second set of PDUs and different paths, different types of the first set of PDUs and the second set of PDUs, different attributes or attribute levels or indicators of the first set of PDUs and the second set of PDUs, the first relationship between the first set of PDUs and the second set of PDUs, the different identifiers of different paths, a first identifier of a path, or the identifier configured for the first QoS flow or the PDU session or the SDAP.

In some embodiments, the processing module 1901 is further configured to reorder the first set of PDUs and the second set of PDUs based on at least one of:
the SNs of the first set of PDUs and the second set of PDUs;
the type indicators of the first set of PDUs and the second set of PDUs;
the association indicators of the first set of PDUs and the second set of PDUs; or
the importance indicators of the first set of PDUs and the second set of PDUs.

In some embodiments, the processing module 1901 is further configured to reorder the first set of PDUs and the second set of PDUs based on information of a first packet header; and/or reorder the first set of PDUs and the second set of PDUs based on information of a second packet header, wherein the first packet header is a packet header corresponding to the first set of PDUs, and the second packet header is a packet header corresponding to the second set of PDUs; or the first packet header is a packet header of at least one data packet corresponding to the first set of PDUs, and the second packet header is a packet header of at least one data packet corresponding to the second set of PDUs.

In some embodiments, a format of at least one of the first packet header or the second packet header is a format of a target packet header, wherein the first packet header is a packet header corresponding to the first set of PDUs, and the second packet header is a packet header corresponding to the second set of PDUs; or the first packet header is a packet header of at least one data packet corresponding to the first set of PDUs, and the second packet header is a packet header of at least one data packet corresponding to the second set of PDUs.

In some embodiments, the different control PDUs of the first set of PDUs and the second set of PDUs include at least one of:
an SN of the control PDU;
a type of the control PDU;
an identifier or SN of a corresponding set of PDUs;
a start marker of the corresponding set of PDUs;
an end marker of the corresponding set of PDUs;
an association indicator of the corresponding set of PDUs;
a type indicator of the corresponding set of PDUs;
an importance indicator of the corresponding set of PDUs;
an association level of the corresponding set of PDUs;
an importance level of the corresponding set of PDUs; or
a bitmap indicator of the corresponding set of PDUs.

In some embodiments, the control PDU corresponding to at least one first set of PDUs and at least one second set of PDUs includes at least one of:
an SN of the control PDU;
a type of the control PDU;
an identifier or SN of a corresponding set of PDUs;
a start marker corresponding to at least one first set of PDUs and at least one second set of PDUs;
an end marker corresponding to at least one first set of PDUs and at least one second set of PDUs;
an association indicator corresponding to at least one first set of PDUs and at least one second set of PDUs;
a type indicator corresponding to at least one first set of PDUs and at least one second set of PDUs;
an importance indicator corresponding to at least one first set of PDUs and at least one second set of PDUs;
a dependency indicator corresponding to at least one first set of PDUs and at least one second set of PDUs;
a priority indicator corresponding to at least one first set of PDUs and at least one second set of PDUs;
an association level corresponding to at least one first set of PDUs and at least one second set of PDUs;
an importance level corresponding to at least one first set of PDUs and at least one second set of PDUs; or
a bitmap indicator corresponding to at least one first set of PDUs and at least one second set of PDUs.

In some embodiments, the bitmap indicator indicates information of at least one set of PDUs.

In some embodiments, the bitmap indicator includes at least one of:
the SN of the control PDU;
the number of corresponding sets of PDUs;
a routing path of the corresponding set of PDUs; or
the identifier of the corresponding set of PDUs.

In some embodiments, the control PDU and the corresponding set of PDUs are transmitted over the same path, or the control PDU and the corresponding set of PDUs are transmitted over different paths.

In some embodiments, a control PDU of the first set of PDUs includes at least one of:
a control PDU located between the first set of PDUs and the second set of PDUs;
a control PDU located between the second set of PDUs and the second set of PDUs;
a control PDU located between the first set of PDUs and the first set of PDUs;
a control PDU located at a start or end position of a plurality of sets of PDUs within the first set of PDUs;
a control PDU located between the plurality of sets of PDUs within the first set of PDUs;
a control PDU located before one or at least one first set of PDUs;
a control PDU located after one or at least one first set of PDUs;
a control PDU for distinguishing or spacing different sets of PDUs;
a control PDU for identifying a start of the first set of PDUs; or a control PDU for identifying an end of the first set of PDUs.

In some embodiments, a control PDU of the second set of PDUs includes at least one of:
a control PDU located between the first set of PDUs and the second set of PDUs;
a control PDU located between the second set of PDUs and the second set of PDUs;
a control PDU located between the first set of PDUs and the first set of PDUs;
a control PDU located at a start or end position of a plurality of sets of PDUs within the second set of PDUs;
a control PDU located between the plurality of sets of PDUs within the second set of PDUs;
a control PDU located before one or at least one second set of PDUs;
a control PDU located after one or at least one second set of PDUs;
a control PDU for distinguishing or spacing different sets of PDUs;
a control PDU for identifying a start of the second set of PDUs; or a control PDU for identifying an end of the second set of PDUs.

In some embodiments, the control PDU corresponding to at least one first set of PDUs and at least one second set of PDUs includes at least one of:
a control PDU located before the corresponding set of PDUs;
a control PDU located after the corresponding set of PDUs;
a control PDU of each corresponding set of PDUs for spacing or distinguishing a plurality of corresponding sets of PDUs;
a control PDU located between at least one first set of PDUs and at least one second set of PDUs;
a control PDU located between the first set of PDUs and the second set of PDUs;
a control PDU located before at least one first set of PDUs and at least one second set of PDUs;
a control PDU located after at least one first set of PDUs and at least one second set of PDUs;
a control PDU for identifying starts of at least one first set of PDUs and at least one second set of PDUs;
a control PDU for identifying ends of at least one first set of PDUs and at least one second set of PDUs;
a control PDU located before at least one first set of PDUs;
a control PDU located after at least one first set of PDUs;
a control PDU for identifying a start of at least one second set of PDUs;
a control PDU for identifying an end of at least one second set of PDUs;
a control PDU for identifying a start of at least one first set of PDUs; or
a control PDU for identifying an end of at least one second set of PDUs.

In some embodiments, the processing module 1901 is further configured to reorder the first set of PDUs and the second set of PDUs based on information of a first control PDU; and/or reorder the first set of PDUs and the second set of PDUs based on information of a second control PDU; and/or reorder at least one of the first set of PDUs or the second set of PDUs based on the information of the first control PDU and the second control PDU; and/or reorder the first set of PDUs and the second set of PDUs based on information of a third control PDU, wherein the first control PDU is a control PDU corresponding to the first set of PDUs, the second control PDU is a control PDU corresponding to the second set of PDUs, and the third control PDU is a control PDU corresponding to the first set of PDUs and the second set of PDUs.

In some embodiments, the processing module 1901 is further configured to reorder the first set of PDUs and the second set of PDUs based on a bitmap indicator of the first control PDU; and/or reorder the first set of PDUs and the second set of PDUs based on a bitmap indicator of the second control PDU; and/or reorder at least one of the first set of PDUs or the second set of PDUs based on the bitmap indicator of the first control PDU and the bitmap indicator of the second control PDU; and/or reorder the first set of PDUs and the second set of PDUs based on a bitmap indicator of the third control PDU, wherein the first control PDU is the control PDU corresponding to the first set of PDUs, the second control PDU is the control PDU corresponding to the second set of PDUs, and the third control PDU is the control PDU corresponding to a set of PDUs of the first control PDU and a set of PDUs of the second control PDU.

In some embodiments, the processing module 1901 is further configured to reorder the first set of PDUs and the second set of PDUs based on an SN of the first control PDU and an SN of the second control PDU; and/or reorder the first set of PDUs and the second set of PDUs based on the SN of the first control PDU, the SN of the second control PDU, and an SN of the third control PDU, wherein the first control PDU is the control PDU corresponding to the first set of PDUs, the second control PDU is the control PDU corresponding to the second set of PDUs, and the third control PDU is the control PDU corresponding to the first set of PDUs and the second set of PDUs.

In some embodiments, identifying the first set of PDUs and the second set of PDUs, includes at least one of:
identifying the types of the first set of PDUs and the second set of PDUs;
identifying the attributes or attribute levels or indicators of the first set of PDUs and the second set of PDUs; or
identifying the first relationship between the first set of PDUs and the second set of PDUs.

In some embodiments, the processing module 1901 is further configured to identify the first set of PDUs and the second set of PDUs over a packet header of the higher layer of the SDAP; and/or identify the first set of PDUs and the second set of PDUs over a packet header of reverse data; and/or identify the first set of PDUs and the second set of PDUs over inter-layer interaction.

In some embodiments, the processing module 1901 is further configured to configure or be configured with different first identifiers for the different paths. The first identifier includes at least one of a type of a set of PDUs, a reliability identifier, an importance identifier, a dependency, a reliability level, an importance level, a priority, a decoding dependency, a decoding reliability, a delay requirement, an identifier of a set of PDUs, a type of a frame, or a type of a coded slice.

In some embodiments, the processing module 1901 is further configured to map the first set of PDUs and the second set of PDUs to the first QoS flow in the case that downlink transmission is performed; the processing module 1901 is further configured to indicate parameter information at a set of PDUs level; and/or the processing module 1901 is further configured to indicate a QoS rule to at least one of a base station or a terminal in the case that uplink transmission is performed, wherein the QoS rule indicates mapping relationships between the first and second sets of PDUs and the first QoS flow.

In some embodiments, the processing module 1901 is further configured to perform the data processing on the first set of PDUs and the second set of PDUs corresponding to the first QoS flow based on parameter information at a set of PDUs level indicated by a core network element in the case that downlink transmission is performed; and/or determine QoS parameters of the first QoS flow based on an indication of the core network element in the case that uplink transmission is performed; and the processing module 1901 is further configured to perform different data processing operations on the first set of PDUs and the second set of PDUs corresponding to the first QoS flow based on the parameter information at the set of PDUs level.

In some embodiments, the processing module 1901 is further configured to determine mapping relationships between the first and second sets of PDUs and the first QoS flow based on a QoS rule indicated by a core network element in the case that uplink transmission is performed; and the processing module 1901 is further configured to perform different data processing operations on the first set of PDUs and the second set of PDUs based on at least one of parameter information at a set of PDUs level indicated by the core network element, parameter information at the set of PDUs level configured by an access network element, scheduling information of the access network element, or configuration information of the access network element.

In some embodiments, the parameter information at the set of PDUs level includes at least one of:
a packet loss rate of the first set of PDUs;
a packet loss rate of the second set of PDUs;
an importance of the first set of PDUs;
an importance of the second set of PDUs;
a dependency of the first set of PDUs;
a dependency of the second set of PDUs;
a packet error rate of the first set of PDUs;
a packet error rate of the second set of PDUs;
a reliability requirement of the first set of PDUs;
a reliability requirement of the second set of PDUs;
a delay budget of the first set of PDUs; or
a delay budget of the second set of PDUs.

In some embodiments, the processing module 1901 is further configured to perform the data processing based on a first set of PDUs corresponding to a first QoS flow and a second set of PDUs corresponding to a second QoS flow.

In some embodiments, the processing module 1901 is further configured to perform different data processing operations based on the first set of PDUs corresponding to the first QoS flow and the second set of PDUs corresponding to the second QoS flow.

In some embodiments, the processing module 1901 is further configured to perform the different data processing operations based on types of the first set of PDUs and the second set of PDUs; perform the different data processing operations based on attributes or attribute levels or indicators of the first set of PDUs and the second set of PDUs, the attribute or attribute level or indicator including at least one of: association, dependency, importance, priority, decoding reliability, or reliability; or perform the different data processing operations based on a first relationship between the first set of PDUs and the second set of PDUs, the first relationship including at least one of: an association relationship, a dependency relationship, an importance relationship, a priority relationship, a decoding reliability relationship, or a reliability relationship.

In some embodiments, the processing module 1901 is further configured to map the first set of PDUs to the first QoS flow and map the second set of PDUs to the second QoS flow in the case that downlink transmission is performed; and/or indicate a QoS rule to at least one of a terminal or an access network element in the case that uplink transmission is performed, wherein the QoS rule indicates a mapping relationship between the first set of PDUs and the first QoS flow and a mapping relationship between the second set of PDUs and the second QoS flow.

In some embodiments, the processing module 1901 is further configured to indicate the QoS rule to at least one of the terminal or the access network element upon establishing a PDU session; and/or the core network element indicates the QoS rule to at least one of the terminal or the access network element upon modifying the PDU session.

In some embodiments, the processing module 1901 is further configured to determine QoS parameters of the first QoS flow and QoS parameters of the second QoS flow based on an indication of a core network element in the case that downlink transmission is performed, and perform different data processing operations based on the QoS parameters of the first QoS flow and the QoS parameters of the second QoS flow; and determine QoS parameters of the first QoS flow and QoS parameters of the second QoS flow based on an indication of the core network element in the case that uplink transmission is performed, and perform different data processing operations based on the QoS parameters of the first QoS flow and the QoS parameters of the second QoS flow.

In some embodiments, the processing module 1901 is further configured to map the first set of PDUs to the first QoS flow and map the second set of PDUs to the second QoS flow by the terminal based on a QoS rule indicated by a core network element in the case that uplink transmission is performed; and the processing module 1901 is further configured to perform different data processing operations by mapping or filtering the first set of PDUs and the second set of PDUs based on respective QoS flows and at least one of a filter or a QFI, wherein the QoS rule indicates a mapping relationship between the first set of PDUs and the first QoS flow and a mapping relationship between the second set of PDUs and the second QoS flow.

In some embodiments, the processing module 1901 is further configured to use or configure or activate a first function in the case that the first QoS flow is configured with different paths.

In some embodiments, the processing module 1901 is further configured to use or configure or activate a first function in the case that the first QoS flow is mapped to different paths; use or configure or activate a first function in the case that the first set of PDUs and the second set of PDUs are mapped to different paths; or use or configure or activate a first function in the case that the first set of PDUs and the second set of PDUs are configured with different paths, wherein the first function refers to a function for performing data processing based on the first set of PDUs and the second set of PDUs corresponding to the first QoS flow.

In some embodiments, the processing module 1901 is further configured to use or configure or activate a first function in the case that a target SDAP PDU or a target packet header of the SDAP PDU is configured or activated or used, wherein the first function refers to a function for performing data processing based on the first set of PDUs and the second set of PDUs corresponding to the first QoS flow.

In some embodiments, the processing module 1901 is further configured to use or configure or activate a first function in the case that a target control PDU is configured or activated or used, wherein the first function refers to a function for performing data processing based on the first set of PDUs and the second set of PDUs corresponding to the first QoS flow.

In some embodiments, the processing module 1901 is further configured to use or configure or activate a first function in the case that the terminal supports a first capability or supports a first format or reports a first indicator, wherein the first function refers to a function for performing data processing based on the first set of PDUs and the second set of PDUs corresponding to the first QoS flow, the first indication includes at least one of an indicator of a capability of the terminal for supporting a target SDAP, the terminal supporting the target SDAP PDU, the terminal supporting a configuration of the target SDAP PDU, the terminal supporting a configuration of the target control PDU, the terminal supporting the first function, the terminal being a terminal that supports an XR service, or the terminal being a terminal of a target protocol version; and the first capability or supporting the first format includes at least one of a capability of the terminal for supporting the target SDAP or the terminal supporting the target SDAP PDU.

In some embodiments, the processing module 1901 is further configured to use or configure or activate a first function in the case that a first identifier is present in at least one of different paths configured by a network device, wherein the first function refers to a function for performing data processing based on the first set of PDUs and the second set of PDUs corresponding to the first QoS flow, and the first identifier includes at least one of a type of a set of PDUs, a reliability identifier, an importance identifier, a reliability level, an importance level, a priority, a decoding dependency, an identifier of a set of PDUs, a type of a frame, a type of a coded slice, a decoding reliability, or a delay requirement.

In some embodiments, the processing module 1901 is further configured to use or configure or activate a first function in the case that at least one path is activated; or use or configure or activate a first function in the case that at least one non-default path is activated; or use or configure or activate a first function in the case that more than one default path is activated, wherein the first function refers to a function for performing data processing based on the first set of PDUs and the second set of PDUs corresponding to the first QoS flow.

In some embodiments, the processing module 1901 is further configured to configure or be configured with at least one default path, or configure or be configured with at least one default path for one PDU session.

In some embodiments, the processing module 1901 is further configured to map the first set of PDUs to the first default path based on the information of the first set of PDUs and the first identifier of the first default path; and map the second set of PDUs to the second default path based on the information of the second set of PDUs and the first identifier of the second default path in the case that the mapping relationship between the QoS flow and the path is not stored.

The processing module 1901 is further configured to map the first set of PDUs to the first default path and map the second set of PDUs to the second default path based on at least one of the information of the first set of PDUs, the first identifier of the first default path, the information of the second set of PDUs, or the first identifier of the second default path in the case that the mapping relationship between the QoS flow and the path is not stored.

The processing module 1901 is further configured to map the first set of PDUs to the first default path based on the information of the first set of PDUs and the first identifier of the first default path; and map the second set of PDUs to the second default path based on the information of the second set of PDUs and the first identifier of the second default path in the case that the mapping relationship between the QoS flow and the path is not stored and the first function is configured or activated.

The processing module 1901 is further configured to map the first set of PDUs to the first default path and map the second set of PDUs to the second default path based on at least one of the information of the first set of PDUs, the first identifier of the first default path, the information of the second set of PDUs, or the first identifier of the second default path in the case that the mapping relationship between the QoS flow and the path is not stored and the first function is configured or activated.

Herein, the information of the first set of PDUs includes at least one of importance, reliability, delay, dependency, priority, decoding reliability, or type of the first set of PDUs; the information of the second set of PDUs includes at least one of importance, reliability, delay, dependency, priority, decoding reliability, or type of the second set of PDUs; the first identifier includes at least one of the type of a set of PDUs, a reliability identifier, an importance identifier, a reliability level, an importance level, a priority, a decoding dependency, an identifier of a set of PDUs, the type of a frame, the type of a coded slice, a decoding reliability, or a delay requirement; and the first function refers to a function for performing data processing based on the first set of PDUs and the second set of PDUs corresponding to the first QoS flow.

In some embodiments, the processing module 1901 is further configured to map the first set of PDUs and the second set of PDUs to different paths based on at least one of the mapping relationships between the first QoS flow and different paths or the first identifiers of different paths in the case that the mapping relationship between the QoS flow and the path is present.

The processing module 1901 is further configured to map the first set of PDUs and the second set of PDUs to different paths based on at least one of: the mapping relationships between the first QoS flow and different paths or the first identifiers of different paths in the case that the mapping relationship between the QoS flow and the path is present and the first function is configured or activated.

Herein, the first identifier includes at least one of the type of a set of PDUs, a reliability identifier, an importance identifier, a reliability level, an importance level, a priority, a decoding dependency, a decoding reliability, a delay requirement, an identifier of a set of PDUs, the type of a frame, or the type of a coded slice; and the first function refers to a function for performing data processing based on the first set of PDUs and the second set of PDUs corresponding to the first QoS flow.

In some embodiments, the processing module 1901 is further configured to configure the first default path and the second default path; or configure the first default path and the second default path for one PDU session.

In some embodiments, the processing module 1901 is further configured with the first default path and the second default path; or configured with the first default path and the second default path for one PDU session.

In some embodiments, the processing module 1901 is further configured to map the first set of PDUs to the third default path based on the information of the first set of PDUs and the first identifier of the third default path; and map the second set of PDUs to the first additional path based on the information of the second set of PDUs and the first identifier of the first additional path in the case that the mapping relationship between the QoS flow and the path is not stored.

The processing module 1901 is further configured to map the first set of PDUs to the third default path and map the second set of PDUs to the first additional path based on the information of the first set of PDUs, the information of the second set of PDUs, and the first identifier of the third default path in the case that the mapping relationship between the QoS flow and the path is not stored.

The processing module 1901 is further configured to map the first set of PDUs to the third default path and map the second set of PDUs to the first additional path based on the information of the first set of PDUs, the information of the second set of PDUs, and the first identifier of the first additional path in the case that the mapping relationship between the QoS flow and the path is not stored.

The processing module 1901 is further configured to map the first set of PDUs to the third default path and map the second set of PDUs to the first additional path based on at least one of the information of the first set of PDUs, the information of the second set of PDUs, the first identifier of the first additional path, or the first identifier of the third default path in the case that the mapping relationship between the QoS flow and the path is not stored.

The processing module 1901 is further configured to map the first set of PDUs to the third default path based on the information of the first set of PDUs and the first identifier of the third default path; and map the second set of PDUs to the first additional path based on the information of the second set of PDUs and the first identifier of the first additional path in the case that the mapping relationship between the QoS flow and the path is not stored and the first function is configured or activated.

The processing module 1901 is further configured to map the first set of PDUs to the third default path and map the second set of PDUs to the first additional path based on the information of the first set of PDUs, the information of the second set of PDUs, and the first identifier of the third default path in the case that the mapping relationship between the QoS flow and the path is not stored and the first function is configured or activated.

The processing module 1901 is further configured to map the first set of PDUs to the third default path and map the second set of PDUs to the first additional path based on the information of the first set of PDUs, the information of the second set of PDUs, and the first identifier of the first additional path in the case that the mapping relationship between the QoS flow and the path is not stored and the first function is configured or activated.

The processing module 1901 is further configured to map the first set of PDUs to the third default path and map the second set of PDUs to the first additional path based on at least one of the information of the first set of PDUs, the information of the second set of PDUs, the first identifier of the first additional path, or the first identifier of the third default path in the case that the mapping relationship between the QoS flow and the path is not stored and the first function is configured or activated.

The processing module 1901 is further configured to map the first set of PDUs and the second set of PDUs to the third default path in the case that the mapping relationship between the QoS flow and the path is not stored and the first function is not configured or activated.

The processing module 1901 is further configured to map the first set of PDUs and the second set of PDUs to the third default path in the case that the mapping relationship between the QoS flow and the path is not stored.

Herein, the information of the first set of PDUs includes at least one of importance, reliability, delay, dependency, priority, decoding reliability, or type of the first set of PDUs; the information of the second set of PDUs includes at least one of importance, reliability, delay, dependency, priority, decoding reliability, or type of the second set of PDUs; the first function refers to a function for performing data processing based on the first set of PDUs and the second set of PDUs corresponding to the first QoS flow; and the first identifier includes at least one of the type of a set of PDUs, a reliability identifier, an importance identifier, a reliability level, an importance level, a priority, a decoding dependency, a decoding reliability, a delay requirement, an identifier of a set of PDUs, the type of a frame, or the type of a coded slice.

In some embodiments, the processing module 1901 is further configured to map the first set of PDUs and the second set of PDUs to different paths based on at least one of: the mapping relationships between the first QoS flow and different paths or the first identifiers of different paths in the case that the mapping relationship between the QoS flow and the path is present.

The processing module 1901 is further configured to map the first set of PDUs and the second set of PDUs to different paths based on at least one of: the mapping relationships between the first QoS flow and different paths or the first identifiers of different paths in the case that the mapping relationship between the QoS flow and the path is present and the first function is configured or activated.

The processing module 1901 is further configured to map the first set of PDUs and the second set of PDUs to the third default path in the case that the mapping relationship between the QoS flow and the path is present and the first function is not configured or activated.

The processing module 1901 is further configured to map the first set of PDUs and the second set of PDUs to the first additional path in the case that the mapping relationship between the QoS flow and the path is present and the first function is not configured or activated.

The processing module 1901 is further configured to map the first set of PDUs and the second set of PDUs to the third default path based on at least one of: the mapping relationships between the first QoS flow and different paths or the first identifier of the third default path in the case that the mapping relationship between the QoS flow and the path is present and the first function is not configured or activated.

The processing module 1901 is further configured to map the first set of PDUs and the second set of PDUs to the first additional path in the case that the mapping relationship between the QoS flow and the path is present and the first function is not configured or activated.

The processing module 1901 is further configured to map the first set of PDUs and the second set of PDUs to the first additional path based on at least one of: the mapping relationships between the first QoS flow and different paths or the first identifier of the first additional path in the case that the mapping relationship between the QoS flow and the path is present and the first function is not configured or activated.

The processing module 1901 is further configured to map the first set of PDUs and the second set of PDUs to the corresponding path based on the mapping relationship between the first QoS flow and the path in the case that the mapping relationship between the QoS flow and the path is present and the first function is not configured or activated.

Herein, the first function refers to a function for performing data processing based on the first set of PDUs and the second set of PDUs corresponding to the first QoS flow; and the first identifier includes at least one of the type of a set of PDUs, a reliability identifier, an importance identifier, a reliability level, an importance level, a priority, a decoding dependency, a decoding reliability, a delay requirement, an identifier of a set of PDUs, the type of a frame, or the type of a coded slice.

In some embodiments, the processing module 1901 is further configured to configure the third default path and the first additional path; or configure the third default path and the first additional path for one PDU session.

In some embodiments, the processing module 1901 is further configured with the third default path and the first additional path; or configured with the third default path and the first additional path for one PDU session.

In some embodiments, the processing module 1901 is further configured to map the SDAP SDU or SDAP PDU to the fourth default path in the case that the mapping relationship between the QoS flow and the path is not stored, the fourth default path corresponding to one PDU session.

The processing module 1901 is further configured to map the SDAP SDU or SDAP PDU to the fourth default path in the case that the mapping relationship between the QoS flow and the path is not stored and the first function is not configured or activated, the fourth default path corresponding to one PDU session.

Herein, the first function refers to a function for performing data processing based on the first set of PDUs and the second set of PDUs corresponding to the first QoS flow.

In some embodiments, the processing module 1901 is further configured to map the first set of PDUs and the second set of PDUs to different paths based on at least one of: the mapping relationships between the first QoS flow and different paths or the first identifiers of different paths in the case that the mapping relationship between the QoS flow and the path is present.

The processing module 1901 is further configured to map the first set of PDUs and the second set of PDUs to different paths based on at least one of: the mapping relationships between the first QoS flow and different paths or the first identifiers of different paths in the case that the mapping relationship between the QoS flow and the path is present and the first function is configured or activated.

The processing module 1901 is further configured to map the SDAP SDU or SDAP PDU to the corresponding path in the case that the mapping relationship between the QoS flow and the path is present and the first function is not configured or activated.

The processing module 1901 is further configured to map the SDAP SDU or SDAP PDU to the corresponding path in the case that the mapping relationship between the QoS flow and the path is present.

Herein, the first function refers to a function for performing data processing based on the first set of PDUs and the second set of PDUs corresponding to the first QoS flow; and the first identifier includes at least one of the type of a set of PDUs, a reliability identifier, an importance identifier, a reliability level, an importance level, a priority, a decoding dependency, a decoding reliability, a delay requirement, an identifier of a set of PDUs, the type of a frame, or the type of a coded slice.

In some embodiments, the processing module 1901 is further configured to configure the fourth default path; or configure the fourth default path for one PDU session.

In some embodiments, the processing module 1901 is further configured with the fourth default path; or configured with the fourth default path for one PDU session.

In some embodiments, the processing module 1901 is further configured to generate an end-marker control PDU in the case that the mapping relationships between the first QoS flow and different paths change; and/or map and deliver the end-marker control PDU to the changed path.

In some embodiments, the processing module 1901 is further configured to determine a target path based on the mapping relationships between the first QoS flow and different paths after the change and/or the mapping relationships between the first QoS flow and different paths before the change and/or the first identifiers of different paths, the target path being the changed path; and map and deliver the end-marker control PDU to the corresponding target path.

In some embodiments, the processing module 1901 is further configured to determine a target path based on the mapping relationships between the first QoS flow and different paths after the change and/or the mapping relationships between the first QoS flow and different paths before the change and/or the first identifiers of different paths in the case that the end-marker control PDU is a target end-marker control PDU, the target path being the changed path; and map and deliver the end-marker control PDU to the corresponding target path based on at least one of the first identifier of the target path or the information of the set of PDUs corresponding to the end-marker control PDU.

Herein, the first identifier includes at least one of the type of a set of PDUs, a reliability identifier, an importance identifier, a dependency, a reliability level, an importance level, a priority, a decoding dependency, a decoding reliability, a delay requirement, an identifier of a set of PDUs, the type of a frame, or the type of a coded slice; and the information of the set of PDUs includes at least one of importance, reliability, delay, dependency, priority, decoding reliability, or type of the set of PDUs.

In some embodiments, the target path includes one path, or the target path includes a plurality of paths.

In some embodiments, the target path includes a path before the change, and/or the target path includes a path after the change.

In some embodiments, the processing module 1901 is further configured to indicate to the terminal that the mapping relationships between the first QoS flow and different paths change over an RRC configuration or a DL data packet or the packet header of the lower layer of the SDAP.

In some embodiments, the processing module 1901 is further configured to determine that the mapping relationships between the first QoS flow and different paths change by receiving an RRC configuration or a DL data packet or the packet header of the lower layer of the SDAP from an access network element.

In some embodiments, the QoS flow includes the first QoS flow of the first PDU session.

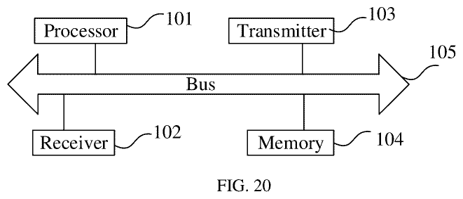

FIG. 20 illustrates a schematic structural diagram of a communication device (a terminal device or an access network element or a core network element) according to some embodiments of the present disclosure. The communication device includes: a processor 101, a receiver 102, a transmitter 103, a memory 104, and a bus 105.

The processor 101 includes one or more processing cores, and the processor 101 performs various functional applications and information processing by running software programs and modules. The receiver 102 and the transmitter 103 are implemented as a communication assembly, wherein the communication assembly may be a communication chip. The memory 104 is connected to the processor 101 over the bus 105. The memory 104 is configured to store at least one instruction, and the processor 101 is configured to execute the at least one instruction to perform the processes in the above method embodiments.

In addition, the memory 104 may be implemented by any type or combination of a volatile storage device or a non-volatile storage device, wherein the volatile storage device or the non-volatile storage device includes, but not limited to: a magnetic disk, an optical disk, an electrically-erasable programmable read-only memory (EEPROM), an erasable programmable read-only memory (EPROM), a static random access memory (SRAM), a read-only memory (ROM), a magnetic memory, a flash memory, and a programmable read-only memory (PROM).

In some embodiments, a chip is further provided. The chip includes at least one of: one or more programmable logic circuits or one or more program instructions. The chip, when running at least one of: the one or more programmable logic circuits or the one or more program instructions, is caused to perform the method for processing data as described above.

In some embodiments, a non-transitory computer-readable storage medium is further provided. The non-transitory computer-readable storage medium stores at least one instruction, at least one program, a code set, or an instruction set therein. The at least one instruction, the at least one program, the code set, or the instruction set, when loaded and executed by a processor, causes the processor to perform the method for processing data as performed by the communication device as defined in the above method embodiments.

In some embodiments, a computer program product is further provided. The computer program product includes one or more computer instructions stored in a non-transitory computer-readable storage medium. The one or more computer instructions, when read by a processor of a computer device from the non-transitory computer-readable storage medium and executed by the processor, cause the computer device to perform the method for processing data as defined in the above aspect.

It will be appreciated by those of ordinary skill in the art that all or a part of the processes for performing the above embodiments are completed by hardware, or are completed by instructing relevant hardware by a program stored in a non-transitory computer-readable storage medium. The storage medium mentioned above is a read-only memory, a magnetic disk, a compact disk, or the like.

Described above are merely optional embodiments of the present disclosure and are not intended to limit the present disclosure. Any modifications, equivalent substitutions, improvements, and the like, made within the spirit and principle of the present disclosure should fall within protection scope of the present disclosure.

1. A method for processing data, comprising:
performing data processing based on different pieces of first data corresponding to at least one quality of service (QOS) flow.

2. The method according to claim 1, wherein performing the data processing based on the different pieces of first data corresponding to the at least one QoS flow comprises:
performing the data processing based on different pieces of first data corresponding to a same QoS flow.

3. The method according to claim 2, wherein performing the data processing based on the different pieces of first data corresponding to the same QoS flow comprises:
performing the data processing based on a first set of protocol data units (PDUs) and a second set of PDUs corresponding to a first QoS flow.

4. The method according to claim 3, wherein performing the data processing based on the first set of PDUs and the second set of PDUs corresponding to the first QoS flow comprises:
performing different data processing operations based on the first set of PDUs and the second set of PDUs corresponding to the first QoS flow.

5. The method according to claim 4, wherein performing the different data processing operations based on the first set of PDUs and the second set of PDUs corresponding to the first QoS flow, comprises:
performing the different data processing operations based on attributes or attribute levels or indicators of the first set of PDUs and the second set of PDUs, wherein each of the attributes or attribute levels or indicators comprises at least one of association, dependency, importance, priority, decoding reliability, or reliability.

6. The method according to claim 3, wherein performing the data processing based on the first set of PDUs and the second set of PDUs corresponding to the first QoS flow comprises at least one of:
identifying the first set of PDUs and the second set of PDUs;
adding or removing packet headers of different data packets of the first set of PDUs and the second set of PDUs; or
deleting or feeding back deletion of at least one of the first set of PDUs or the second set of PDUs.

7. The method according to claim 6, wherein the packet headers of the different data packets of the first set of PDUs and the second set of PDUs comprise:
at least one of an importance indicator of the first set of PDUs or an importance indicator of the second set of PDUs;
wherein the data packet of the first set of PDUs comprises all or part of PDUs in the first set of PDUs, and the data packet of the second set of PDUs comprises all or part of PDUs in the second set of PDUs.

8. The method according to claim 7, wherein there is at least one of:
an SN of the first set of PDUs is carried in a packet header of the first set of PDUs, or an SN of the second set of PDUs is carried in a packet header of the second set of PDUs.

9. The method according to claim 6, wherein the method is applicable to a transmitter; and
identifying the first set of PDUs and the second set of PDUs comprises:
identifying attributes or attribute levels or indicators of the first set of PDUs and the second set of PDUs.

10. The method according to claim 3, wherein the method is applicable to an access network element; and performing the data processing based on the first set of PDUs and the second set of PDUs corresponding to the first QoS flow comprises at least one of:
in a case that downlink transmission is performed, performing the data processing on the first set of PDUs and the second set of PDUs corresponding to the first QoS flow based on parameter information at a set of PDUs level indicated by a core network element; or
in a case that uplink transmission is performed, determining QoS parameters of the first QoS flow based on an indication of a core network element; and performing different data processing operations on the first set of PDUs and the second set of PDUs corresponding to the first QoS flow based on the parameter information at the set of PDUs level.

11. The method according to claim 10, wherein the parameter information at the set of PDUs level comprises at least one of:
an importance of the first set of PDUs; or
an importance of the second set of PDUs.

12. A communication device, comprising: a processor; a transceiver connected to the processor;
and a memory, configured to store one or more executable instructions of the processor, wherein the processor, when loading and executing the one or more executable instructions, is caused to perform:
performing data processing based on different pieces of first data corresponding to at least one quality of service (QOS) flow.

13. The communication device according to claim 12, wherein the processor, when loading and executing the one or more executable instructions, is caused to perform:
performing the data processing based on different pieces of first data corresponding to a same QoS flow.

14. The communication device according to claim 13, wherein the processor, when loading and executing the one or more executable instructions, is caused to perform:
performing the data processing based on a first set of protocol data units (PDUs) and a second set of PDUs corresponding to a first QoS flow.

15. The communication device according to claim 14, wherein the processor, when loading and executing the one or more executable instructions, is caused to perform:
performing different data processing operations based on the first set of PDUs and the second set of PDUs corresponding to the first QoS flow.

16. The communication device according to claim 15, wherein the processor, when loading and executing the one or more executable instructions, is caused to perform:
performing the different data processing operations based on attributes or attribute levels or indicators of the first set of PDUs and the second set of PDUs, wherein each of the attributes or attribute levels or indicators comprises at least one of association, dependency, importance, priority, decoding reliability, or reliability.

17. The communication device according to claim 14, wherein the processor, when loading and executing the one or more executable instructions, is caused to perform at least one of:
identifying the first set of PDUs and the second set of PDUs;
adding or removing packet headers of different data packets of the first set of PDUs and the second set of PDUs; or
deleting or feeding back deletion of at least one of the first set of PDUs or the second set of PDUs.

18. The communication device according to claim 17, wherein the packet headers of the different data packets of the first set of PDUs and the second set of PDUs comprise:
at least one of an importance indicator of the first set of PDUs or an importance indicator of the second set of PDUs;
wherein the data packet of the first set of PDUs comprises all or part of PDUs in the first set of PDUs, and the data packet of the second set of PDUs comprises all or part of PDUs in the second set of PDUs.

19. The communication device according to claim 18, wherein there is at least one of:
an SN of the first set of PDUs is carried in a packet header of the first set of PDUs, or an SN of the second set of PDUs is carried in a packet header of the second set of PDUs.

20. A chip, comprising at least one of one or more programmable logic circuits or one or more program instructions, wherein the chip, when running at least one of the one or more programmable logic circuits or the one or more program instructions, is caused to perform:
performing data processing based on different pieces of first data corresponding to at least one quality of service (QOS) flow.
